(19) United States
(12) Patent Application Publication
(10) Pub. No.: US 2017/0289619 A1
(43) Pub. Date: Oct. 5, 2017

(54) METHOD FOR POSITIONING VIDEO, TERMINAL APPARATUS AND CLOUD SERVER

(71) Applicant: Samsung Electronics Co., Ltd., Gyeonggi-do (KR)

(72) Inventors: Chaojin XU, Beijing (CN); Delin FENG, Beijing (CN); Jiashen SUN, Beijing (CN); Xianghong RUAN, Beijing (CN); Jia WU, Beijing (CN); Xuesong YAO, Beijing (CN)

(21) Appl. No.: 15/473,020

(22) Filed: Mar. 29, 2017

(30) Foreign Application Priority Data
Mar. 29, 2016 (CN) 201610189262.6

(51) Int. Cl. H04N 21/442; H04N 21/472; H04N 21/81; H04N 21/258; H04N 21/234; H04N 21/414; H04N 21/4788; H04N 21/218

(52) U.S. Cl. CPC H04N 21/44218; H04N 21/4788; H04N 21/47202; H04N 21/2181; H04N 21/44204; H04N 21/25866; H04N 21/23424; H04N 21/41407; H04N 21/8133

(57) ABSTRACT

Disclosed is a method for positioning a video, a terminal apparatus and a cloud server, including acquiring user's impression data associated with a playback progress of a video, and positioning the content of the video based on the acquired user's impression data.

### PRIORITY

The present application claims priority under 35 U.S.C. §119(a) to a Chinese Patent Application filed in the Sino Intellectual Property Office on Mar. 29, 2016 and assigned Serial No. 201610189262.6, the contents of which are incorporated herein by reference.

### BACKGROUND

### 1. Field of the Disclosure

The present disclosure relates generally to video processing, and more particularly, to a method for positioning a video, a terminal apparatus and a cloud server.

### 2. Description of the Related Art

With the development of technology, terminal apparatuses with a video playback function and/or a display function with which users can watch video, such as smart phones, tablet computers, personal computers (PCs) and smart televisions (TVs) have proliferated. When watching a video by a terminal apparatus, the user might want to position the content of the video in order to find content of interest. In an existing method for positioning a video, a user is required to manually drag a playback progress bar in order to position the video playback progress of the desired video content. In this method, since the terminal apparatus is unaware of the real positioning intention of the user, the apparatus automatically positions video playback portions dragged by the user one by one for playback, to enable the user to watch and confirm the content. Such a method produces low positioning accuracy, and consequently, renders it difficult for the user to quickly position video playback progress of the desired video content in the video. Usually, the user can position the desired video content by performing multiple dragging operations, which produces low positioning efficiency. Moreover, the user operations tend to be very tedious, thereby resulting in an unsavory user's experience.

As such, there is a need in the art for method and apparatus for more accurately and efficiently positioning video content in a terminal apparatus.

### SUMMARY

The present disclosure has been made to address the above-mentioned problems and disadvantages, and to provide at least the advantages described below.

Accordingly, an aspect of the present disclosure is to provide a method for positioning a video, a terminal apparatus and a cloud server, in order to provide enhanced video positioning accuracy and user operations during a video positioning process, as compared to the prior art. According to an aspect of the present disclosure, a method for positioning a video includes acquiring user impression data associated with playback progress of a video, and positioning content of the video based on the acquired user impression data.

According to another aspect of the present disclosure, a method for positioning a video includes receiving feedback data of the users who are watching a video and corresponding video playback progress uploaded by a plurality of terminal apparatuses, determining user impression data associated with the video playback progress based on the feedback data of each user who is watching the video and the corresponding video playback progress, and providing the determined user impression data associated with the video playback progress to a terminal apparatus, wherein the terminal apparatus positions the content of the video according to the user's impression data.

According to another aspect of the present disclosure, a terminal apparatus includes a user impression data acquisition module, configured to acquire user impression data associated with video playback progress of a video, and a positioning module, configured to position the content of the video based on the acquired user impression data.

According to another aspect of the present disclosure, a cloud server includes a feedback data receiving module, configured to receive feedback data of the user who is watching a video and corresponding video playback progress uploaded by a plurality of terminal apparatuses, a user impression data determination module, configured to determine user impression data associated with the video playback progress based on the feedback data of each user who is watching the video and the corresponding video playback progress, and a data providing module, configured to provide the determined user impression data associated with the video playback progress to a terminal apparatus, wherein the terminal apparatus positions the content of the video according to the user impression data.

According to another aspect of the present disclosure, a method for positioning a video includes receiving feedback data of the users who are watching a video and corresponding video playback progress uploaded by a plurality of terminal apparatuses; determining user's impression data associated with the video playback progress based on the feedback data of each user who is watching the video and the corresponding video playback progress; and providing the determined user's impression data associated with the video playback progress to a terminal apparatus so that the terminal apparatus positions the content of the video according to the user's impression data.

According to another aspect of the present disclosure, a terminal apparatus includes a user's impression data acquisition module, configured to acquire user's impression data associated with video playback progress of a video; and a positioning module, configured to position the content of the video based on the acquired user's impression data.

According to another aspect of the present disclosure, a cloud server includes a feedback data receiving module, configured to receive feedback data of the users who are watching a video and corresponding video playback progress uploaded by a plurality of terminal apparatuses; a user's impression data determination module, configured to determine user's impression data associated with the video playback progress based on the feedback data of each user who is watching the video and the corresponding video playback progress; and a data providing module, configured to provide the determined user's impression data associated with the video playback progresses to a terminal apparatus so that the terminal apparatus positions the content of the video according to the user's impression data.

### BRIEF DESCRIPTION OF THE DRAWINGS

The above and other aspects, features, and advantages of the present disclosure will become apparent and be readily appreciated from the following description of embodiments, taken in conjunction with the accompanying drawings, in which:

FIG. 1 is a diagram of a system for positioning a video according to a first embodiment of the present disclosure;

FIG. 2 illustrates a method for collecting feedback data of a user who is watching a video according to a second embodiment of the present disclosure;

FIG. 3A illustrates a method for collecting comment data in the feedback data of a user who is watching a video according to a third embodiment of the present disclosure;

FIG. 3B illustrates an example in which a user issues comments according to the third embodiment of the present disclosure;

FIG. 4 illustrates a method for collecting operation data in the feedback data of a user who is watching a video according to a fourth embodiment of the present disclosure;

FIG. 5 illustrates a method for collecting physiological response data in the feedback data of a user who is watching a video according to a fifth embodiment of the present disclosure;

FIG. 6A illustrates a method for collecting comment data in the feedback data of a user who is watching a video according to a sixth embodiment of the present disclosure;

FIG. 6B illustrates an example of the comment data of a user on a video according to the sixth embodiment of the present disclosure;

FIG. 7A illustrates a method for positioning a video of a cloud server according to a seventh embodiment of the present disclosure;

FIG. 7B illustrates an example of integrating comment data and/or evaluation data according to the seventh embodiment of the present disclosure;

FIG. 7C illustrates an example of managing, by a cloud server, feedback data of a user who is watching a video according to the seventh embodiment of the present disclosure;

FIG. 8 illustrates a method for positioning a video on a terminal apparatus side according to an eighth embodiment of the present disclosure;

FIG. 9A illustrates a method for positioning content of a video based on comment data according to a ninth embodiment of the present disclosure;

FIG. 9B illustrates an example of displaying comment content by a terminal apparatus according to the ninth embodiment of the present disclosure;

FIG. 9C illustrates an example of positioning a video according to comments according to the ninth embodiment of the present disclosure;

FIG. 9D illustrates an example of positioning a video according to searched comments according to the ninth embodiment of the present disclosure;

FIG. 10A illustrates a method for positioning object content of a video based on comment data according to a tenth embodiment of the present disclosure;

FIG. 10B illustrates an example of positioning object content of a video according to comments according to the tenth embodiment of the present disclosure;

FIG. 11A illustrates a method for positioning scene content of a video based on comment data according to an eleventh embodiment of the present disclosure;

FIG. 11B illustrates an example of positioning scene content of a video according to comments according to the eleventh embodiment of the present disclosure;

FIG. 12A illustrates a method for positioning and displaying on electronic text content associated with a video based on comment data according to a twelfth embodiment of the present disclosure;

FIG. 12B illustrates an example of demonstrating an electronic text related to a video according to the twelfth embodiment of the present disclosure;

FIG. 13A illustrates a method for positioning content of a video based on preference data according to a thirteenth embodiment of the present disclosure;

FIG. 13B illustrates an example of marking video playback progress according to user's impression data according to the thirteenth embodiment of the present disclosure;

FIG. 13C illustrates an example of an impression curve of the video playback progress of a video and user emotional tendentiousness data according to the thirteenth embodiment of the present disclosure;

FIG. 13D illustrates an example of a curve of the video playback progress of a video and user mood data according to the thirteenth embodiment of the present disclosure;

FIG. 13E illustrates an example of a curve of the video playback progress of a video and the viewing rate data according to the thirteenth embodiment of the present disclosure;

FIG. 13F illustrates an example of a curve of the video playback progress of a video and user evaluation data according to the thirteenth embodiment of the present disclosure;

FIG. 13G illustrates an example of a curve of the video playback progress of a video and the overall data of degree of approval according to the thirteenth embodiment of the present disclosure;

FIG. 13H illustrates an example of positioning the content of a video according to the preference data of a user to the video, according to the thirteenth embodiment of the present disclosure;

FIG. 14A illustrates a method for downloading a video based on preference data according to a fourteenth embodiment of the present disclosure;

FIG. 14B illustrates an example of intelligently downloading a video according to the preference data of a user to the video and the electric power of a terminal apparatus, according to the fourteenth embodiment of the present disclosure;

FIGS. 15A and 15B are flowcharts of a method for intercepting and sharing a video based on preference data according to a fifteenth embodiment of the present disclosure;

FIG. 15C illustrates an example of intercepting and sharing a video according to the fifteenth embodiment of the present disclosure;

FIG. 16 illustrates a special example of an overall implementation method according to a sixteenth embodiment of the present disclosure;

FIG. 17 is a block diagram of an internal structure of a terminal apparatus according to a seventeenth embodiment of the present disclosure; and

FIG. 18 is a block diagram of an internal structure of a cloud server according to an eighteenth embodiment of the present disclosure.

### DETAILED DESCRIPTION

Embodiments of the present disclosure will be described in detail with reference to the accompanying drawings. The examples of these embodiments have been illustrated in the drawings throughout which same or similar reference numerals refer to same or similar elements or elements having same or similar functions. The embodiments described with reference to the drawings are illustrative, merely used for explaining the present disclosure and should not be regarded as limiting the present disclosure in any regard.

It should be understood by a person of ordinary skill in the art that singular terms such as “a”, “an”, “the”, and “said” may be intended to include plural forms as well, unless otherwise stated. It should be further understood that terms such as “include” and “including” used in this specification specify the presence of the stated features, integers, steps, operations, elements and/or components, but do not exclude the presence or addition of one or more other features, integers, steps, operations, elements, components, and/or combinations thereof. When a component is referred to as being “connected to” or “coupled to” another component, the component may be directly connected or coupled to other elements or provided with intervening elements therebetween. In addition, “connected to” or “coupled to” as used herein can include wireless connection or coupling. As used herein, the expression “and/or” includes all or any of one or more associated listed items or combinations thereof.

Unless otherwise defined, all terms including technical and scientific terms used herein have the same meaning as commonly understood by a person of ordinary skill in the art to which the present disclosure pertains. It shall be further understood that terms, such as those defined in commonly used dictionaries, should be interpreted as having a meaning that is consistent with their meanings in the context of the prior art and will not be interpreted in an idealized or overly formal sense unless expressly defined herein.

It should be understood by a person skilled in the art that the terms “terminal” and “terminal apparatus” as used herein include not only apparatuses with a wireless signal receiver having no emission capability but also apparatuses with receiving and emitting hardware capable of performing bidirectional communication over a bidirectional communication link. Such apparatuses can include cellular or other communication apparatuses with a single-line display or with or without a multi-line display, personal communication systems (PCSs) with combined functionalities of speech, data processing, facsimile and/or data communication, personal digital assistants (PDAs), which can include radio frequency (RF) receivers, pagers, Internet networks/intranet accesses, web browsers, notepads, calendars and/or global positioning system (GPS) receivers, and/or conventional laptop and/or palmtop computers or other apparatuses having and/or including a RF receiver.

The “terminal” and “terminal apparatus” as used herein may be portable, transportable, mountable in air, sea and/or land transportation, or suitable and/or configured to run locally and/or distributed to be run in other locations. The “terminal” or “terminal apparatus” as used herein may be a communication terminal, an Internet terminal, or a music/video player terminal, such as a personal data assistant (PDA), a mobile internet device (MID) and/or a mobile phone with a music/video playback function, or may be an apparatus such as a smart TV and/or a set-top box.

In embodiments of the present disclosure, a terminal apparatus acquires user's impression data associated with video playback progress of a video, for example, comment data of the user on the video (i.e., regarding the video) and/or preference data of the user to the video, and positions the content of the video based on the acquired user's impression data. In the embodiments of the present disclosure, the terminal apparatus can determine or predict a positioning intention of a user according to the impression of other users to a video and provide a video positioning service to the user. In contrast with manual dragging or other conventional methods, the method provided by the embodiments of the present disclosure can more accurately ascertain the positioning intention of a user, thereby improving the accuracy of video positioning. Moreover, due to the improvement of the accuracy of video positioning, the user is required to perform far fewer positioning operations than in the prior art, and both the video positioning efficiency and the user's experience can be improved.

### First Embodiment

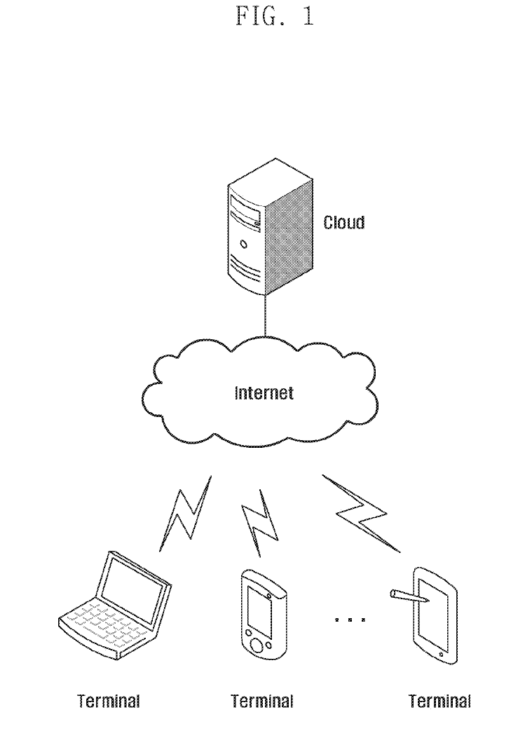

The first embodiment of the present disclosure provides a diagram of a system for positioning a video, as illustrated in FIG. 1, including a terminal apparatus.

In FIG. 1, there may be one or more terminal apparatuses.

There may be wired connection or wireless connection between terminal apparatuses.

The wireless connection can be at least one of Bluetooth®, ultra-wide band, ZigBee®, wireless fidelity (WiFi), general packet radio service (GPRS), 3rd-generation (3G) partnership project (3GPP, and long term evolution (LTE), for example.

A terminal apparatus can access to the Internet in a wired mode or in a wireless mode, such as through a WiFi, GPRS, 3G or LTE network.

The terminal apparatus can have at least one of a video playback, input, data collection and communication function.

For example, a terminal apparatus equipped with an image and/or audio collection device and a smart TV, usually has the above four functions, and a wearable apparatus, such as a smart watch or a smart bracelet, usually has the data collection and the communication function.

It can be understood by a person skilled in the art that, the terminal apparatus is actually equivalent to a video playback apparatus when the terminal apparatus performs the video playback function, and the terminal apparatus is equivalent to a data collection apparatus, such as an operation, comment, physiological response, or evaluation data collection apparatus, when the terminal apparatus performs the data collection function.

The terminal apparatus in the embodiments of the present disclosure may be configured to receive, from a plurality of other terminal apparatuses, feedback data of users who are watching videos and video playback progresses corresponding to the feedback data of users who are watching videos, and then process the feedback data and the video playback progresses to generate user's impression data to be acquired by the terminal apparatus itself or other terminal apparatuses for purpose of video positioning.

As illustrated in FIG. 1, the system for positioning a video provided by this embodiment of the present disclosure further includes a cloud server, which usually can be interpreted as a cloud platform.

The cloud server can include at least one of standalone servers, a server group, a server cluster and a distributed server system. A person skilled in the art can select the architecture of the cloud server according to actual conditions, and the specific architecture of the cloud server will not be limited in the embodiments of the present disclosure.

The cloud server accesses to the Internet in a wired mode, such as by accessing to a wide area network or backbone network of the Internet. For example, the servers in the cloud server access to the wide area network of the Internet through an optical fiber.

In this embodiment of the present disclosure, the cloud server is mainly configured to receive, from a plurality of terminal apparatuses, feedback data of users who are watching videos and video playback progresses corresponding to the feedback data of users who are watching videos, and then process the feedback data to generate user's impression data to be acquired by the terminal apparatuses. The present disclosure considers (consider) that one user may have a plurality of terminal apparatuses, for example, a smart phone, a tablet computer, a PC and a smart TV.

In this embodiment of the present disclosure, the terminal apparatuses of one user can be bound together, and other terminal apparatuses of the user all form external apparatuses of this terminal apparatus. Of course, the external apparatuses can further include other apparatuses rather than the terminal apparatuses.

The mutual binding of a terminal apparatus and an external apparatus is realized by logging-in an account maintained by a cloud server or by performing authentication to one of the two apparatuses by the other of the two apparatuses.

The terminal apparatus logs in to a cloud server of the serving side to register a user account, and the cloud server activates the user account and records a terminal apparatus ID (e.g., universally unique identifier) to this user account. After other terminal apparatuses of the user log into the account, the cloud server records the terminal apparatus IDs of the other terminal apparatuses to the user account. The terminal apparatus IDs under one user account have a mutual binding relationship.

For a terminal apparatus such as a wearable apparatus, before the terminal apparatus is activated (e.g., before leaving the factory), the cloud server usually stores the terminal apparatus ID of the terminal apparatus in correspondence to the characteristic information of the terminal apparatus, which can be a telecommunication number or a machine identification code having uniqueness. The terminal apparatus belonging to a smart phone, acquires the characteristic information of the wearable apparatus by shooting, scanning, and receiving a user input, for example, and then uploads the characteristic information to a cloud server, which records the terminal apparatus ID of the wearable apparatus to a user account of the terminal apparatus such as a smart phone so as to complete the mutual binding between the wearable apparatus and other terminal apparatuses.

### Second Embodiment

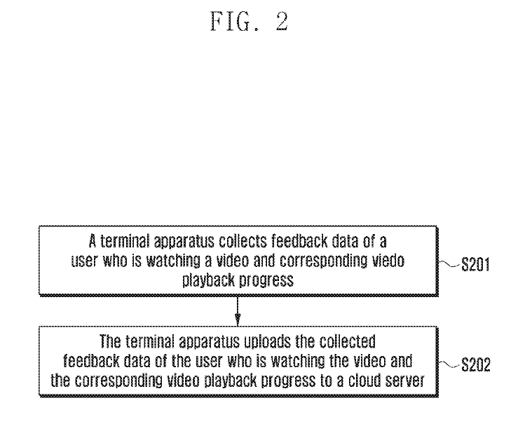

The second embodiment of the present disclosure will consider when a terminal apparatus collects feedback data of a user who is watching a video and corresponding video playback progress, and a cloud server determines user's impression data associated with the video playback progress based on the feedback data and the corresponding video playback progress. The flowchart of the method is as illustrated in FIG. 2.

In step S201, a terminal apparatus collects feedback data of a user who is watching a video and corresponding video playback progress.

In this embodiment of the present disclosure, the terminal apparatus can play a video by an application or in a webpage manner.

The present disclosure considers that a user usually generates some feedback while watching a video. For example, the user generates some impressions, change in user's expressions, fast heartbeat, and change in respiratory rhythm.

In step S201, the terminal apparatus collects feedback data of a user who is watching a video and corresponding video playback progress.

The feedback data includes at least one of comment data of the user to the video, operation data of the user to the video, physiological response data of the user who is watching the video, and evaluation data of the user to the video.

The comment data of the user to the video includes at least one of text, speech, video, picture and expression comments.

The operation data of the user to the video includes at least one of a user operation of marking or dragging the video, a fast-forward, fast-reverse, pause, zoom, interception and a video sharing operation.

The physiological response data of the user who is watching a video includes at least one of expression information, action information, sound information and physiological indices of the user.

The video playback progress can include at least one of the sequence number of episodes of the video, the video playback progress moment, and the video playback progress time period.

When the video playback apparatus and the collection apparatus are the same terminal apparatus, the terminal apparatus can acquire the feedback data of a user who is watching a video by itself during the video playback process, and then acquire the corresponding video playback progress in the terminal apparatus.

When the video playback apparatus and the collection apparatus are different terminal apparatuses, the video playback apparatus can acquire the feedback data of a user who is watching a video by the collection apparatus during the video playback process, and then acquire a corresponding video playback progress in the current apparatus.

When the collection apparatus includes a terminal apparatus and an external apparatus, the terminal apparatus can collect input data, and at least one of expression, action and sound information in the physiological response data, and the external apparatus can collect physiological indices in the physiological response data.

When the video playback apparatus and the collection apparatus are different terminal apparatuses, the collection apparatus can collect the feedback data of a user who is watching a video, and acquire a corresponding video playback progress by the video playback apparatus, by at least one of account login, speech recognition, image recognition and quick response (QR) code recognition.

The terminal apparatus can acquire the video playback progress of the video while collecting the feedback data of the user who is watching the video in many ways, such as while predicting that the user is about to generate the feedback data of the user who is watching the video, at the starting moment of the feedback data of the user who is watching the video, or at the ending moment of the feedback data of the user who is watching the video. The terminal apparatus can also acquire a user-defined video playback progress.

In step S202, the terminal apparatus uploads the collected feedback data of a user who is watching a video and the corresponding video playback progress to a cloud server.

The terminal apparatus further collects a terminal apparatus ID and a video ID of the video watched by the user, while collecting the feedback data of the user who is watching the video.

When the video playback apparatus and the collection apparatus are the same terminal apparatus, the terminal apparatus sends the feedback data of the user who is watching the video and corresponding video playback progress together with the video ID and the terminal apparatus ID to a cloud server in order to generate the user's impression data.

The apparatus ID of the video playback apparatus can be an ID of a user watching the video, for example, an account registered in a video playback application or a video playback web site by the user, or an ID temporarily assigned to the user, or an apparatus ID of a terminal apparatus used by the user who is watching the video, for example.

When the video playback apparatus and the collection apparatus are different terminal apparatuses, during the video playback process in step S201, the terminal apparatus serving as the video playback apparatus acquires feedback data of a user who is watching a video corresponding to video playback progress of the video by the terminal apparatus serving as the collection apparatus. In this step, the feedback data of the user who is watching the video and the corresponding video playback progress together with the video ID and the terminal apparatus ID are sent to a cloud server in order to generate the user's impression data, or the feedback data, the corresponding video playback progress, the video ID and the terminal apparatus ID can also be sent to a cloud server by the collection apparatus.

### Third Embodiment

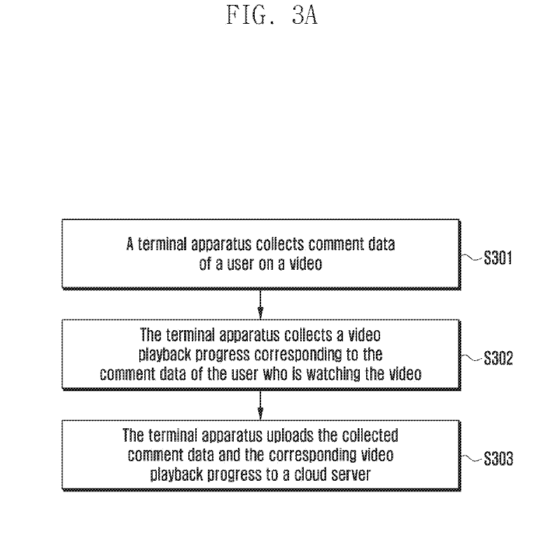

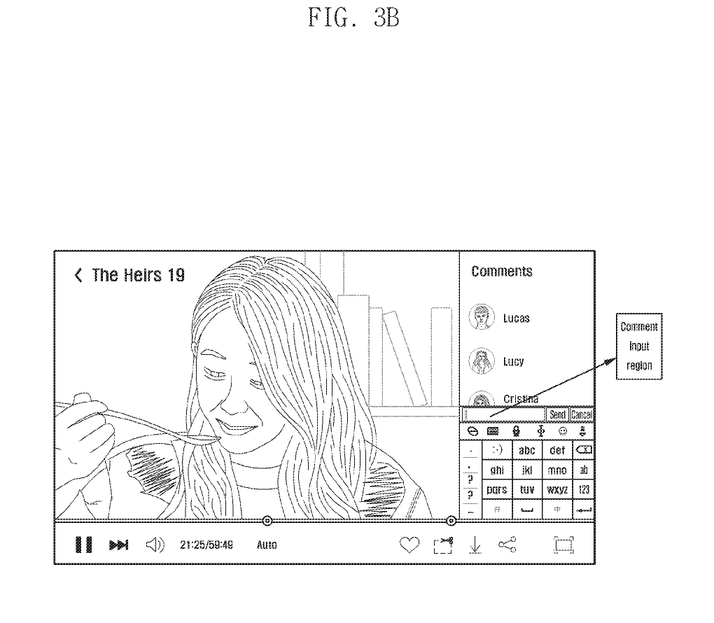

The third embodiment of the present disclosure, as illustrated in FIG. 3A, provides a method for collecting comment data of a user on a video. In step S301, a terminal apparatus collects comment data of a user on a video.

While watching a video by using a terminal apparatus, a user may make comments on the video, and input the comment data into the terminal apparatus.

The terminal apparatus can collect comment data input by the user with respect to a video in real time during the video playback process, and can receive comment data input by the user with respect to a video when the video is not played.

The terminal apparatus can call out and display a comment input region, according to a comment region callout instruction input by a user through a key, speech, gesture or an external apparatus, for example. After the terminal apparatus receives a clicking event of user's virtual key for issuing comments, the terminal apparatus determines the comment region callout instruction input by the user is received, and then calls out and displays the comment input region.

Alternatively, when a video playback region is zoomed to a preset size or when the video playback region is hidden or when the video is not played (that is, the video playback region is not displayed), the terminal apparatus automatically displays a comment region which includes a comment display region and/or a comment input region.

The terminal apparatus receives comment content input by the user to the video through the comment input region, and then automatically records the comment content.

The comment issued by the user includes, but is not limited to, comment to the video content, comment to a specific object (e.g., a character) in the video, comment to a specific scene in the video, and other comments related to the video in various aspects.

The user's comments include original comments issued by the user on the video and reply comments issued by the user with respect to the original comments. The reply comment includes reply content issued by the user with respect to the comments of other users, and with respect to the user's own comments.

The form of the comment issued by the user to the video includes, but is not limited to, at least one of text, speech, video, picture and expression comment.

Specifically, the content of the text comment input by the user can be acquired by a terminal apparatus or by a physical or a virtual key of an external apparatus associated therewith.

The speech of the user can be collected in real time by a sound collection apparatus of the terminal apparatus so as to obtain speech comment content, an audio file stored in the terminal apparatus can be used as speech comment content or can be acquired over a network as speech comment content.

A video of the user can be collected in real time by a sound collection apparatus and an image collection apparatus of the terminal apparatus so as to obtain video comment content, a video file stored in the terminal apparatus can be used as video comment content, and a video file can be acquired over a network as video comment content.

A picture of the user can be collected in real time by an image collection apparatus of the terminal apparatus so as to obtain picture comment content, a picture file stored in the terminal apparatus can be used as picture comment content, and a picture file can be acquired over a network as picture comment content.

An expression file stored in the terminal apparatus can be used as expression comment content, and an expression file can be acquired over a network as expression comment content.

Text comment content can be extracted from the acquired speech, video or picture comment content.

In step S302, the terminal apparatus collects video playback progress corresponding to the comment data of the user who is watching the video, by at least one of determining, as the video playback progress corresponding to the comment data, video playback progress when it is confirmed to issue the comment data, determining, as the video playback progress corresponding to the comment data, video playback progress selected by the user, and determining, as the video playback progress corresponding to the feedback data, video playback progress when it is confirmed to input the comment data.

Specifically, a method for determining, as the video playback progress corresponding to the comment data, video playback progress when it is confirmed to input the comment data includes determining that the user might input comment content when the terminal apparatus receives a comment region callout instruction input by the user, and automatically recording video playback progress of the video at this instant as video playback progress corresponding to the comment data issued by the user in this instance. The system time at this instant is automatically used as a system time corresponding to the comment data.

While playing a video by a user, after the terminal apparatus receives a clicking event of a user's virtual key for issuing comments, the terminal apparatus determines that a comment region callout instruction input by the user is received, then calls out and displays a comment input region, and automatically records video playback progress of the video at this instant as video playback progress corresponding to the comment data issued by the user in this instance.

For example, a smart watch plays a video, a smart phone receives a clicking event of the user's virtual key for issuing comments when the video playback progress of the video is 16′08″ and the system time at this instant is 15:30:15, the smart phone records video playback progress at this instant and displays a comment input region. The system time at this instant can be recorded. After a comment data A input by the user is received, the smart phone determines that the video playback progress corresponding to the comment data A is 16′08″ and further determines that the system time corresponding to the comment data A is 15:30:15.

For example, in FIG. 3B, the terminal apparatus plays a video having total playback duration of 59:49, i.e., 59′49″, the terminal apparatus receives a comment region callout instruction from a user when the video is played to video playback progress of 21:25, i.e., 21′25″, the terminal apparatus records the video playback progress of 21′25″ at this instant and displays a comment input region on the right side of the video. After comment data A input by the user is received through the comment input region, it is determined that the video playback progress of the video corresponding to comment data A is 21′25″.

The method for determining, as the video playback progress corresponding to the comment data, video playback progress when it is confirmed to issue the comment data includes determining, after a comment sending instruction input by the user is received, that the user completes this instance of input of the comment data and needs to send the comment data, and automatically recording video playback progress of the video at this instant as video playback progress corresponding to the comment data issued by the user in this instance. The system time at this instant is automatically used as a system time corresponding to the comment data.

The terminal apparatus resumes playing the video after displaying the comment region, and automatically records, after the comment data input by the user is received through the comment input region and when receiving a clicking event of user's virtual key for sending comments, video playback progress of the video at this instant as video playback progress corresponding to the comment data issued by the user in this instance.

For example, a smart phone plays a video, and has completely received comment data A input by the user when the video playback progress of the video is 16′20″ and the system time at this instant is 15:30:27, and a clicking event of user's virtual key for sending comments is received, and video playback progress at this instant is recorded, along with the system time at this instant. The smart phone determines that the video playback progress of the video corresponding to the comment data A is 16′20″ and further determines that the system time corresponding to the comment data A is 15:30:27.

A method for determining, as the video playback progress corresponding to the comment data, video playback progress selected by the user, includes determining video playback progress of the video defined by the user as video playback progress corresponding to the comment data input by the user in this instance.

After the comment data input by the user is received by a terminal apparatus, the terminal apparatus receives operations such as clicking or dragging a playback time axis (e.g., video playback progress bar) of the video, and determines video playback progress defined by the user is received. After detecting a confirmation operation with respect to the video playback progress (e.g., detecting an event of clicking a virtual key of “Confirm”), the terminal apparatus determines the video playback progress as video playback progress corresponding to the comment data input by the user in this instance.

The terminal apparatus can acquire the system time corresponding to the comment, for example, the system time of the terminal apparatus when the terminal apparatus detects that the user issues comments. The system time includes, but is not limited to, the time in a time zone to which the terminal apparatus pertains.

The terminal apparatus can continue playing the video while receiving the comment content input by the user. In addition, the terminal apparatus can also pause playing the video when calling out and displaying a comment input region (e.g., receiving a clicking event of a virtual key for issuing comments), and then resume playing the video after receiving a comment sending instruction input by the user (e.g., after receiving an event of clicking a virtual key for sending comments).

In actual operation, a terminal apparatus for playing a video (referred to as a video playback apparatus) and a terminal apparatus for collecting comments (referred to as a comment collection apparatus) can be a same terminal apparatus.

For example, a user watches a video on a smart phone, and inputs the comments on the video by a virtual keyboard of the smart phone while watching the video. During this process, the smart phone can acquire comment content issued by the user and video playback progress corresponding to the comment content. In this case, all comments on this video will be displayed on this terminal apparatus.

In addition, the video playback apparatus and the comment collection apparatus can also be different terminal apparatuses.

For example, the video playback apparatus can be a smart TV or a display apparatus in public places such as a subway station or a bus station, while the comment collection apparatus can be a smart phone, a tablet computer or other portable apparatus of the user.

When a video is played on the video playback apparatus, the comment collection apparatus can acquire video playback progress of the video playback apparatus, such as by logging-in one user account, sound recognition, image recognition or QR code recognition, for example.

The user calls out a comment input region in the comment collection apparatus, inputs comment content and confirms to issue the comment (e.g., clicking a virtual key for sending comments) after inputting the content. In this case, all comments on the video can be displayed on the video playback apparatus, on the comment collection apparatus, or on both the video playback apparatus and the comment collection apparatus.

In step S303, the terminal apparatus uploads the collected comment data and the corresponding video playback progress to a cloud server.

The terminal apparatus can correspondingly upload the collected comment data of the user to the video, as well as the video playback progress of the video corresponding to the comment data, the video ID and the terminal apparatus ID, to the cloud server.

The terminal apparatus can package the corresponding comment data, the video playback progress, the video ID and the terminal apparatus ID into a feedback message, and then send the feedback message to a cloud server.

The terminal apparatus can also send the system time corresponding to the comment data, as well as the video playback progress corresponding to the comment data, the video ID and the terminal apparatus ID, to a cloud server, or encapsulate the system time corresponding to the comment data also into the feedback message and then send the feedback message to the cloud server.

The terminal apparatus can send the feedback message to the cloud server in real time or in non-real time during the video playback process, after the video playback is completed, or prior to the video playback.

When the video playback apparatus and the comment collection apparatus are different terminal apparatuses, a method for a terminal apparatus to feed back data to a cloud server includes sending, by the comment collection apparatus, the comment data acquired in the above step and the video playback progress of the video corresponding to the comment data to the video playback apparatus after receiving a comment sending instruction, and correspondingly uploading, by the video playback apparatus, the terminal apparatus ID, the video ID, the comment data and the video playback progress corresponding to the comment to the cloud server.

The comment collection apparatus sends the comment data acquired in the above step and the time information corresponding to the comment (the video playback progress of the video and/or system time corresponding to the comment data) to the video playback apparatus after receiving a comment sending instruction, and the video playback apparatus correspondingly uploads the terminal apparatus ID, the video ID, the comment data and the time information corresponding to the comment to the cloud server.

It is also possible to transmit data to a cloud server by the comment collection apparatus. After receiving a comment sending instruction, the comment collection apparatus correspondingly uploads the comment data acquired in the above acquiring step, the time information corresponding to the comment (the video playback progress of the video and/or system time corresponding to the comment data), the terminal apparatus ID and the video ID to the cloud server.

When the video playback apparatus and the comment collection apparatus are the same terminal apparatus, a method for a terminal apparatus to feed back data to a cloud server includes correspondingly uploading, by the comment collection apparatus, after receiving a comment sending instruction, the comment data acquired in the above acquiring step, the video playback progress of the video corresponding to the comment data, the terminal apparatus ID and the video ID to the cloud server.

### Fourth Embodiment

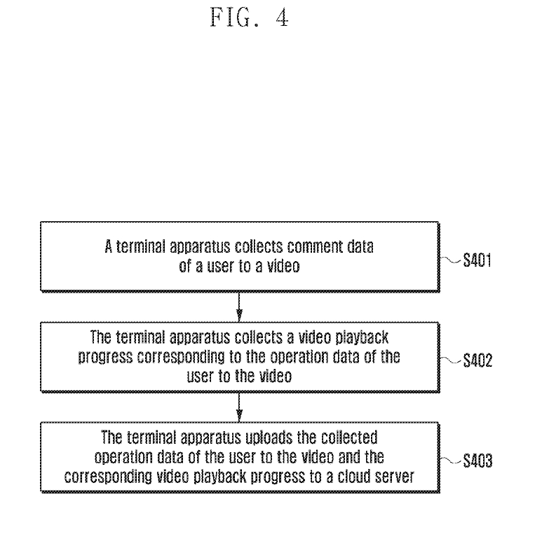

The fourth embodiment of the present disclosure, as illustrated in FIG. 4, provides a method for collecting operation data of a user to a video. In step S401, a terminal apparatus collects operation data of an operation of a user to a video during the video playback process. The operation includes, but is not limited to, at least one of a user's operation of marking the video, dragging the video, fast-forward, fast-reverse, pause, zoom, interception, and sharing the video, for example.

The user can operate the video by a key, speech, a gesture, or an external apparatus for example, and the terminal apparatus can automatically record operation data of the user to the video.

The terminal apparatus can collect an operation of marking the video.

Specifically, the terminal apparatus can collect marks performed with respect to a highlight point and/or a highlight fragment of the video, or with respect to a non-highlight point and/or a non-highlight fragment of the video. The terminal apparatus can also collect marks performed with respect to a corresponding object (e.g., a character, an animal, or scenery) present in the video, or can collect marks performed with respect to a scene present in the video.

In this case, the mark type of mark data recorded by the terminal apparatus includes point mark and fragment mark. The point mark can include at least one of highlight point mark, non-highlight point mark, object mark, and scene mark. The fragment mark can include at least one of highlight fragment mark and non-highlight fragment mark.

For example, if the terminal apparatus receives a clicking event of a highlight point mark during the video playback process, the terminal apparatus determines a highlight point mark to the video is received.

For another example, if the terminal apparatus receives a clicking event of marking a certain character in the current video frame during the video playback process, the terminal apparatus determines an object mark associated with the character is received.

The terminal apparatus can collect a dragging operation, a fast-forward operation and/or a fast-reverse operation performed with respect to the video playback bar of the video.

It can be understood by a person skilled in the art that the dragging operation/fast-forward operation/fast-reverse operation indicates the user's preference to the currently played video content to some extent. For example, if the user drags the progress bar forward or backwards, it is indicated that the user is not interested in the video content at the current video playback progress and is attempting to find the video content of interest by dragging the progress bar.

In this case, the operation data to the video collected by the terminal apparatus includes such operations as dragging forward, dragging backwards, a fast-forward operation, and a fast-reverse operation, for example.

The terminal apparatus collects a pause operation to the video.

If the user is interested in the currently played video content when the user is watching a video played by the terminal apparatus, the user might perform a pause operation on the video in order to carefully view the details of the content. To some extent, the pause operation indicates that the user is interested in the currently played video content.

In this case, the operation data to the video collected by the terminal apparatus is a pause operation.

The terminal apparatus can collect a zoom operation to the video.

If the user is interested in the currently played video content when the user is watching a video played by the terminal apparatus, the user might perform a zoom-out or zoom-in operation on a video playback region, such as by pinching fingers. To some extent, the zoom operation indicates that the user is interested in the currently played video content.

In this case, the operation data of the user to the video is a zoom operation.

The terminal apparatus can collect an interception operation to the video.

The user can intercept a video fragment for subsequently sharing or storing when watching the video played by the terminal apparatus. To some extent, the interception operation indicates that the user is interested in the video content of the intercepted video fragment.

In this case, the operation data of the user to the video is an interception operation.

The terminal apparatus can collect a video sharing operation to the video.

The user can share a video or a video fragment with other users. To some extent, the sharing operation indicates that the user is interested in the video content of the shared video or video fragment.

In this case, the operation data of the user to the video is a sharing operation.

In step S402, the terminal apparatus collects video playback progress corresponding to the operation data of the user to the video.

When the operation of the user to the video is a marking operation, the terminal apparatus determines at least one of video playback progress corresponding to a video frame where the user marks, starting video playback progress corresponding to the marked video fragment, ending video playback progress corresponding to the video fragment and video playback progress corresponding to a key video frame in the video fragment as the video playback progress corresponding to the operation data of the user to the video.

Specifically, with respect to an operation having point mark operation data, the terminal apparatus determines video playback progress of a video frame at the occurrence of the point marking operation as the video playback progress corresponding to the point mark.

For example, during the video playback process, when the video playback progress of the video is 16′08″ and the system time at this instant is 15:30:15, and if the terminal apparatus collects a clicking event of a highlight point mark, the terminal apparatus determines that the video playback progress of a video frame corresponding to the marking operation is 16′08″, and further determines that the system time corresponding to this mark is 15:30:15.

For example, when the video playback progress of the video is 16′20″ and the system time at this instant is 15:30:27, and if the terminal apparatus collects a marking event of a certain character in the video frame at this time, the terminal apparatus determines that the video playback progress of a video frame corresponding to the marking operation is 16′20″, and further determines that the system time corresponding to this mark is 15:30:27.

For a fragment marking operation, the terminal apparatus determines a video fragment corresponding to the fragment marking operation, and then determines starting video playback progress corresponding to the video fragment, ending video playback progress corresponding to the video fragment and video playback progress of a key frame of the video fragment in the video. At least one of the above three video playback progresses can be used as the video playback progress corresponding to the fragment marking operation.

When the operation of the user to the video is a user's operation of dragging the video, a fast-forward, fast-reverse, pause or zoom operation, the terminal apparatus determines video playback progress when performing the operation and/or video playback progress after performing the operation as the video playback progress corresponding to the operation data of the user to the video.

Specifically, with respect to any of the above operations, the terminal apparatus determines the video playback progress corresponding to the operation data of this operation by the following methods.

A method for determining the video playback progress corresponding to the operation data includes, if only one progress changing operation to the video is collected within a set period of time, regarding the video playback progress at the end of the progress changing operation as the video playback progress corresponding to the operation data of this operation.

For example, when the terminal apparatus plays a video to video playback progress of 16′08″ and the system time at this instant is 15:30:15, if the terminal apparatus collects an operation of dragging backwards a video playback progress bar of the video and does not collect other progress changing operations within a set period of time, the terminal apparatus regards the video playback progress (i.e., 16′08″) at the end of the operation of dragging backwards as the video playback progress corresponding to this operation. The terminal apparatus regards the system time (i.e., 15:30:15) at the end of the operation of dragging backwards as the system time corresponding to this operation.

Another method for determining the video playback progress corresponding to an operation includes, if more than two progress changing operations to the video are collected and no dragging/fast-forward/fast-reverse operation recurs within a set period of time after playing from the video playback progress of the last operation, regarding the video playback progress at the end of the last progress changing operation as the video playback progress corresponding to the operation data of this operation.

For example, when the terminal apparatus plays a video to video playback progress of 16′08″, the terminal apparatus collects an operation of dragging backwards a video playback progress bar of the video, and the video playback progress at the end of the dragging operation is 19′10″. If another operation of dragging backwards is collected after the video is continuously played for 2 s and the video playback progress at the end of this operation is 19′30″, and if no dragging operation is collected again within a set period of time after the video is continuously played from 19′30″, 19′30″ is regarded as the video playback progress corresponding to the above dragging operations. To some extent, the video playback progress reflects that the user is not interested in the video content from 16′08″ to 19′30″ but is interested in the video content from the video playback progress of 19′30″.

The terminal apparatus implements video playback progress when performing a pause operation on the video as the video playback progress corresponding to the pause operation.

For example, during the video playback process, when the video is played to video playback progress of 16′08″ and the system time at this instant is 15:30:15, and if the terminal apparatus detects a clicking event of a pause key, the terminal apparatus determines a pause operation to the video is received and then determines that the video playback progress corresponding to the pause operation is 16′08″. The terminal apparatus determines that the system time corresponding to the pause operation is 15:30:15.

The terminal apparatus implements video playback progress when performing a zoom operation on the video as the video playback progress corresponding to the zoom operation.

When the operation of the user to the video is intercepting or sharing the video, the terminal apparatus determines at least one of a starting video playback progress corresponding to the intercepted or shared video content, an ending video playback progress and video playback progress corresponding to the key video frame as the video playback progress corresponding to the feedback data.

Specifically, the terminal apparatus can regard at least one of the following video playback progresses as the video playback progress corresponding to the interception operation:

1) A starting video playback progress of an intercepted video fragment. For example, if a user intercepts, from the video, a video fragment at video playback progress from 16′08″ to 17′18″, 16′08″ is regarded as the starting video playback progress of the video fragment;

2) An ending video playback progress of an intercepted video fragment. For example, if a user intercepts, from the video, a video fragment at video playback progress from 16′08″ to 17′18″, 17′18″ is regarded as the ending video playback progress of the video fragment; and

3) Video playback progress corresponding to a key video frame of an intercepted video fragment in the video. For example, if a user intercepts, from the video, a video fragment at video playback progress from 16′08″ to 17′18″, 16′10″, 16′15″, 16′40″, 16′50″ and 17′10″ in the video fragment are key frames of the video fragment, 16′10″, 16′15″, 16′40″, 16′50″ and 17′10″ are regarded as the video playback progresses corresponding to the key video frames.

The terminal apparatus regards at least one of the following video playback progresses as the video playback progress corresponding to the sharing operation:

1) Video playback progress corresponding to starting content of a shared video/video fragment in the video;

2) Video playback progress corresponding to ending content of a shared video/video fragment in the video; and

3) Video playback progress corresponding to a key video frame of a shared video/video fragment in the video.

In this embodiment, the video playback apparatus and the collection apparatus can be the same apparatus. For example, a user watches a video on a smart phone and performs an operation to the video by the smart phone while watching the video. In this case, the smart phone is able to collect operation data of the user and video playback progress corresponding to the operation data.

In step S403, the terminal apparatus uploads the collected operation data of a user and the corresponding video playback progress to a cloud server.

When the video playback apparatus and the collection apparatus are the same terminal apparatus, the terminal apparatus can correspondingly upload the terminal apparatus ID, the video ID, the operation data and the video playback progress corresponding to the operation data to a cloud server, after detecting that the playback of a video is ended and/or paused.

After detecting the playback of a video is ended and/or paused, the terminal apparatus can encapsulate the terminal apparatus ID, the video ID, the operation data and the video playback progress corresponding to the operation data into a feedback message and then upload the feedback message to a cloud server.

After detecting the playback of a video is ended and/or paused, the terminal apparatus can correspondingly upload the terminal apparatus ID, the video ID, the operation data and the time information corresponding to the operation data to a cloud server.

The time information corresponding to the operation data can include video playback progress corresponding to the operation data, and the system time corresponding to the operation data.

The terminal apparatus can correspondingly upload the terminal apparatus ID, the video ID, the operation data and the video playback progress corresponding to the operation data to a cloud server periodically during the playback process.

The terminal apparatus can periodically encapsulate the terminal apparatus ID, the video ID, the operation data and the video playback progress corresponding to the operation data into a feedback message during the playback process and then upload the feedback message to a cloud server.

The terminal apparatus can correspondingly upload the terminal apparatus ID, the video ID, the operation data and the time information corresponding to the operation data to a cloud server periodically during the playback process.

The video playback apparatus and the operation collection apparatus can also be different terminal apparatuses. For example, the video playback apparatus can be a smart TV, while the operation collection apparatus can be a smart phone or a tablet computer.

When a video is played on the playback apparatus, the operation collection apparatus can acquire video playback progress of the video playback apparatus by logging-in one user account, sound recognition, image recognition or QR code recognition, for example, and then display the video playback progress in the displayed video playback progress bar. The user performs an operation on the playback of the video in the operation collection apparatus, which acquires operation data and time information corresponding to the operation. In this case, the video playback apparatus can respond to the operation performed by the user on the operation collection apparatus.

In this embodiment of the present disclosure, the data is fed back to the cloud server by the video playback apparatus after the playback of a video is ended and/or paused. (1) The operation collection apparatus acquires operation data and time information corresponding to the operation data in the above-described manner and then sends the operation data and the time information corresponding to the operation data to the video playback apparatus after receiving a collection stopping/pausing instruction sent by the video playback apparatus, and the video playback apparatus correspondingly uploads the terminal apparatus ID, the video ID, the operation data and the time information corresponding to the operation data to the cloud server, and (2) The operation collection apparatus acquires operation data and time information corresponding to the operation data in the above-described manner and then sends the collected operation data and the time information corresponding to the operation data to the video playback apparatus at set time intervals, and the video playback apparatus correspondingly uploads the terminal apparatus ID, the video ID, the operation data and the time information corresponding to the operation data to the cloud server after detecting that the playback of a video is ended/paused.

The data is fed back to the cloud server in real time by the video playback apparatus during the playback process. The operation collection apparatus acquires operation data and time information corresponding to the operation data in the above-described manner and then sends the collected operation data and the time information corresponding to the operation data to the video playback apparatus at set time intervals, and the video playback apparatus determines video playback progress corresponding to the operation data received at this time and correspondingly uploads the terminal apparatus ID, the video ID, the operation data and the time information corresponding to the operation data to the cloud server.

The data is fed back to the cloud server by the operation collection apparatus after the playback is ended/paused. (1) The operation collection apparatus acquires operation data and time information corresponding to the operation data in the above-described manner, and then correspondingly uploads the terminal apparatus ID, the video ID, the operation data and the time information corresponding to the operation data to the cloud server after receiving a collection stopping/pausing instruction sent by the video playback apparatus, and (2) The operation collection apparatus acquires operation data and time information corresponding to the operation data in the above-described manner, then determines video playback progress corresponding to the collected operation data according to the video playback progress received at the beginning of collection at set time intervals after receiving a collection stopping/pausing instruction sent by the video playback apparatus, and correspondingly uploads the terminal apparatus ID, the video ID, the operation data and the time information corresponding to the operation data to the cloud server.

The data is fed back to the cloud server by the operation collection apparatus during the playback process. The operation collection apparatus acquires operation data and time information corresponding to the operation data in the above-described manner, then determines video playback progress corresponding to the operation data collected in this instance according to the video playback progress received at the beginning of collection at set time intervals, and correspondingly uploads the terminal apparatus ID, the video ID, the operation data and the time information corresponding to the operation data to the cloud server.

### Fifth Embodiment

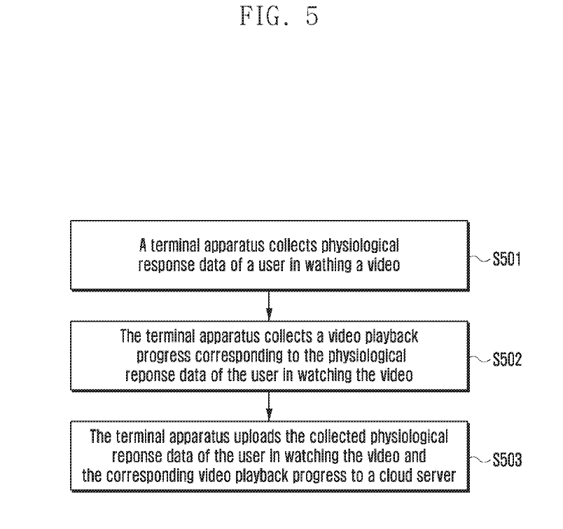

The fifth embodiment of the present disclosure, illustrated in FIG. 5, provides a method for collecting physiological response data of a user who is watching a video. In step S501, a terminal apparatus collects physiological response data of a user who is watching a video.

The present disclosure realizes that a user usually generates some physiological responses while watching a video, such as at least one of expression, action and sound of the user who is watching a video, as well as body temperature, heart rate, blood pressure and other physiological indices.

The terminal apparatus can collect physiological response data of a user who is watching a video.

The physiological response data can include at least one of expression, action, and sound information, and physiological indices of the user.

The physiological indices can include at least one of body temperature, heart rate, and blood pressure data.

The sound information, expression information and action information of the user can be collected by a sound collection apparatus and an image collection apparatus of the terminal apparatus, and the body temperature, heart rate, blood pressure and other physiological indices of the user can be collected by various wearable apparatuses and sensors.

For example, the body temperature data of the user who is watching a video is collected in real time by a temperature sensor of a wearable apparatus, the heart rate data of the user who is watching a video is collected in real time by a heart rate sensor of the wearable apparatus, and the blood pressure data of the user who is watching a video is collected in real time by a blood pressure sensor of the wearable apparatus.

The video playback apparatus and the terminal apparatus for collecting a physiological response (called a response collection apparatus) can be the same terminal apparatus. For example, when a user watches a video on a smart phone, the expression information and the sound information of the user are collected in real time by an image collection apparatus (e.g., a camera) and a sound collection apparatus (e.g., a microphone) of the smart phone.

In addition, the video playback apparatus and the response collection apparatus can also be different terminal apparatuses. For example, the video playback apparatus can be a smart TV or a display apparatus in public places such as a subway station or a bus station, while the response collection apparatus can be a wearable apparatus, such as a smart watch.

The terminal apparatus can collect physiological response data of a user by various methods.

(1) The physiological response data is collected after it is detected that the playback of a video is started.

Specifically, the video playback apparatus sends a response collection notification to a pre-registered or associated response collection apparatus when detecting that the playback of a video is started, such as when detecting that a user starts a video and performs a playback operation, detecting that the playback of a video is resumed after the user performs a fast-forward/dragging operation on the video, or detecting that the user performs a playback operation on the video after performing a pause operation, and the response collection apparatus begins to collect the physiological response data of the user to the video according to the response collection notification. Furthermore, the video playback apparatus sends a response collection stopping notification to the response collection apparatus when detecting that the playback of a video is ended, such as detecting that a user closes the video, and the response collection apparatus stops collecting the physiological response data of the user according to the response collection stopping notification.

If the video playback apparatus detects that the video is paused (for example, detecting that the user performs a pause/dragging/fast-forward operation or other operations on the video to result in the pause of the video), the video playback apparatus can send a response collection pausing notification to the response collection apparatus, which pauses the collection of the physiological response data of the user to the video according to the response collection pausing notification.

To avoid the disturbance to the collection of physiological response data by the abnormal start, stop or pause or other abnormal playback states of the video and improve the collection efficiency and effectiveness of the physiological response data, it is also possible to collect the physiological response data of the user based on the minimum collection time.

Specifically, the playback duration of the video is compared with a preset minimum collection time, and when the playback duration of the video is greater than the minimum collection time, the response collection apparatus collects the physiological response data of the user until receiving an instruction of closing/quitting the video input by the user or until the video is closed, quit, stopped or paused due to non-human factors.

When the playback duration of the video is less than or equal to the minimum collection time, the response collection apparatus does not collect the physiological response corresponding to the video or the response collection apparatus abandons the collected physiological response corresponding to the video, where the threshold is greater than or equal to 0 second.

For example, when the minimum collection time is preset as 5 seconds and the user has played the video for 6 seconds, the response collection apparatus collects the physiological response data of the user to the video starting from the fifth second. If the user has played the video for only 4 seconds, the response collection apparatus does not collect the physiological response of the user from 0 to 4 seconds of the video.

(2) The response collection apparatus always collects the physiological response data of the user.

The response collection apparatus can collect and record the physiological response data of the user in real time while watching the video. For example, the response collection apparatus collects the physiological response data of the user all the time at set time intervals.

In step S502, the terminal apparatus collects video playback progress corresponding to the physiological response data of the user who is watching a video.

With respect to the manner in which to collect the physiological response data during the video playback process, the terminal apparatus collects the video playback progress of the video while collecting the physiological response data of the user.

For example, if the terminal apparatus collects the physiological response data of the user every 2 seconds from the beginning of the playback of a video, the video playback progress of the video corresponding to each collected physiological response is successively 0′0″, 0′02″, 0′04″, 0′06″ . . . , etc.

The terminal apparatus can also acquire the system time while collecting the physiological response data, and use the system time as the system time corresponding to the physiological response data.

With respect to the manner in which to always collect the physiological response data, the terminal apparatus records a time stamp for collecting each physiological response data, and matches the system time corresponding to the video playback progress of the video with each time stamp after detecting that the playback of a video is started. With respect to the video playback progress having the system time consistent with the time stamp for collecting the physiological response data, it is determined that the video playback progress corresponds to the physiological response data.

In step S503, the terminal apparatus uploads the collected feedback data of the user who is watching a video and the corresponding video playback progress to a cloud server.

The terminal apparatus can correspondingly upload the terminal apparatus ID, the video ID, the physiological response data and the video playback progress corresponding to the physiological response data to the cloud server after detecting that the playback of a video is ended/paused.

The terminal apparatus can correspondingly upload the terminal apparatus ID, the video ID, the physiological response data, the video playback progress corresponding to the physiological response data and the system time to the cloud server after detecting that the playback of a video is ended/paused.

The terminal apparatus can also upload the data in real time during the video playback process. Specifically, the terminal apparatus uploads the terminal apparatus ID, the video ID, the physiological response data collected in this instance and the video playback progress corresponding to the physiological response data to the cloud server periodically.

The terminal apparatus uploads the terminal apparatus ID, the video ID, the physiological response data collected in this instance, the video playback progress corresponding to the physiological response data and the system time to the cloud server periodically.

With respect to the manner in which to collect physiological response data during the video playback process, the manner in which to upload data to a cloud server by the video playback apparatus and the response collection apparatus includes

A. The data is uploaded by the video playback apparatus after the playback is ended/paused. (1) The video playback apparatus informs the response collection apparatus to begin to collect the physiological response of the user to the video when detecting that the playback of a video is started, the response collection apparatus sends the collected physiological response and the corresponding system time to the video playback apparatus after receiving a collection stopping/pausing instruction sent by the video playback apparatus, and the video playback apparatus determines video playback progress corresponding to the received physiological response data and correspondingly uploads the terminal apparatus ID, the video ID, the physiological response data, the video playback progress corresponding to the physiological response data and the system time to the cloud server, and (2) The video playback apparatus informs the response collection apparatus to begin to collect the physiological response of the user to the video and informs the response collection apparatus of the video playback progress at this instant when detecting that the playback of a video is started, the response collection apparatus sends the collected physiological response data and the corresponding system time to the video playback apparatus at set time intervals, and the video playback apparatus determines video playback progress corresponding to the received physiological response data when detecting that the playback of a video is ended/paused, and then correspondingly uploads the terminal apparatus ID, the video ID, the physiological response data, the video playback progress corresponding to the physiological response data and the system time to the cloud server.

B. The data is uploaded in real time by the video playback apparatus during the playback process The video playback apparatus informs the response collection apparatus to begin to collect the physiological response of the user to the video when detecting that the playback of a video is started, the response collection apparatus sends the collected physiological response data and the corresponding system time to the video playback apparatus at set time intervals, and the video playback apparatus determines video playback progress corresponding to the physiological response data received in this instance and uploads the terminal apparatus ID, the video ID, the physiological response data received in this instance, the video playback progress corresponding to the physiological response data and the system time to the cloud server in real time.

C. The data is uploaded by the response collection apparatus after the playback is ended/paused. (1) The video playback apparatus informs the response collection apparatus to begin to collect the physiological response of the user to the video and informs the response collection apparatus of the video playback progress at this instant when detecting that the playback of a video is started, the response collection apparatus determines video playback progress corresponding to the collected physiological response data according to the video playback progress received at the beginning of collection after receiving a collection stopping/pausing instruction sent by the video playback apparatus, and the response collection apparatus correspondingly uploads the terminal apparatus ID, the video ID, the physiological response data, the video playback progress corresponding to the physiological response data and the system time to the cloud server, and (2) The video playback apparatus informs the response collection apparatus to begin to collect the physiological response of the user to the video and also informs the response collection apparatus of the video playback progress at this instant when detecting that the playback of a video is started, the response collection apparatus determines video playback progress corresponding to the collected physiological response data according to the video playback progress received at the beginning of collection at set time intervals after receiving a collection stopping/pausing instruction sent by the video playback apparatus, and the response collection apparatus correspondingly uploads the terminal apparatus ID, the video ID, the physiological response data, the video playback progress corresponding to the physiological response data and the system time to the cloud server, and

D. The data is uploaded in real time by the response collection apparatus during the playback process. The video playback apparatus informs the response collection apparatus to begin to collect the physiological response of the user to the video and informs the response collection apparatus of video playback progress at this time when detecting that the playback of a video is started, the response collection apparatus determines video playback progress corresponding to the physiological response data collected in this instance according to the video playback progress received at the beginning of collection at set time intervals, and the response collection apparatus uploads the terminal apparatus ID, the video ID, the physiological response data collected in this instance, the video playback progress corresponding to the physiological response data and the system time to the cloud server in real time.

With respect to the manner in which to always collect physiological response data, the manner in which to upload data to a cloud server by the video playback apparatus and the response collection apparatus includes

A. The data is uploaded by the video playback apparatus after the playback is ended/paused. (1) The video playback apparatus informs, when detecting that the playback of a video is ended/paused, the response collection apparatus of a system time when the playback of a video is started and a system time when the playback of a video is ended/paused, the response collection apparatus intercepts, from the collected physiological responses, a physiological response between the system time when the playback of a video is started and is ended/paused and sends the intercepted physiological response data and the corresponding system time to the video playback apparatus, which determines video playback progress corresponding to the received physiological response data and correspondingly uploads the terminal apparatus ID, the video ID, the physiological response data, the video playback progress corresponding to the physiological response data and the system time to the cloud server. (2) The video playback apparatus informs the response collection apparatus to feed back data when detecting that the playback of a video is started, the response collection apparatus sends the collected physiological response data and the corresponding system time to the video playback apparatus at set time intervals after receiving an instruction from the video playback apparatus, when detecting that the playback of a video is ended/paused, the video playback apparatus informs the response collection apparatus of a system time when the playback of a video is started and is ended/paused, the response collection apparatus intercepts, from the collected physiological responses, a physiological response between the system time when the playback of a video is started and is ended/paused, and the video playback apparatus determines video playback progress corresponding to the physiological response data and correspondingly uploads the terminal apparatus ID, the video ID, the physiological response data, the video playback progress corresponding to the physiological response data and the system time to the cloud server.

B. The data is uploaded in real time by the video playback apparatus during the playback process. The video playback apparatus informs the response collection apparatus to feed back data when detecting that the playback of a video is started, the response collection apparatus sends the collected physiological response data and the corresponding system time to the video playback apparatus at set time intervals after receiving an instruction from the video playback apparatus, and the video playback apparatus determines video playback progress corresponding to the physiological response data received in this instance and uploads the terminal apparatus ID, the video ID, the physiological response data received in this instance and the video playback progress corresponding to the physiological response data and the system time to the cloud server in real time.

C. The data is uploaded by the response collection apparatus after the playback is ended/paused. (1) When detecting that the playback of a video is ended/paused, the video playback apparatus informs the response collection apparatus of a system time when the playback of a video is started and a system time when the playback of a video is ended, and sends video playback progress corresponding to the system time when the playback of a video is started and/or is ended/paused to the response collection apparatus, which intercepts, from the collected physiological responses, a physiological response between the system time when the playback of a video is started and is ended/paused, the response collection apparatus determines video playback progress corresponding to the intercepted physiological response according to the received video playback progress, and the response collection apparatus correspondingly uploads the terminal apparatus ID, the video ID, the physiological response data, the video playback progress corresponding to the physiological response and the system time to the cloud server, and (2) When detecting that the playback of a video is started, the video playback apparatus informs the response collection apparatus of the video playback progress at this instant, the response collection apparatus determines video playback progress according to the video playback progress received at the beginning of collection at set time intervals, the video playback apparatus informs, when detecting that the playback of a video is ended/paused, the response collection apparatus of a system time when the playback of a video is started and is ended/paused, the response collection apparatus intercepts, from the collected physiological responses, a physiological response between the system time when the playback of a video is started and is ended/paused, and the response collection apparatus determines video playback progress corresponding to the intercepted physiological response data according to the received video playback progress, and correspondingly uploads the terminal apparatus ID, the video ID, the physiological response data, the video playback progress corresponding to the physiological response data and the system time to the cloud server, and

D. The data is uploaded in real time by the response collection apparatus during the playback process. The video playback apparatus informs the response collection apparatus of the video playback progress at this instant when detecting that the playback of a video is started, the response collection apparatus determines video playback progress corresponding to the physiological response data collected in this instance according to the video playback progress received at the beginning of collection at set time intervals, and the response collection apparatus uploads the terminal apparatus ID, the video ID, the physiological response data collected in this instance, the video playback progress corresponding to the physiological response data and the system time to the cloud server in real time.

### Sixth Embodiment

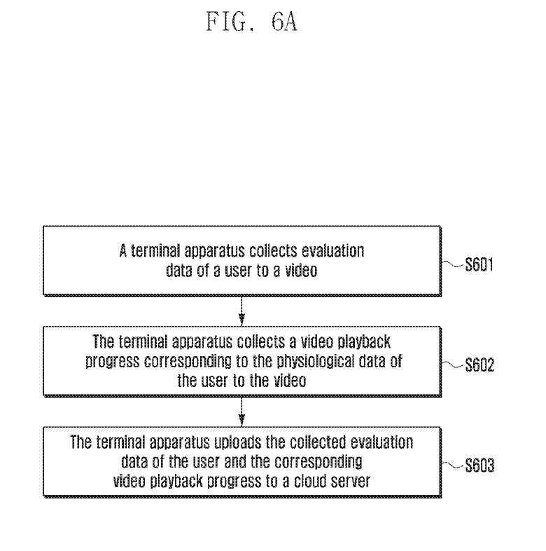

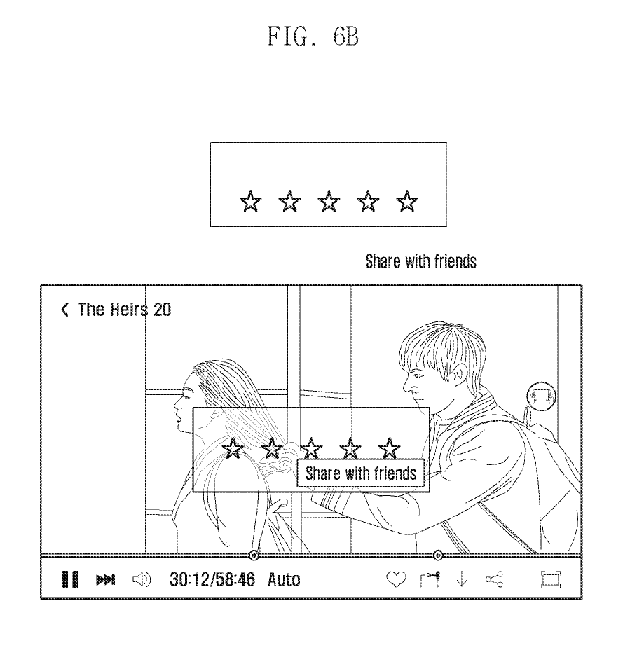

The sixth embodiment of the present disclosure provides a method for collecting evaluation data of a user to a video, as illustrated in FIG. 6A.

In step S601, a terminal apparatus collects evaluation data of a user to a video when a user watches a video on a terminal apparatus.

The evaluation data of the user to the video includes, but is not limited to, evaluation data of the video content, evaluation data of a specific character or other object content or a specific scene or other scene content in the video, and evaluation data related to the video in various aspects.

The terminal apparatus can collect rank evaluation data and/or numeric evaluation data input by the user to the video. The rank evaluation data can be at least one of a good, neutral and poor evaluation rank, or can be one of five-star rank, four-star rank three-star rank, two-star rank and one-star rank.

The user can input evaluation data with respect to the video, while watching a video by the terminal apparatus. The user can call out an evaluation data input region by a key, speech, gesture, or external apparatus, such as by calling out the evaluation data input region by clicking a virtual key for the video evaluation data, or the terminal apparatus displays an evaluation data display region and an evaluation data input region when the video playback region is zoomed to a certain size to play the video or when the video playback region is hidden, and the user inputs corresponding evaluation rank data in the evaluation data input region.

For example, FIG. 6B illustrates an example of evaluation data of the user to the video. The terminal apparatus calls out an evaluation data input region according to a user's instruction during the video playback process, and then displays five stars without filling in any color in the stars in the evaluation data input region. After receiving the five stars selected by the user through the evaluation data input region, the terminal apparatus fills the five stars selected by the user with a color so as to indicate the rank evaluation data input by the user to the video. In FIG. 6B, the more stars of the five stars are filled in by the user, the higher the rank evaluation of the video.

In step S602 of FIG. 6A, the terminal apparatus collects video playback progress corresponding to the evaluation data of the user to the video.

The time information corresponding to the evaluation data includes, but is not limited to, video playback progress corresponding to the evaluation data and a system time corresponding to the evaluation data.

The manner in which to acquire the video playback progress corresponding to the evaluation data by the terminal apparatus can include at least one of the following three methods.

(1) The terminal apparatus determines video playback progress when it is confirmed to input feedback data as the video playback progress corresponding to the evaluation data, including, when the terminal apparatus determines that the user might input evaluate data to the video after receiving an evaluation data input instruction from the user, such as a clicking event of a virtual key for inputting evaluation data of the video, the terminal apparatus calls out the evaluation data input region, then automatically records the video playback progress at this instant, and determines the recorded video playback progress as the video playback progress corresponding to the evaluation data of the user in this instance.

(2) The terminal apparatus determines video playback progress when it is confirmed to issue feedback data as the video playback progress corresponding to the evaluation data, including: when the terminal apparatus receives an evaluation data confirm instruction (for example, receiving an event of clicking a virtual key for issuing evaluation data), the terminal apparatus automatically records the video playback progress at this instant, and determines the recorded video playback progress as the video playback progress corresponding to the evaluation data of the user in this instance.

(3) The terminal apparatus determines video playback progress selected by the user as the video playback progress corresponding to the evaluation data, wherein the terminal apparatus can also receive video playback progress defined by the user, and determine the self-defined video playback progress as the video playback progress corresponding to the evaluation data in this instance.

For example, after the user completes the input of evaluation data and selects video playback progress corresponding to the evaluation data, such as by clicking or by dragging a progress bar, the terminal apparatus determines, after detecting that the selected video playback progress is confirmed by the user, the video playback progress selected by the user as the video playback progress corresponding to the evaluation data of the user in this instance.

In this embodiment of the present disclosure, when the user inputs evaluation data, the terminal apparatus can continue playing the video. In addition, it is also possible to pause the playback of a video when the user calls out an evaluation data input region, and resume playing the video after the user completes the content input and confirms the evaluation data.

The video playback apparatus and the evaluation data collection apparatus can be the same terminal apparatus.

For example, while a user watches a video on a smart phone, the user inputs evaluation data of the video. At this time, the smart phone is able to acquire the evaluation data of the user and video playback progress corresponding to the evaluation data. In this case, the evaluation data of the video may or may not be displayed on the terminal apparatus.

The video playback apparatus and the evaluation data collection apparatus can also be different terminal apparatuses. For example, the video playback apparatus can be a smart TV or a display apparatus in a public location such as a subway station or a bus station, while the evaluation data collection apparatus can be a smart phone or a tablet computer of the user. When a video is played on the video playback apparatus, the evaluation data collection apparatus can acquire video playback progress of the video playback apparatus by logging-in one user account, sound recognition, image recognition or QR code recognition. The user calls out an evaluation data input region in the evaluation data collection apparatus, inputs evaluation data, and confirms the evaluation data after the evaluation data is input. In this case, the evaluation data of the video can be displayed on one or both of the video playback apparatus and the evaluation data collection apparatus.

In step S603, the terminal apparatus uploads the collected evaluation data of the user and the corresponding video playback progress to a cloud server.

When the video playback apparatus and the evaluation data collection apparatus are the same terminal apparatus, the terminal apparatus can feed back data to a cloud server by correspondingly uploading the terminal apparatus ID, the video ID, the evaluation data and the time information corresponding to the evaluation data to the cloud server after detecting that the playback of a video is ended/paused, and can also perform real-time feedback during the playback progress, and correspondingly upload the terminal apparatus ID, the video ID, the evaluation data and the time information corresponding to the evaluation data to the cloud server at set time intervals.

The time information corresponding to the evaluation data includes, but is not limited to, video playback progress and a system time corresponding to the evaluation data.

When the video playback apparatus and the evaluation data collection apparatus are different terminal apparatuses, the video playback apparatus and the evaluation data collection apparatus feed back data to a cloud server by uploading the data, after the playback is ended/paused. (1) The evaluation data collection apparatus acquires video playback progress corresponding to the evaluation data in the above-described manner, and sends the video playback progress corresponding to the evaluation data and the time information of evaluating data of the video, to the video playback apparatus after receiving a collection stopping/pausing instruction sent by the video playback apparatus. The video playback apparatus correspondingly uploads the terminal apparatus ID, the video ID, the evaluation data and the time information corresponding to the evaluation data to the cloud server. (2) The evaluation data collection apparatus acquires video playback progress corresponding to the evaluation data in the above-described manner, and sends the video playback progress corresponding to the evaluation data and the time of evaluating data of the video, to the video playback apparatus at set time intervals, and the video playback apparatus correspondingly uploads the terminal apparatus ID, the video ID, the evaluation data and the time information corresponding to the evaluation data to the cloud server when detecting that the playback of a video is ended/paused.

The data is fed back in real time by the video playback apparatus during the playback process. The evaluation data collection apparatus acquires video playback progress corresponding to the evaluation data in the above-described manner, and sends the video playback progress corresponding to the evaluation data and the time of evaluating data of the video, to the video playback apparatus at set time intervals, and the video playback apparatus correspondingly uploads the terminal apparatus ID, the video ID, the evaluation data and the time information corresponding to the evaluation data to the cloud server.

The data is fed back by the evaluation data collection apparatus after the playback is ended/paused. (1) The evaluation data collection apparatus acquires video playback progress corresponding to the evaluation data in the above-described manner, and correspondingly uploads the terminal apparatus ID, the video ID, the evaluation data and the time information corresponding to the evaluation data to the cloud server after receiving a collection stopping/pausing instruction sent by the video playback apparatus. (2) The evaluation data collection apparatus acquires video playback progress corresponding to the evaluation data in the above-described manner, the video playback apparatus sends the video playback progress to the evaluation data collection apparatus at set time intervals, and the evaluation data apparatus correspondingly uploads the terminal apparatus ID, the video ID, the evaluation data and the time information corresponding to the evaluation data to the cloud server after receiving a collection stopping/pausing instruction sent by the video playback apparatus. The data is fed back in real time by the evaluation collection apparatus during the playback process. The evaluation data collection apparatus acquires video playback progress corresponding to the evaluation data in the above-described manner, and correspondingly uploads the terminal apparatus ID, the video ID, the evaluation data and the time information corresponding to the evaluation data to the cloud server at set time intervals after the user requests the evaluation data.

### Seventh Embodiment

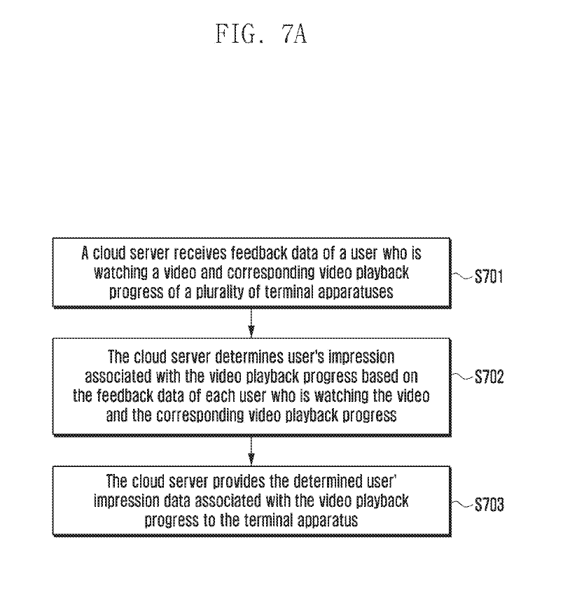

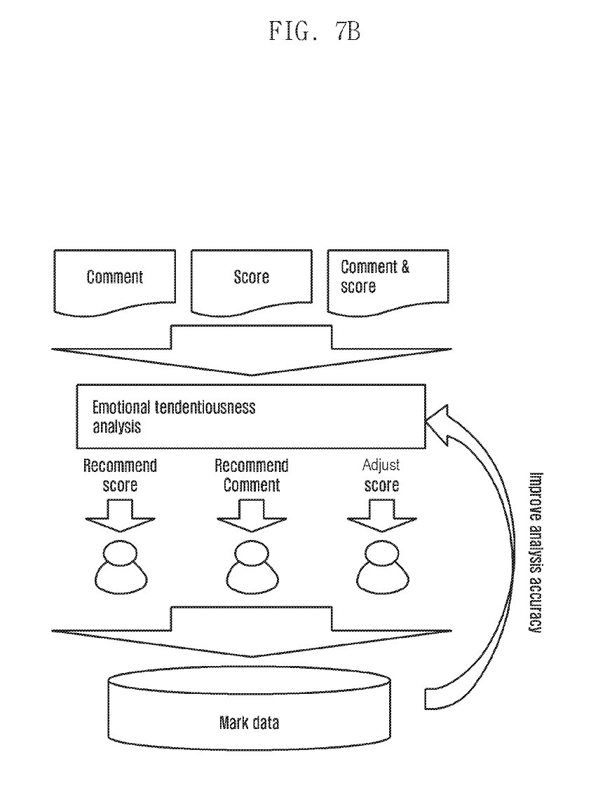

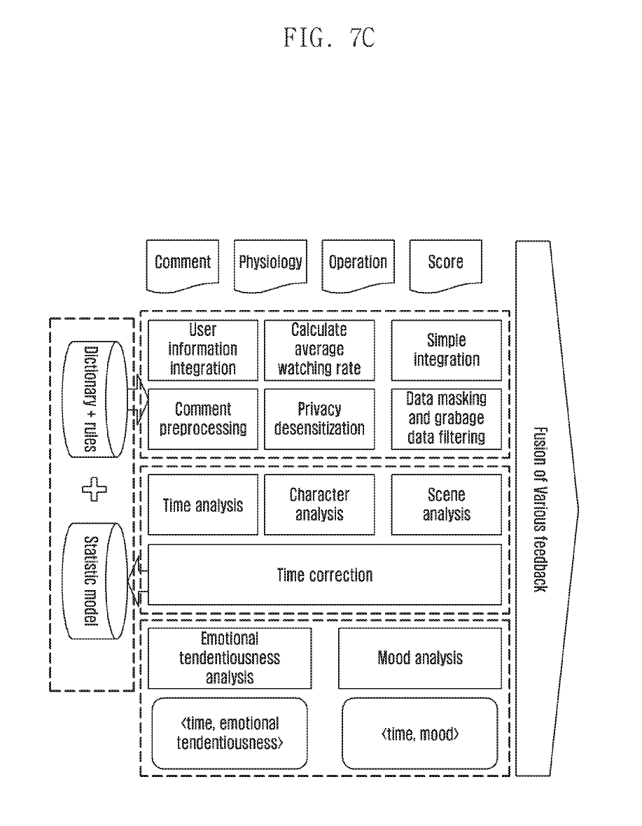

The seventh embodiment of the present disclosure provides a method for positioning a video by a cloud server, as illustrated in the method of FIG. 7A, which will now be described.

In step S701, a cloud server receives feedback data of users of a plurality of terminal apparatuses while watching a video and corresponding video playback progress.

Specifically, the cloud server receives feedback data of a user who is watching a video respectively uploaded by a plurality of terminal apparatuses, video playback progress corresponding to the feedback data of the user who is watching the video, a video ID and a terminal apparatus ID.

The cloud server receives a feedback message respectively uploaded by a plurality of terminal apparatuses, and then analyzes, from the feedback message, the terminal apparatus ID, the video ID, and the corresponding feedback data of the user who is watching the video and the video playback progress.

With respect to each received feedback message, the cloud server analyzes, from the feedback message, the terminal apparatus ID, the video ID, the feedback data of the user who is watching the video, and the video playback progress and system time corresponding to the feedback data of the user who is watching the video.

The feedback data of a user who is watching the video includes input data and/or physiological response data of the user. The input data includes at least one of comment, operation data and evaluation data of the user. The physiological response data includes at least one of expression information, action information, sound information and physiological indices of the user.

In step S702, the cloud server determines user's impression data associated with the video playback progress based on the feedback data of each user who is watching the video and the corresponding video playback progress.

The cloud server determines comment data of the user to the video and/or preference data of the user to the video, which are both associated with the video playback progress, based on the feedback data of each user who is watching the video and the corresponding video playback progress.

The preference data of the user to the video includes at least one of emotional tendentiousness data of the user to the video, mood data of the user who is watching the video, viewing rate data of the user who is watching the video; evaluation data of the user to the video, and overall data of degree of approval of the user to the video.

Specifically, for videos having the same video ID, with respect to each video playback progress in the videos, the cloud server uses all comment data corresponding to the video playback progress sent by a plurality of terminal apparatuses as the comment data corresponding to the video playback progress, so as to obtain correspondence data between the video playback progress of the video and the comment data. Similarly, correspondence data between the video playback progresses of a plurality of videos and the comment data can be obtained. A user ID of the comment data corresponding to video playback progress is determined according to the correspondingly received comments and user IDs.

The cloud server can correct the video playback progress corresponding to the comment data of the user who is watching the video according to at least one of comment content contained in the feedback data, object information of the video and scene information. The purpose of correcting the video playback progress is to cause the feedback of a user who is watching a video to correspond to a playback progress of the feedback data. If it is detected that the video playback progress fed back by a terminal apparatus is not consistent with the video playback progress actually corresponding to the feedback data, a correction is performed.

The correcting, by the cloud server, on video playback progress corresponding to the comment data of a user who is watching a video according to the comment content contained in the comment data includes acquiring comment text from the comment data, and recognizing the video playback progress of the video from the comment content of the comment text as the video playback progress recognized from the comment data. In addition, the system time can also be recognized.

Specifically, the cloud server can recognize, from the comment content of the comment text, words or phrases related to the video playback progress by using a preset rule or policy. For example, phrases such as “a few minutes ago”, “which episode” and “next episode” indicate the video progress or the sequence number of episodes of the video.

The cloud server can perform matching according to various predefined dictionaries and several modes by using suffix trees, regular expressions or other text formats to recognize words or phrases related to the video playback progress.

For example, a simple dictionary includes the following contents:

an Arabic numeral dictionary: 0 to 9, represented by NUM;

a Chinese numeral dictionary: zero to nine, represented by cNUM;

a time interval symbol dictionary: :/-, represented by SEG;

a time expression prefix/suffix dictionary: before, after, represented by CON;

a time range dictionary: begin, since, represented by INT;

a time unit dictionary: second, minute, hour, represented by UNIT;

a progress indicator dictionary: at, the part, represented by FLAG; and

the mode can include at least one of absolute time mode, relative time mode and time period mode.

For example, in the above simple dictionary and in the absolute time mode,

according to the text format [NUM][NUM][SEG][NUM][NUM], “12:30” can be recognized; and

according to the text format [cNUM][UNIT][cNUM][UNIT][FLAG], “at 5′30” can be recognized.

In the above simple dictionary and in the relative time mode, according to the text format [cNUM][UNIT][cNUM][UNIT][CON], “before 5′30″” can be recognized; and

In the above simple dictionary and in the time period mode,

according to the text format [INT][NUM][UNIT][INT], “since (the video) began for 3 minutes” can be recognized.

The cloud server performs grammar and semantic analyses on the words or phrases related to the video playback progress that is recognized from the comment content of the comment text to obtain video playback progress of the video, and then uses this video playback progress as video playback progress recognized from the comment data. If words or phrases related to the system time are recognized from the comment content of the comment text, grammar and semantic analyses are performed on those words or phrases to obtain the system time, so that video playback progress corresponding to the system time is determined.

For each piece of the received comment data, the cloud server corrects the video playback progress corresponding to the comment data according to the video playback progress recognized from the comment data. For example, the video playback progress corresponding to the comment data is replaced with the video playback progress recognized from the comment data.

The cloud server corrects the video playback progress corresponding to the comment data according to the comment content contained in the comment data and/or object information of the video, by recognizing the object information from the received comment data.

For each piece of the received comment data, the cloud server recognizes object information from the comment content of the comment text of this comment by using a text analysis method. For example, the name or alias of the actor, the name or alias of the role or the relation name (including the realistic relation of a character and the relation of the video character) is recognized from the comment content of the comment text.

Disambiguation is performed on the recognized object information according to a database, including when the same name defines different meanings and when a plurality of personal names refer to the same person. The database can be a knowledge base of reference information about names and relations, and the training method of the database can include: preliminarily constructing from a structured knowledge base directly, then automatically learning from the semi-structured or unstructured data in the Internet, and performing human-aided correction and management.

Since a person name may have ambiguity, disambiguation is usually performed by using the context. For example, Charlotte is a personal name in some episodes, but in “Goodbye Mr. Loser”, Xia Luo is a person name. In this step, three methods can be employed, i.e., a dictionary (rule)-based method, a statistics-based method, and a combination of the dictionary-based method and the statistics-based method. Taking “combination of the dictionary-based method and the statistics-based method” as an example, the specific recognition method includes matching a candidate personal name according to the dictionary, constituting the context information of the personal name candidate (including information about the video itself) into several features, then determining whether it is a personal name by using a support vector machine (SVM) or other classifiers, and determining the person corresponding to this personal name.

A certain relation between objects is recognized by a method similar to the method for recognizing a personal name. For example, considering rivals in love, from the existing relation “rival<Xia Luo (gh08420512), Yuan Hua (dg023690r)>” in the knowledge base, it is recognized that the subject of evaluation “the scene that the rival of Xia Luo confesses his love to the actress II is funny” is “Yuan Hua”. The expression form of a particular relation in the knowledge base can be normalized into relation<personal name A (ID A), personal name B (ID B)>.

Object information such as characters of each frame of images of the video is recognized in advance by using an image recognition method. The object information obtained by the image recognition is associated and fused with the object information recognized by the text analysis.

In this embodiment of the present disclosure, the cloud server can regularly collect a large amount of videos, such as by receiving those uploaded by the user's terminal apparatus, and then store these videos.

The cloud server searches, with respect to the object information recognized from the comment data or the object information obtained after the association and fusion, a video associated with the comment data or the object information, and acquires video playback progress at the time when the object information appears in the searched video. For example, the content of the searched video is recognized, and when it is recognized that at least one frame image containing the recognized object information appears in the video, video playback progress at the time when the frame image appears is acquired.

For the object information recognized from the comment data or obtained after the association and fusion, the cloud server corrects the video playback progress corresponding to the received comment data, according to the acquired video playback progress corresponding to a video frame or video fragment of the video containing the object information.

The cloud server corrects the video playback progress corresponding to the comment data according to the comment content contained in the comment data and/or scene information of the video.

Specifically, for each piece of the received comment data, the cloud server recognizes scene information from the comment content of the comment text of the comment data by using a text analysis method.

The text analysis is performed by a rule-based method, a statistic model, and a combination of the rule-based method and the statistic model. The statistic model can be at least one of a conditional random field (CRF) model, an SVM model, and a hidden Markov model (HMM).

Taking the statistic method as an example, each word in the text in the following Table 1 may be labeled.

TABLE 1

| The | dialogue | of | Li | Xiao | Long | in | the | film | making | studio | is | very | philosophical |
|---|---|---|---|---|---|---|---|---|---|---|---|---|---|
| O | O | O | P-B | P-I | P-E | O | O | L-B | L-I | L-E | O | O | O |

In Table 1, P denotes a personal name, L denotes a place name, and B, I and E denote a starting position indicator, an internal position indicator and an ending position indicator, respectively. Thus, the personal name “protagonist” and the place name “in the elevator” can be extracted according to the result.

Scene information in each frame of images of the video is recognized by using an image recognition method in advance, and a correspondence is then established between the recognized scene information and the video playback progress of the video. The scene includes a plurality of dimensions, such as place, clothing, picture color, and current plot category, and the image recognition is off-line processing. The scene information obtained by the image recognition is associated and fused with the scene information recognized by the text analysis.

The cloud server searches, with respect to the scene information recognized from the comment data or the scene information obtained after the association and fusion, a video associated with the comment data or associated with the scene information, and acquires video playback progress at the time when the scene information appears in the searched video. For example, the content of the searched video is recognized, and when it is recognized that at least one frame image containing the recognized scene information appears in the video, video playback progress at the time when the frame image appears is acquired.

For the scene information recognized from the comment data or obtained after the association and fusion, the cloud server corrects the video playback progress corresponding to the received comment data according to the acquired video playback progress corresponding to a video frame or video fragment of the video containing the scene information.

The cloud server determines at least one of the following data based on the feedback data of a user who is watching a video: viewing rate data, emotional tendentiousness data, mood data, and evaluation data associated with the video playback progress of the video.

The cloud server determines the emotional tendentiousness data associated with the video playback progress of the video based on at least one of comment data, physiological response data, and evaluation data of the user to the video.

For each video playback progress, the cloud server estimates emotional tendentiousness data corresponding to the video playback progress according to the comment data corresponding to the video playback progress, by using a rule-based and/or a statistics-based method.

The rule-based method is used to give a corresponding emotional tendentiousness score to the comment by using the pre-constructed emotional word dictionary and corresponding rules. For example, the emotional word dictionary contains words expressing a positive emotion, such as “handsome” and “like”. In the comment “Professor Du is so handsome that I really like him”, it can be seen that the tendentiousness of this comment is +2. If there is a negative word for modifying the emotional words, for example, “not”, it is required to give a negative score for the corresponding emotional tendentiousness.

The model-based method is used to give an emotional tendentiousness score to the comment according to the output result of a classifier by using a corresponding supervised or semi-supervised model. In this method, various features are extracted from the pre-processed comment data and can be represented by a vector form, where each dimension of a vector represents a certain feature. Then, the emotional tendentiousness score of the comment is predicted by using a linear regression or a support vector machine (SVM) regression algorithm, for example.

Since the rule-based method cannot cover all possible models, and the statistics-based method heavily depends upon mark data, it is also possible to employ a combination of the rule-based method and the statistics-based method. That is, the rules are regarded as features and as the input of the statistics-based method, or the result of the statistics-based method is corrected by using the rules.

The cloud server estimates emotional tendentiousness data corresponding to video playback progress according to the text comment, speech comment or other comments corresponding to the video playback progress.

For each video playback progress, the cloud server estimates emotional tendentiousness data corresponding to the video playback progress according to the physiological response data corresponding to the video playback progress.

The physiological response data includes expression information, action information, sound information, as well as body temperature, heart rate, blood pressure or other physiological indices. The emotional tendentiousness analysis of the expression information, action information or other image information is generally performed by two feature construction methods, and then the classification or prediction of tendentiousness is performed according to features.

The first feature construction method is to artificially construct features. Some key features are extracted from a face or an action. For example, some relatively invariable “anchor points”, such as the tip of a nose, are used as some fixed reference points or facial action units, and then the emotional tendentiousness is determined by using a variable point, such as the corners of the mouth. Alternatively, some features related to rhythms, frequency spectra and quality of sound are extracted from speech signals. The speech feature can be extracted by frames, and the overall statistical feature of the current sentence is then calculated maximally, minimally or other methods.

The second feature construction method is used to automatically construct upper features according to the original features of the image information, sound information and physiological indices, for example, by intensive feature engineering.

For each video playback progress, the cloud server estimates emotional tendentiousness data corresponding to the video playback progress according to the comment data and physiological response data corresponding to the video playback progress, and according to the comment data and evaluation data corresponding to the video playback progress.

Specifically, the cloud server can integrate evaluation data information according to the comments or evaluation data, and the emotional tendentiousness data of the user to the video is represented by the evaluation data information.

Since the statistics-based method requires mark data, when the data is too sparse and inaccurate, it is required to expand the data to mark data automatically according to the evaluation data feedback of the user.

Specifically, a data set corresponding to the comment data and the evaluation data are continuously expanded according to different comment submission conditions, so that the emotional tendentiousness recognition is more accurate and the degree of participation of the user is high.

For example, FIG. 7B illustrates an example of integrating the comment data and/or the evaluation data. As illustrated in FIG. 7B, if there are only comments, the system automatically evaluates data according to the comments and makes recommendations to the user so as to help the user to quickly evaluate data. If there is only evaluation data, the system recommends hot comment candidates having a closer score so as to guide the user to submit comments. If there are both comments and evaluation data, the system can directly expand a mark data set, or can also perform adjustment on the evaluation data. If there is a large difference between the evaluation data of the user and the evaluation data recommended by the system, the system asks the user whether to make a change.

By the above processing, the <comment, evaluation data> correspondence data is stored in a training data set, thereby improving the accuracy of the system in determining the emotional tendentiousness data corresponding to the video playback progress.

For each video playback progress, the cloud server estimates mood data corresponding to the video playback progress according to the comment data and physiological response data corresponding to the video playback progress.

For each video playback progress, the cloud server automatically determines the mood type, such as happiness, vigilance, anger, disgust, sadness, surprise, fear, or worship, and mood intensity or mood amplitude of the user at the video playback progress, according to the received comment data and physiological response data corresponding to the video playback progress.

The feature extraction method and the analysis method are similar to the method for recognizing words or phrases associated with video playback progress from the comment content of the comment text as described above. The difference, however, is that corresponding rules and models for analysis and prediction are different due to different recognition purposes. The feature extraction method and the analysis method will not be repeated here.

By the above processing, correspondence data between the video playback progresses of a plurality of videos and the mood data of the user can be obtained. The mood data of the user can include a plurality of dimensions, and the correspondence between video playback progress and the amplitude of each mood dimension can be obtained. For example, happiness, trust, admiration, fear, or surprise represent a plurality of dimensions of the mood data.

The cloud server determines viewing rate data corresponding to video playback progress of a video according to the feedback data of a user who is watching a video uploaded by each terminal apparatus.

The cloud server can calculate viewing rate data at each video playback progress moment according to the operation data in the feedback data of a user who is watching a video fed back by each terminal apparatus. The viewing rate data can represent the actual watching condition of each user to the video. For example, if a user performs a dragging operation while watching a video, the video content from the point prior to dragging to the point after dragging is not watched by the user, so that the corresponding viewing rate data is relatively low.

Some operations will increase the viewing rate, for example, a marking, fast-reverse, pause, zoom, interception, or video sharing operation performed on the video.

Some operations will reduce the viewing rate, such as a user's operation of dragging the video or a fast-forward operation.

By the above processing, correspondence data between video playback progress of a video and the viewing rate data can be obtained, where the video playback progress of each video corresponds to the corresponding viewing rate data.

For each video playback progress, the cloud server can determine overall data of degree of approval associated with the video playback progress of the video according to at least one of the viewing rate data, emotional tendentiousness data and mood data corresponding to the video playback progress.

For each video, with respect to each video playback progress of the video, the cloud server can obtain emotional tendentiousness data, mood data, viewing rate data and evaluation data or other preference data of the user to the video according to the above contents of this step, respectively.

The cloud server can obtain a correspondence between the video playback progress and the evaluation data, according to the evaluation data of the user to the video uploaded by each terminal apparatus. With respect to each video playback progress, the cloud server processes the evaluation data of each user, such as by performing average processing to obtain an average score, and then uses the processed evaluation data as evaluation data corresponding to the video playback progress.

Preference data, of each same type, of all users is averaged, and the overall emotional tendentiousness data, mood data, viewing rate data, and evaluation data corresponding to each video playback progress is obtained.

The overall data of degree of approval corresponding to video playback progress is determined by weight fusion and/or numerical fitting.

Specifically, the overall degree of approval of each video playback progress is obtained by one of the following two fusion methods.

Method 1: According to a preset combination mechanism, the overall emotional tendentiousness data, mood data, viewing rate data and evaluation data corresponding to each video playback progress and other preference data of a user to the video are combined to obtain the overall data of degree of approval corresponding to the video playback progress, as the following will explain.

The preset combination mechanism can be multiplication or weighted addition, multiplication of weights, logarithm, power, or exponent, for example, and the weights can be adjusted at any time.

For example, the preset combination mechanism can be one of the following combination mechanisms:

(weight a*emotion)*(weight b*mood amplitude)*(weight c*viewing rate)*(weight d*evaluation data),

(weight a*emotion)+(weight a*evaluation data)*(weight a*mood amplitude)*(weight a*viewing rate), and

(weight a*emotion)+(weight a*evaluation data)+(weight a*mood amplitude)+(weight a*viewing rate).

Method 2: The degree of approval of each video playback progress is marked by other methods, such as by counting the number of watching audiences at the playback progress moment or questionnaire surveying the goodness of each video playback progress, and the final overall data of degree of approval is predicted by automatically learning a fitting formula by using a linear or nonlinear fitting algorithm.

The overall data of degree of approval corresponding to video playback progress of a video can be obtained through the above two methods.

Prior to correcting the video playback progress corresponding to the comment data according to the comment content contained in the comment data in the feedback data of the user who is watching the video, the cloud server can preprocess the comment data in the received feedback data of the user who is watching the video to obtain comment text.

Specifically, with respect to the text comment or emoticon comment, for convenience of subsequent processing, natural language processing is performed on the text content in the text comment or the emoticon comment according to different languages so as to obtain the comment text. For example, word segmentation, part-of-speech marking or other steps are performed on the text content of the text comment to obtain the comment text.

Considering processing in Chinese as an example, the word segmentation of the text content of the text comment indicates that a sequence of Chinese characters in the text comment is partitioned into individual words to obtain a word set of the text comment. Based on a preset statistic model, the part-of-speech of each word in the word set of the text comment, such as noun, pronoun or adjective, is marked so as to obtain the comment text. For a word having several parts-of-speech, the role of this word in the context can be recognized according to the word and its part-of-speech.

For the speech comment, text content can be recognized from the speech comment by speech recognition, or the speech comment is converted into the text comment, and the above preprocessing of the text is performed to obtain comment text.

For the image comment and the video comment, different preprocessing methods are used for the contents of the image and the video to obtain comment text.

For a text image and a text video, or for an image and a video based on text content, text information of the content is directly recognized by characters or by handwriting recognition. Alternatively, the image comment or the video comment is converted into the text comment, and the above preprocessing of the text is performed to obtain comment text.

For a non-text image and a non-text video, or for an image and a video not based on text content, the semantic feature, such as characters, objects, events, scenes and relations of the image content is recognized by image recognition, and is then converted into corresponding text information. Alternatively, the image comment or video comment is converted into the text comment, and the above preprocessing of the text is performed to obtain comment text.

The preprocessed comment text can be stored in correspondence to the comment before preprocessing. When the same comment is subsequently received again, the preprocessing step may be skipped, and the comment content stored in correspondence to the subsequently received comment can be directly searched as the preprocessed comment text, thereby improving the processing efficiency.

The cloud server can integrate user information uploaded by each terminal apparatus.

Each user ID will correspond to respective user information, including at least one of name, age, family situation, income, job, post, permanent residence, education/skill/knowledge level, and interest/preference tag.

The user information can be selected by a user in registering to video playback software or logging into video playback software, and a terminal apparatus reports the information selected by the user to a cloud server which integrates the user information. When not receiving the information selected by the user, the terminal apparatus can complement the information by a prediction algorithm, or the cloud server can complement the information.

The user information can be used for sequencing the comment information of the user, for example.

The cloud server can perform simple integration on the received feedback data of a user who is watching a video.

For a same video, the comments, operation data, physiological response data, evaluation data and other information at the same instant or during the same time period of video playback progress are integrated according to the uniqueness of the video playback progress of the time field.

A correspondence table obtained after the simple integration can include the following fields: video ID, system time, video playback progress of the video, feedback content, and terminal apparatus ID of a user who watches the video. The specific comments, operation data, physiological response data, evaluation data and other information are filled in the feedback content field.

The cloud server can perform privacy desensitization on the received feedback data of a user who is watching a video.

To ensure the security of user's privacy in the data, sensitive information is processed by confusion, encryption or masking sensitive data, whiling ensuring the effectiveness of the sensitive information. The sensitive information includes account number, phone number, password, and gender, for example. The privacy desensitization can be performed by various desensitization methods, including but not limited to replacement, encryption and decryption, randomization, fuzzification, data formatting, and user-defined algorithms.

The cloud server can perform data masking on the received feedback data of a user who is watching a video.

The data masking can recognize and mask a plurality of masking levels, such as a complete masking level which is associated with national politics and economy, eroticism or other public sensitive comment information, and an age-specific masking level, including violence, vulgarity, pornography, offensive words, gambling, and narcotics, for example. The age-specific masking level can be partitioned into different masking levels, such as age groups including 12 and under, 15 and under, and 18 and under. For example, if a user is under 12 years old, comment information about violence, vulgarity and pornography are automatically filtered out.

The manifestation form includes, but is not limited to, text comment/speech comment/video comment/picture comment/expression comment. The masking is performed in various manners, including supervised methods such as Bayesian classification, linear regression, support vector machine, decision tree and decision forest, and unsupervised matching methods, i.e., matching according to predefined rules and masking words, or matching according to rules discovered by associated rules and masking words.

The cloud server can perform garbage data filtering on the received feedback data of a user who is watching a video.

The garbage data filtering includes filtering of garbage users and garbage feedback data. The garbage users include, but are not limited to, robots, and advertising and marketing users. The garbage feedback data includes, but is not limited to, irrelevant evaluations, advertising and marketing, malicious or false evaluations, operations and score of non-human behavior. By using such information as the login IP of the user, media access control (MAC) address, frequency, geographical position, comment time, access records, and comment content, the filtering can be performed in various manners, including supervised methods such as Bayesian classification, linear regression, support vector machine, decision tree and decision forest, and unsupervised matching methods, i.e., matching according to predefined rules and garbage words, or according to rules discovered by associated rules and garbage words, so as to recognize suspicious garbage users and garbage feedback data.

FIG. 7C illustrates an example of managing, by a cloud server, feedback data of a user who is watching a video, according to a seventh embodiment of the present disclosure.

Returning to FIG. 7A, in step S703, the determined user's impression data associated with the video playback progress is provided to the terminal apparatus.

The cloud server actively pushes user's impression data associated with the video playback progress to the terminal apparatus, either automatically or in response to a request from the terminal apparatus. Thus, the terminal apparatus positions the content of the video according to the user's impression data.

Specifically, the cloud server pushes the user's impression data associated with the video playback progress to the terminal apparatus, including at least one of the following:

The processed (privacy desensitization/data masking/garbage data filtering) comment data, the corrected video playback progress, and the correspondence data between the video playback progress and the comment data of the user to the video, between the video playback progress and the emotional tendentiousness data of the user to the video, between the video playback progress and the mood data of the user who is watching the video, between the video playback progress and the viewing rate data of the user to the video, between the video playback progress and the evaluation data of the user to the video, and between the video playback progress and the overall degree of approval. The correspondence data can be sent to the terminal apparatus together with the comments, or can also be returned to the terminal apparatus according to the related request from the terminal apparatus.

The cloud server can alternatively predetermine an electronic text corresponding to the video, then analyze the video content and the electronic text content, divide the video into a plurality of video fragments in terms of video content, such as plot, and determine electronic text content corresponding to each of the video fragments, i.e., establish a correspondence between the video fragments (or video content) and the electronic text content. The cloud server determines a correspondence between the video playback progress of the video and the electronic text content according to the correspondence between the video fragments and the video playback progress of the video. In the step S703 of FIG. 7A, the cloud server can send the obtained correspondence data between the video fragments (or video content) and the electronic text content and the correspondence data between the video playback progress and the electronic text content to the terminal apparatus.

The electronic text content can be a novel, prose, an essay, a poem, actual literature, a news report, or a thesis, for example.

Considering a cloud server as an example, the steps illustrated in FIG. 7A describe a method of processing and integrating, by the cloud server, the feedback data of a user to a video to obtain user's impression data.

As understood by a person skilled in the art, in the seventh embodiment of the present disclosure, it is also possible to process, by a terminal apparatus, data to generate user's impression data according to the feedback data of a user who is watching a video from a plurality of other terminal apparatus and the video playback progress corresponding to the feedback data of the user who is watching the video, for enabling this terminal apparatus or other terminal apparatuses to acquire the user's impression data for positioning the video.

### Eighth Embodiment

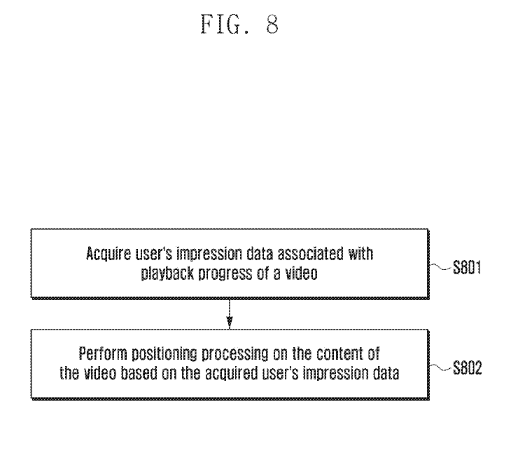

FIG. 8 illustrates a method for positioning a video on a terminal apparatus side according to an eighth embodiment of the present disclosure.

In step S801, user's impression data associated with a playback progress of a video is acquired.

A terminal apparatus can acquire user's impression data associated with video playback progress of a video from a cloud server when the video is not played, or during the video playback process.

The user's impression data includes comment data of the user to the video, and/or preference data of the user to the video. The preference data of the user to the video includes at least one of emotional tendentiousness data of the user, mood data of the user, viewing rate data, evaluation data and overall data of degree of approval.

In step S802, the content of the video is positioned based on the acquired user's impression data.

The positioning the content of the video based on the acquired user's impression data specifically includes at least one of positioning the content of the video based on the comment data, positioning object content of the video based on the comment data, positioning scene content of the video based on the comment data, and positioning the content of the video based on the preference data.

The positioning the content of the video based on the acquired user's impression data further includes at least one of positioning and displaying electronic text content associated with the video based on the comment data, downloading the video based on the preference data, and intercepting and sharing the video based on the preference data.

### Ninth Embodiment

The present disclosure considers that a user may browse comments of other users to a video while watching the video by a terminal apparatus, and the user might wish to acquire video content corresponding to the comment content if the user is interested in the comment content. However, in the prior art video positioning method, a user may attempt to search video content corresponding to the comment content by manually dragging video playback progress bar, rendering it difficult for the user to quickly search the video content corresponding to the comment content. The user may search the video content corresponding to the comment content by performing multiple dragging operations, rendering it tedious and low in efficiency for the user to perform this search.

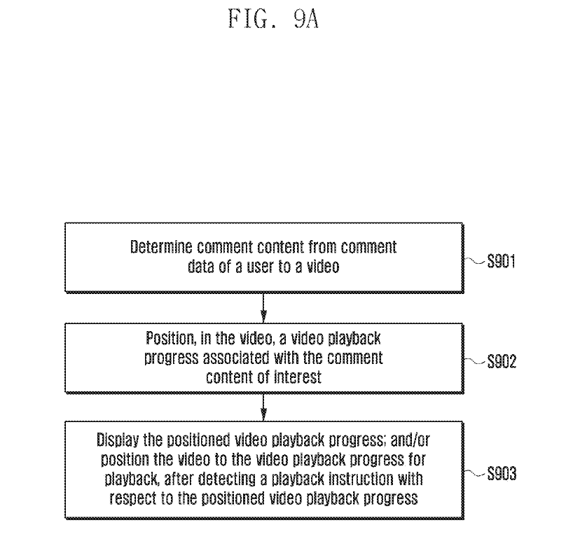

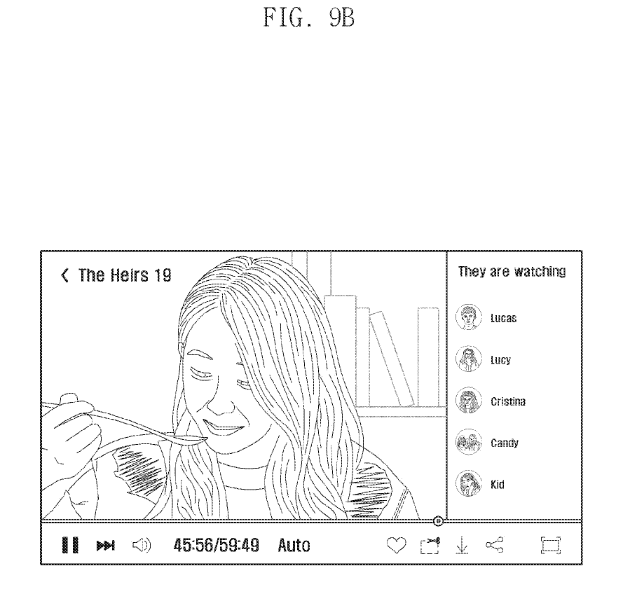

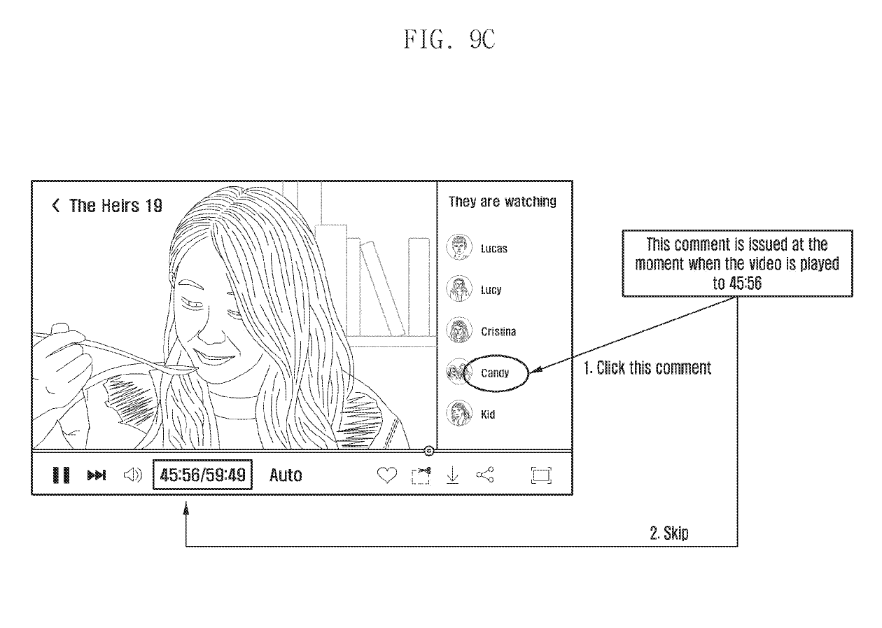

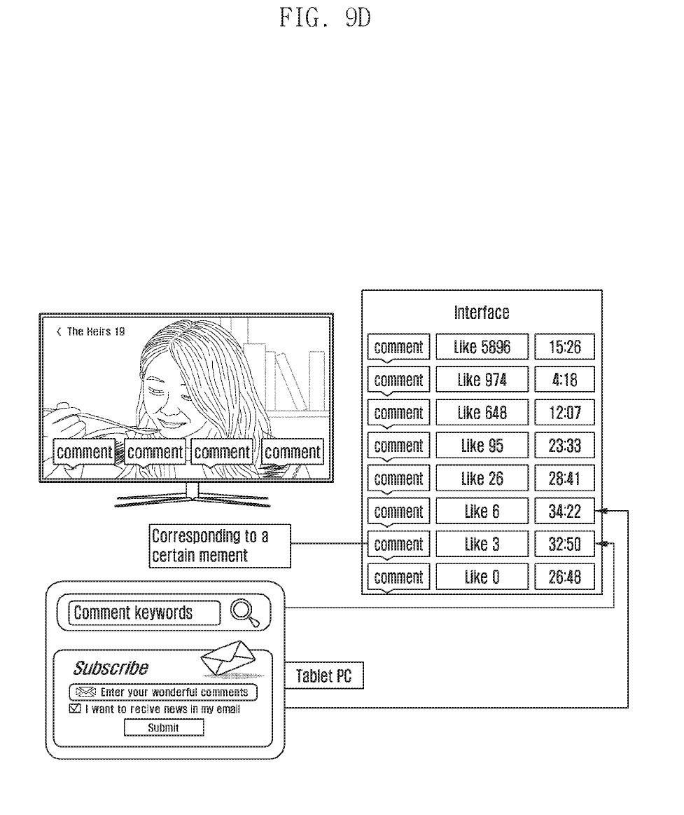

To cure these problems, the ninth embodiment of the present disclosure as illustrated in FIG. 9A, provides a method for positioning content of a video based on comment data. In step S901, comment content of interest is determined from comment data of a user on a video.

A terminal apparatus displays comment data associated with video playback progress of a video.

Specifically, for a video, the terminal apparatus searches comment data associated with video playback progress of the video, from the relation data of the comment data of the acquired user's impression data and video playback progresses, and displays the comment content, such as comment contents of a plurality of pieces of comment data corresponding to a plurality of video playback progresses of the video. The plurality of comment contents can be displayed in a list, with one comment content being displayed in each row or column of the list.

The terminal apparatus can also sequence comment contents of the video, which are sequenced according to the time or the number of thumbs-up of the comment data, or according to the user information (e.g., user name) of users.

For example, a user triggers an instruction for sequencing according to the user information, where the user can select the specific type and sequencing mode of the user information, such as based on the age of comment users from the eldest to the youngest. The terminal apparatus sends a sequencing request to a cloud server after receiving the instruction. The cloud server then sequences comment data of each user to the video according to the specific type and sequencing mode of the user information selected by the user and feeds back the sequencing result to the terminal apparatus, which displays the received sequencing result.

The user can also select and separately display comments of users having user information of a certain particular type. The terminal apparatus sends a request to the cloud server, which extracts comment data issued by the users of the particular type and feeds back the extracted comment data to the terminal apparatus which displays the comment content of the received comment data.

FIG. 9B illustrates an example of displaying comment content by a terminal apparatus according to the ninth embodiment of the present disclosure. As illustrated in FIG. 9B, during the video playback process, in correspondence to the arrangement of video playback progresses, the terminal apparatus displays comment contents of users having user IDs “Lucas”, “Lucy”, “Cristina”, “Candy” and “Kid”.

The terminal apparatus detects an operation of selecting comment content, and then determines the selected comment content as comment content of interest of the user.

For example, the user can select the comment content of interest from the comment contents displayed in a video playback interface by speech, a key, a gesture or an external apparatus.

Determining the comment content selected by the user according to the speech of the user includes collecting the speech of the user after receiving a speech collection instruction input by the user, recognizing, from the speech input by the user, information associated with a function of positioning a video according to comments by speech recognition, and activating the function of positioning a video according to comments, continuing to recognize, from the speech input by the user, information associated with the comment content, such as words in the comment content or a display position of the comment content in the interface, and determining the comment content as the comment content of interest of the user according to the information associated with the comment content.

For example, if a user sends speech “watch the video corresponding to the second comment”, after performing speech recognition on the speech, the terminal apparatus knows by analysis that the purpose of the user is to activate a function of positioning a video according to comments, and the current display position of the comment content selected by the user in the video playback interface is the second position, so the terminal apparatus activates the function of positioning a video according to comments and determines the second comment content as the comment content of interest selected by the user.

The terminal apparatus can determine the comment content selected by the user according to a key clicking event, such as performed by a hardware key on the terminal apparatus, i.e., the home or sound adjustment key, or the key can be a virtual key on a user interface (UI) of the terminal apparatus.

For example, a user selects comment content of interest by a sound adjustment key and then confirms the selection by the home key, and the terminal apparatus determines the selected comment content of interest according to the operation of the user.

A user can directly click certain comment content of interest, and the terminal apparatus determines the comment content of interest selected by the user according to the operation of the user. Alternatively, the terminal apparatus displays a positioning virtual key besides each piece of comment content while displaying comment content, and determines the comment content selected by the user as the comment content of interest when the user clicks the positioning virtual key. The user can click the virtual key in a predetermined manner, such as by short pressing, long pressing, short pressing a predetermined number of times, or alternate short and long pressing, for example.

FIG. 9C illustrates an example of positioning a video according to comments, according to the ninth embodiment of the present disclosure. As illustrated in FIG. 9C, when a user watches a video in the video playback interface of a terminal apparatus, the comment content issued by each user to the video can be simultaneously displayed on a side of the playback interface. Assuming that the current video playback progress is 30′40″ and the user clicks a display region where the comment content issued by “Candy” is located, after detecting the click event of the user, the terminal apparatus determines that the user performs a selection operation on the comment content issued by “Candy”.

The terminal apparatus can determine a comment selected by the user by detecting the gesture of the user, such as a screen gesture. For example, if the user performs a set gesture to a certain comment on the screen, the terminal apparatus confirms the comment content of interest selected by the user upon detecting the set gesture of the user. The gesture can also be an air gesture.

The terminal apparatus can determine the comment content of interest selected by the user, by receiving the comment content of interest and/or video playback progress associated with the comment content of interest sent by an external apparatus. For example, when the terminal apparatus is connected with a stylus, the user can select the comment content of interest by a key on the stylus, the stylus feeds the operation of the user back to the terminal apparatus through the connection, and the terminal apparatus determines the comment content of interest selected by the user according to the received operation of the user.

The user can select the comment content of interest from the comment contents currently displayed by the terminal apparatus. However, if there are numerous comments, it is very difficult for the user to find the comment content of interest from a large amount of comment contents. To cure this matter, the present disclosure provides that comment contents searched according to the keyword input by the user can be displayed prior to determination of the comment content of interest.

Specifically, the terminal apparatus can display a comment search box in the video playback interface, and the user can input a search keyword in the comment search box. The terminal searches, from the comment contents corresponding to the video, comment contents matched with the search keyword according to the search keyword input by the user, and displays the comment contents searched according to the keyword input by the user. The user can select the comment content of interest from the searched comment contents, in the above-described manner of selecting the comment content of interest, and the terminal apparatus determines the comment content of interest of the user according to the selection operation of the user. To enable a user to more quickly select the comment content of interest, the terminal apparatus can also sequence the searched comments according to the matching degree with the search keyword, and then display the searched comments.

The system presets a series of keywords related to a video, for example, the name and nickname of a role or a role player in the video, the name of an animal, and the name of a scenery. When a keyword mentioned above is included in a comment content, the keyword is highlighted (e.g., underlined) while displaying the comment content.

Returning to FIG. 9A, in step S902, video playback progress associated with the comment content of interest is positioned in the video.

After determining the comment content of interest selected by the user, the terminal apparatus positions video playback progress associated with the comment content of interest in the video.

Specifically, the comment content and the video playback progress corresponding to each piece of comment data by each user are stored in the terminal apparatus. When a user is browsing the comment content with respect to a video, and if there is comment content of interest, the user performs a predetermined selection operation on certain comment content of interest. After determining the comment content selected by the user, the terminal apparatus can search, from the stored data, video playback progress corresponding to the comment data containing the comment content of interest.

For example, as illustrated in FIG. 9C, after determining that the user performs a selection operation on the comment content issued by “Candy”, the terminal apparatus finds that the video playback progress corresponding to the comment content is 45′56″.

After detecting a selection operation to a keyword in the comment content of interest, the terminal apparatus determines video playback progress associated with the comment content of interest containing the keyword.

The above two manners of positioning video playback progress of a video can be manually selected by a user, or can be automatically selected by a terminal apparatus according to the preset priority.

In step S903, the positioned video playback progress is displayed by the terminal apparatus, and/or the video is positioned to the video playback progress for playback after detecting a playback instruction with respect to the positioned video playback progress.

For example, the positioned video playback progress is marked on the playback progress bar of the video, for enabling a user to freely select for skipped playback.

With respect to the video playback progress positioned in step S902, the terminal apparatus positions the video to the video playback progress for playback after detecting a playback instruction with respect to the video playback progress.

In this embodiment of the present disclosure, the terminal apparatus can determine the reception of a playback instruction with respect to the positioned video playback progress after detecting a selection operation of the user with respect to the comment content. That is, after the user selects the comment content of interest, the terminal apparatus automatically positions the video to the corresponding video playback progress for playback, or the terminal apparatus can also position the video to the corresponding video playback progress after detecting a selection operation of the user with respect to the comment content, wherein, prior to the video being displayed, the terminal apparatus plays the video from the corresponding video playback progress when the user requests to play the video (for example, clicking a playback key). The terminal apparatus pauses the video first after skipping the video playback progress, and then re-plays the video according to the operation of the user. Alternatively, the terminal apparatus displays the positioned playback progress first, and then positions the video to the video playback progress for playback after detecting a selection operation of the user with respect to the positioned video playback progress.

For example, as illustrated in FIG. 9C, after determining that the video playback progress of the video corresponding to the comment content selected by the user is 45′56″, the terminal apparatus positions the video to 45′56″ for playback, so that the user can browse the video content corresponding to the selected comment content.

The terminal apparatus acquires a video fragment corresponding to the positioned video playback progress according to the video content of the video, and displays video playback progress corresponding to the acquired video fragment.

The terminal apparatus acquires a video fragment corresponding to the positioned video playback progress according to the video content of the video, and positions the video to a starting position of the video fragment for playback after detecting a playback instruction with respect to the acquired video fragment.

The video content includes at least one of object, scene and event content.

With respect to the video playback progress positioned in step S902, the terminal apparatus determines at least one of the object, scene and event content corresponding to the video playback progress, determines a video fragment corresponding to the object, scene and event content, of a video frame to which the determined video playback progress pertains, and plays the video from a starting video playback progress position of the video fragment, so that the user can completely understand the video content and the viewing continuity of the user is ensured.

When the terminal apparatus detects a selection operation of a user to a comment during the video playback process, the video is skipped from the current video playback progress to video playback progress corresponding to the comment content of interest selected by the user or a starting video playback progress of the object, scene and event content corresponding to the video playback progress for playback.

In this embodiment of the present disclosure, the terminal apparatus can determine the reception of a playback instruction with respect to the corresponding video fragment after detecting a selection operation of the user with respect to the comment content. That is, after the user selects the comment content of interest, the terminal apparatus automatically positions the video to a starting position of the corresponding video fragment for playback, or the terminal apparatus positions the video to the starting position of the corresponding video fragment after detecting a selection operation of the user with respect to the comment content, wherein, prior to the video being displayed, the terminal apparatus plays the video from the starting position of the video fragment when the user requests to play the video, such as by clicking of a playback key. For example, the terminal apparatus pauses the video after skipping the video playback progress, and then re-plays the video according to the operation of the user. Alternatively, the terminal apparatus displays a starting position of a video fragment corresponding to the positioned video playback progress first, and then positions the video to the starting position for playback after detecting a selection operation of the user with respect to the starting position of the video fragment.

If the terminal apparatus is not currently playing the video and if a selection operation of the user with respect to the comment content is detected, the terminal apparatus activates the playback of the video first, and uses video playback progress corresponding to the comment content selected by the user, or a starting video playback progress of the object, scene and event content corresponding to the video playback progress for playback.

Based on the method in FIG. 9A, in practical applications, the video playback apparatus and the comment collection apparatus can be the same terminal apparatus or different terminal apparatuses. For example, a user watches a video on a smart phone and issues comments on the video by a virtual keyboard of the smart phone while watching the video. In this case, all the comments on the video can be displayed on the video playback apparatus or the comment collection apparatus, or can be displayed on both the video playback apparatus and the comment collection apparatus.

When the comments on the video are displayed on the video playback apparatus, the user can directly select the comment content of interest on the video playback apparatus. In this case, in the video playback apparatus, the correspondence data between the comments of other users to the video and the video playback progresses is stored. The video playback apparatus searches video playback progress corresponding to the comment selected by the user and then skips to the video playback progress for playback. The user can also select the comment content of interest by other apparatuses.

When the comments on the video are displayed on the comment collection apparatus, the user can directly select the comment content of interest on the comment collection apparatus, where the correspondence data between the comments of other users to the video and the video playback progresses can be stored. After the user selects a comment from the comment collection apparatus, the comment collection apparatus searches video playback progress corresponding to the comment selected by the user and then informs the video playback apparatus of the searched video playback progress, and the video playback apparatus skips to the video playback progress for playback. Alternatively, in the video playback apparatus, the correspondence data between the comments of users to the video and the video playback progresses is stored, and the user selects a comment on the comment collection apparatus, which informs the video playback apparatus of the comment selected by the user, and the video playback apparatus searches video playback progress corresponding to the comment selected by the user and then skips to the video playback progress for playback.

FIG. 9D illustrates an example of positioning a video according to the searched comments according to the ninth embodiment of the present disclosure. As illustrated in FIG. 9D, the comments of users on a video displayed by terminal apparatuses are sequenced according to the number of thumbs-up for each comment. If a user inputs a keyword of the comment content to be searched in a search box, the terminal apparatus displays comment contents searched according to the keyword. After the user selects the comment content of interest from the searched comment contents and performs a click or other selection operations, the terminal apparatus positions the video to video playback progress corresponding to the comment selected by the user for playback.

In addition, since a user may wish to check comments related to a certain plot in a video, this embodiment of the present disclosure provides a method for positioning comments according to videos, including determining a video fragment of interest from video fragments corresponding to the video, and displaying comment content associated with video playback progress corresponding to the video fragment of interest.

Specifically, the cloud server can perform analysis according to the video content, divide the video content into a plurality of video fragments by plots in advance, and feed a list of the plurality of video fragments back to a terminal apparatus, wherein the cloud server can partition the video content into video fragments according to the predefined granularity, or the granularity can be selected by a user. For example, a scene or a sentence can be used as one fragment for partitioning, or a preset duration such as a minute/an hour can be set as the granularity of partition. After detecting that a user triggers an instruction for searching comments according to a plot, the terminal apparatus displays a list of a plurality of video fragments on the interface. The list can contain the ID, content description (for example, each video fragment corresponds to one sentence as content description) and corresponding video playback progress of each video fragment. After the user selects a desired video fragment according to the plot list, the terminal apparatus uses the video fragment selected by the user as a video fragment of interest after detecting the selection of the user to the video fragment, and then sends information such as the ID information, content description or video playback progress, about the video fragment of interest to a cloud server, which searches the comment content corresponding to the video fragment and feeds the searched comment content back to the terminal apparatus, where the received comment content is displayed.

In addition, in the method for positioning comments according to videos, it is also possible to select, by the user, a video fragment of comment content to be watched, the terminal apparatus feeds video playback progress corresponding to the video fragment selected by the user back to a cloud server, which searches a user comment corresponding to the video playback progress and then sends the searched comment content to the terminal apparatus, where the received comment content is displayed.

For example, if a user does not like the plot from 18′10″ to 21′35″ while watching a video and wants to search other users having the same opinion, the user selects the fragment from 18′10″ to 21′35″ as a video fragment whose comments are to be watched, the terminal apparatus feeds video playback progress (from 18′10″ to 21′35″) corresponding to the video fragment back to the cloud server, which searches user comments corresponding to the video playback progress and sends the searched comment content to the terminal apparatus, and the terminal apparatus displays the received comment content.

Based on the ninth embodiment of the present disclosure, a user can watch the video playback progress corresponding to the comment content by selecting the comment content so as to watch the video content at the video playback progress, instead of randomly dragging the video playback progress bar, which simplifies the operation flow of the user in searching the video content, more accurately positions the video content of interest of the user, and improves the user's experience.

### Tenth Embodiment

The present disclosure considers that a user might browse comments of other users to a video while watching the video by a terminal apparatus. If the user is interested in a certain object (for example, a character, an animal, or scenery) mentioned in a comment, the user may wish to acquire the video content corresponding to the object of interest in the comment. In the prior art, a user tries to search the object content of interest from the video by manually dragging video playback progress bar, which makes it difficult for the user to quickly search the object content of interest. The user may search the object content of interest involved in the comment by numerous dragging operations, which are very tedious to perform, and render low efficiency and, likely, a poor user's experience

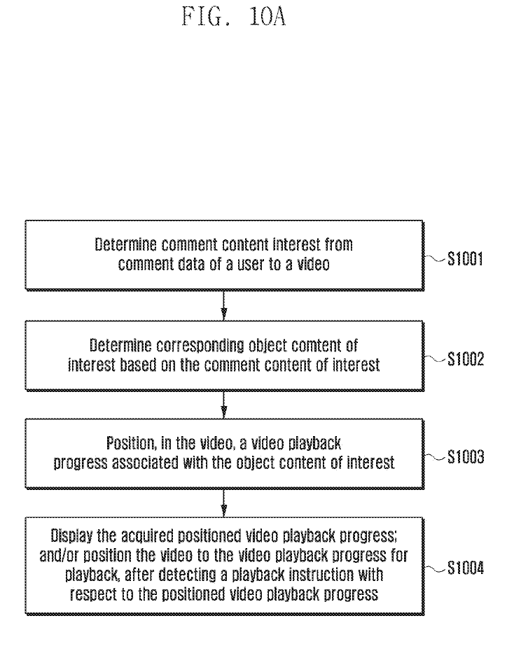

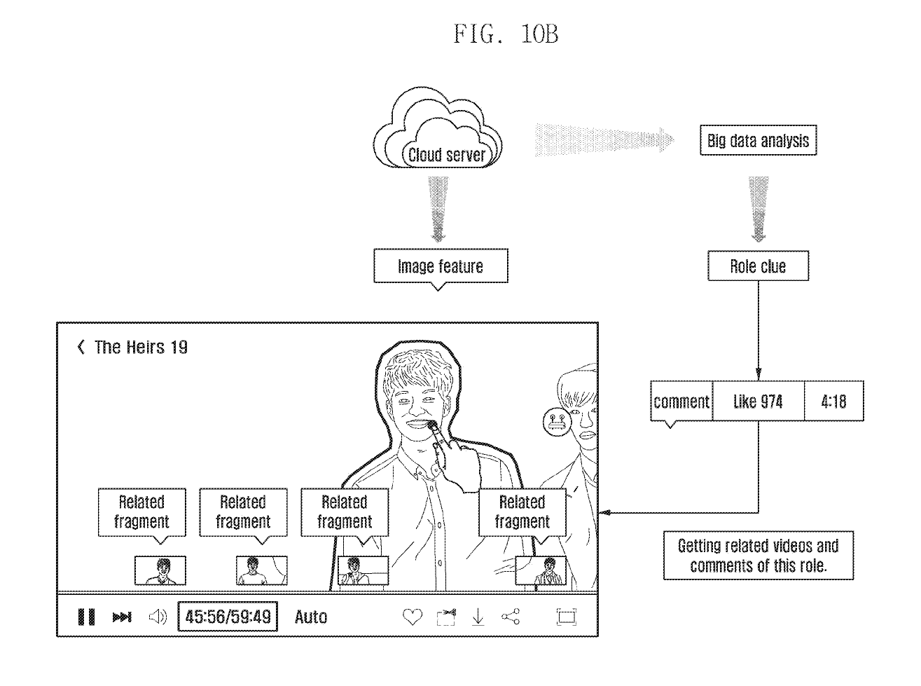

To cure these matters, the tenth embodiment of the present disclosure as described in FIG. 10A provides a method for positioning object content of interest of a video based on comment data.

In step S1001, comment content of interest is determined from comment data of a user on a video.

The specific determination method of comment content of interest in this step is basically identical to the determination method of comment content of interest in step S901 of FIG. 9A, and will not be repeated here.

In step S1002, corresponding object content of interest is determined based on the comment content of interest, by multiple methods as described below.

In this embodiment of the present disclosure, the corresponding video content of interest is determined based on the comment content of interest, and the video content of interest includes object content of interest.

A method for determining object content of interest of a user includes determining a video frame image corresponding to video playback progress associated with the comment content of interest, and determining the corresponding object content of interest based on the video frame image.

Specifically, when a user browses comments with respect to a video and if there is an object content of interest in the comment content, the user can select a certain comment containing the object content of interest and then perform a preset selection operation. After a selection operation of the user with respect to the comment is detected, video playback progress of the video corresponding to the comment content is searched, an object contained in the video frame image is determined from the video frame image corresponding to the searched video playback progress, and the object content of interest of the user is determined according to the object contained in the video frame image. For example, if a user selects a number of objects from the objects contained in a video frame image, it can be understood by a person skilled in the art that the objects selected by the user are usually objects of interest of the user.

The terminal apparatus can highlight object content, such as personal or animal names, contained in the content while displaying the comment content, such as by underlining the object content. After receiving a selection operation of a user with respect to the marked object content in the comment content, the terminal apparatus determines that the user selects the object content, and uses the object content as the object content of interest of the user.

Determining the object content of interest of the user can be performed by the terminal apparatus. Specifically, after detecting a selection operation of the user with respect to a comment, the terminal apparatus searches video playback progress of the video corresponding to the comment from the stored data, determines objects from a video frame image corresponding to the video playback progress of the video by image recognition and analysis or other methods, and uses the object content of the determined objects as the object content of interest of the user.

The selection operation to a comment can be received by the terminal apparatus, and the object content of interest is determined by the cloud server according to the selection operation. Specifically, after detecting a selection operation of the user with respect to a comment, the terminal apparatus sends the comment selected by the user to the cloud server, which searches video playback progress of the video corresponding to the comment, determines objects from a video frame image corresponding to the video playback progress of the video by image recognition and analysis or other methods, and uses the object content of the determined objects as the object content of interest of the user.

In addition, determining the object content of a user can also be performed by cooperation of the terminal apparatus and the cloud server. Specifically, after detecting a selection operation of the user with respect to a comment, the terminal apparatus searches video playback progress of the video corresponding to the comment from the stored data, and sends the searched video playback progress of the video to the cloud server, which determines objects from a video frame image corresponding to the video playback progress of the video by image recognition and analysis, for example, and uses the object content of the determined objects as the object content of interest of the user.

If the terminal apparatus or the cloud server recognizes only one object from the video frame image corresponding to the searched video playback progress of the video, the object content can be directly used as the object content of interest of the user.

For example, if the video frame image only contains character A, the object content of interest of the user is character A.

If the terminal apparatus or the cloud server recognizes a plurality of objects from the video frame image corresponding to the searched video playback progress, the object content of interest of the user can be recognized by the following methods 1) to 4).

1) The object content of all recognized objects is used as the object content of interest of the user.

2) A key object in the video frame image is analyzed, and the object content of the key object is used as the object content of interest. The key object can be determined by the size of a region occupied by each object in the video frame image. For example, if the video frame image contains character A, character B and character C and the region occupied by character A is largest, character A is used as the object content of interest of the user.

3) The object content of interest of the user can also be determined in combination with the comment content selected by the user. For example, if object A, object B and object C are recognized and if the comment content selected by the user contains the name information of object A, then object A can be used as the object content of interest of the user.

4) The object content of interest of the user can also be determined according to the selection of the user. For example, the related information (images, etc.) of a plurality of recognized objects are all shown to the user for enabling the user to select, and the content of an object of interest selected from the plurality of objects by the user is used as the object content of interest of the user.

Another method for determining the object content of interest of a user includes determining the object content of interest from the comment content of interest.

Specifically, when a user browses comments with respect to a video, and if there is object content of interest in the comment content, the user can select a certain comment containing the object content of interest and then perform a preset selection operation. After determining a selection operation of the user with respect to the comment, the terminal apparatus analyzes the comment content selected by the user and determines the object content of interest of the user.

The terminal apparatus can mark (e.g., underline) object content contained in the content while displaying the comment content, and the user can perform a selection operation with respect to the marked object content in the comment content.

Determining the object content of interest of the user can be performed by the terminal apparatus. After detecting a selection operation of the user, the terminal apparatus analyzes the comment content selected by the user and determines the object content of interest of the user.

Determining the object content of interest of the user can be performed by the cloud server. For example, the terminal apparatus sends the comment selected by the user to the cloud server after detecting a selection operation of the user, and the cloud server analyzes the comment content selected by the user and then determines the object content of interest of the user.

The comment content of interest includes at least one of text, speech, picture and video comment content. If the comment content of interest includes the picture, video or speech comment content, the text content corresponding to the picture, video or speech comment content is acquired, and the corresponding object content of interest is determined from the acquired text content.

Specifically, when the comment selected by the user is a text comment and the user performs a selection operation with respect to the marked object content in the comment content, the object selected by the user can be directly used as the object content of interest of the user. For example, if character A and character B are marked in the comment content and the user performs a selection operation to character A, then character A is used as the object content of interest of the user.

When the comment selected by the user is a text comment and the user performs a selection operation with respect to the entire comment, objects contained in the comment selected by the user are analyzed based on a semantic analysis technology. If only one object is obtained by analysis, the object content can be directly used as the object content of interest of the user.

When the comment selected by the user is a text comment and the user performs a selection operation with respect to the entire comment, the object content of interest of the user can be recognized by the following methods 1) to 3) if a plurality of objects are obtained by analysis.

1) The object content of all objects obtained by analysis is used as the object content of interest of the user.

2) The object content of interest of the user can also be determined in combination with the comment content selected by the user. For example, if object A, object B and object C are obtained by analysis and the comment content selected by the user contains the name information of object A, then object A can be used as the object content of interest of the user.

3) The object content of interest can also be selected by the user. For example, the related information of the objects obtained by analysis are provided to the user for enabling the user to select, and the object content of an object selected by the user is used as the object content of interest of the user.

When the comment selected by the user is a speech comment, the terminal apparatus can convert the speech comment into a text comment and then determine the object content of interest of the user in the above-described manner.

When the comment selected by the user is a picture or video comment, the object content of interest of the user can be recognized by the following methods 1) to 2).

1) The picture or video is converted into text by an image analysis technology, and the object content of interest of the user is then determined in the above-described manner.

2) The object content of interest of the user is determined according to an image selected by the user or an image frame selected by the user in the video. Specifically, objects contained in the image can be analyzed by image recognition and analysis. If only one object is obtained by analysis, the object is directly used as the object content of interest of the user. If a plurality of objects are obtained by analysis, (1) all the object contents obtained by analysis are used as the object content of interest of the user, (2) a key object in the image is analyzed, and the key object content is used as the object content of interest, where the key object can be determined by the size of a region occupied by each object in the image, and (3) the object content of interest can also be selected by the user. For example, the related information of the objects obtained by analysis are provided to the user for enabling the user to select, and the object content selected by the user is used as the object content of interest of the user.

Another method for determining the object content of interest of a user includes, when the user watches a video on a terminal apparatus and a played video frame image contains the object content of interest of the user, a preset selection operation can be performed with respect to the video frame image or to a region corresponding to the object content of interest of the user in the video frame image. The terminal apparatus determines the object content of interest of the user after detecting the selection operation of the user.

Determining the object content of interest of the user can be performed by the terminal apparatus, such as after detecting a selection operation of the user.

Determining the object content of interest of the user can be performed by the cloud server. For example, the terminal apparatus sends information about a video frame image or object content of interest selected by the user to the cloud server after detecting a selection operation of the user, and the cloud server then determines the object content of interest of the user.

When the user performs a preset selection operation with respect to a region corresponding to the object content of interest of the user in a video frame image, the terminal apparatus or the cloud server can perform image recognition and analysis on the video frame image to obtain the object content corresponding to the region in which the selection operation is performed by the user, and then use the object as the object content of interest of the user.

When the user performs a preset selection operation with respect to the video frame image, the object content of interest of the user can be determined according to the video frame image. Specifically, objects contained in the image can be analyzed by image recognition and analysis. If only one object is obtained by analysis, the object is directly used as the object content of interest of the user. If a plurality of objects are obtained by analysis, (1) all the objects obtained by analysis are used as the object content of interest of the user, (2) a key content in the image is analyzed, and the key object is used as the object content of interest, where the key object can be determined by the size of a region occupied by each object in the image, and (3) the object content of interest can also be selected by the user. For example, the related information of the objects obtained by analysis are provided to the user for enabling the user to select, and the object selected by the user is used as the object content of interest of the user.

When it is detected that the user performs a preset selection operation with respect to the video frame image or to a region corresponding to the object content of interest of the user in the video frame image, the terminal apparatus can pause the playback of the video, and then resume playing the video after detecting a user's instruction of resuming playing the video.

In step S1003, video playback progress associated with the object content of interest is positioned in the video.

Video playback progress associated with the object content of interest is acquired according to the object content of the video.

Specifically, according to the object content of interest selected by the user obtained in step S1002, a video fragment containing the object content of interest can be searched from the entire video by image recognition, analysis or other technologies.

The terminal apparatus can search, according to the object content of interest selected by the user obtained in step S1002, a video fragment containing the object content of interest from the entire video by image recognition, analysis or other technologies.

The cloud server can search, according to the object content of interest selected by the user obtained in step S1002, a video fragment containing the object content of interest from the entire video by image recognition, analysis or other technologies, and the cloud server returns the information about the searched video fragment to the terminal apparatus.

Video playback progress corresponding to the acquired video fragment is positioned. A starting video playback progress of the acquired video fragment is positioned.

In step S1004, the acquired positioned video playback progress is displayed, and/or the video is positioned to the video playback progress for playback after detecting a playback instruction with respect to the positioned video playback progress.

The terminal apparatus can display the video playback progress corresponding to the video fragment acquired in step S1003, and can also position the video to the starting video playback progress of the video fragment for playback after detecting a playback instruction with respect to the acquired video fragment.

After detecting a selection operation of the user with respect to the entire comment content containing the object information or to the object information in the comment content, the terminal apparatus determines the reception of a playback instruction with respect to a video fragment corresponding to the object content of interest. That is, after the user selects the object content of interest, the terminal apparatus automatically positions the video to a starting position of the corresponding video frame for playback.

Alternatively, the terminal apparatus can position the video to the starting position of the corresponding video fragment after detecting a selection operation of the user with respect to the entire comment content containing the object information or to the object information in the comment content, wherein prior to displaying the video, the terminal apparatus plays the video from the starting position of the video fragment when the user requests to play the video. For example, the terminal apparatus pauses the video after skipping the video playback progress, and then re-plays the video according to the operation of the user.

Alternatively, the terminal apparatus displays a starting position of a video fragment corresponding to the positioned video playback progress first, and then positions the video to the starting position for playback after detecting a selection operation of the user with respect to the starting position of the video fragment.

Specifically, the terminal apparatus can display information about the video playback progress of the determined video fragment, which is marked (e.g., highlighted) on the video playback progress bar, for enabling a user to freely select for skipped playback.

After receiving a user's operation of clicking a certain video playback progress in a certain marked video fragment, the terminal apparatus can perform video skipping by either skipping to the clicked video playback progress for playback, or skipping to a starting video playback progress of the video fragment for playback, so that the user can completely understand the video content and the viewing continuity of the user is ensured.

The video playback apparatus and the comment collection apparatus can be the same apparatus or different apparatuses. For example, a user watches a video on a smart phone and issues comments on the video by a virtual keyboard of the smart phone while watching the video. In this case, all the comments on the video can be displayed on one or both of the video playback apparatus and the comment collection apparatus.

When the comments on the video are displayed on the video playback apparatus, the user can directly select a comment containing the object content of interest on the video playback apparatus. In this case, the video playback apparatus determines the object content of interest of the user and displays video playback progress and/or a video fragment containing the object content of interest of the user in the video to the user.

When the comments on the video are displayed on the comment collection apparatus, the user can directly select a comment containing the object content of interest on the comment collection apparatus, which determines the object content of interest of the user according to the comment selected by the user and then feeds a video fragment containing the object content of interest of the user in the video back to the video playback apparatus. In turn, the video playback apparatus feeds the video fragment containing the object content of interest of the user in the video back to the user. Alternatively, the comment collection apparatus sends the comment selected by the user to the video playback apparatus, which determines the object content of interest of the user according to the received comment and then feeds a video fragment containing the object content of interest of the user in the video back to the user.

FIG. 10B illustrates an example of positioning object content of a video according to comments, according to the tenth embodiment of the present disclosure. As illustrated in FIG. 10B, when a user watches a video in a video playback interface of a terminal apparatus, the comment content issued by each user to the video can be simultaneously displayed in the playback interface. Assuming that the current video playback progress is 30′40″ and the user selects a certain comment by clicking, the terminal apparatus determines that the video playback progress corresponding to the comment is 40′02″ after detecting the selection operation of the user, obtains a character of interest or other object contents of interest of the user from the video frame image corresponding to the video playback progress by analysis, and searches that video fragments, in which the character appears. For, example, video fragments from 25′20″ to 27′22″, from 29′30″ to 32′51″ and from 40′00″ to 48′15″ are included. Therefore, the terminal apparatus highlights video playback progress of the three video fragments on the video playback progress bar, so that the user can browse video contents in which the selected character of interest appears.

In the method for positioning the object content of a video based on the comment data according to the tenth embodiment of the present disclosure, according to a selection operation of a user with respect to the comment containing the object content of interest, the video is automatically positioned to video playback progress where a video fragment containing the object content of interest of the user is located, and the positioned video playback progress is displayed for enabling the user to select and/or the video fragment containing the object content of interest of the user is played according to a playback instruction. Moreover, in comparison with the conventional method of manually searching a video fragment containing the object content of interest by a user, the method provided by the tenth embodiment of the present disclosure negates the steps of searching manually by the user, greatly enhancing the accuracy and efficiency of video positioning, and improving the user's experience.

### Eleventh Embodiment

The present disclosure considers that a user might browse comments of other users to a video while watching the video by a terminal apparatus. If the user is interested in a certain scene mentioned in a comment, the user may wish to acquire the video content in which the scene of interest in the comment appears. In an existing video positioning method, a user conventionally tries to search the scene content of interest from the video by manually dragging video playback progress bar, rendering it difficult to quickly search the scene content of interest. The user may search, from the video, the scene content of interest involved in the comment by multiple dragging operations, which are very tedious and low in efficiency.

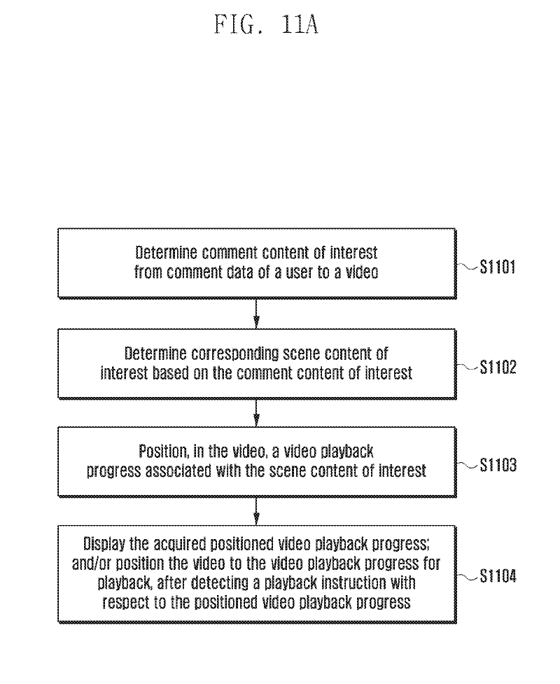

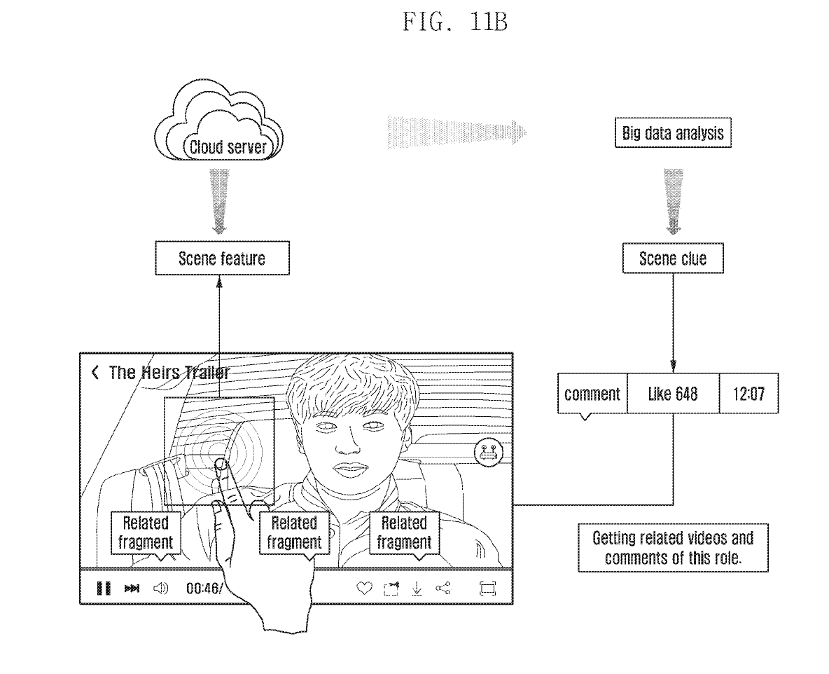

To cure these matters, the eleventh embodiment of the present disclosure as taught in FIG. 11, provides a method for positioning scene content of interest of a video based on comment data.

In step S1101, comment content of interest is determined from comment data of a user on a video.

The specific determination method of comment content of interest in this step is basically identical to the determination method of comment content of interest in S901 of FIG. 9A, and will not be repeated here.

In step S1102, corresponding scene content of interest is determined based on the comment content of interest.

In this embodiment of the present disclosure, the corresponding video content of interest is determined based on the comment content of interest, and the video content of interest includes scene content of interest.

In step S1101, the scene content of interest of a corresponding user can be determined based on the comment content of interest by multiple methods, such as determining a video frame image corresponding to video playback progress associated with the comment content of interest, and determining the corresponding scene content of interest based on the video frame image.

Specifically, when a user browses comments with respect to a video and there is scene content of interest in the comment content, the user can select this comment and then perform a preset selection operation. After detecting the selection operation of the user, the terminal apparatus searches video playback progress corresponding to the comment content, then determines, from a video frame image corresponding to the searched video playback progress, scenes contained in the video frame image, and determines the scene content of interest of the user according to the scenes contained in the video frame image. For example, if the user selects a certain scene from the scenes contained in the video frame image, the scene selected by the user is usually a scene of interest of the user.

The terminal apparatus can mark scene information contained in the content while displaying the comment content, receives a selection operation performed by the user with respect to the marked scene information in the comment content, determines that user selects the scene, and uses the scene as the scene content of interest of the user.

Determining the scene content of interest of the user can be performed by the terminal apparatus. For example, the terminal searches video playback progress corresponding to the comment from the stored data after detecting a selection operation of the user, and then determines the scene content of interest of the user from a video frame image corresponding to the video playback progress by image recognition or analysis, for example.

Determining the scene content of interest of the user can be performed by the cloud server. For example, the terminal apparatus sends the comment selected by the user to the cloud server after detecting a selection operation of the user, and the cloud server searches video playback progress corresponding to the comment, and determines the scene content of interest of the user from a video frame image corresponding to the video playback progress by image recognition or analysis.

In addition, determining the scene content of a user can also be performed by the terminal apparatus and the cloud server cooperatively. For example, the terminal apparatus searches video playback progress corresponding to the comment from the stored data after detecting a selection operation of the user and then sends the searched video playback progress to the cloud server, which determines the scene content of interest of the user from a video frame image corresponding to the video playback progress by image recognition or analysis.

The scene content of interest can also be determined from the comment content of interest.

Specifically, when a user browses comments with respect to a video and there is scene content of interest in the comment content, the user can select this comment and then perform a preset selection operation. After detecting the selection operation of the user, the terminal apparatus analyzes the comment content selected by the user, and then determines the scene content of interest of the user.

The terminal apparatus can mark scene information contained in the content while displaying the comment content, and the user can perform a selection operation with respect to the marked scene information in the comment content.

Determining the scene content of interest of a user can be performed by the terminal apparatus. For example, after detecting a selection operation of the user, the terminal apparatus analyzes the comment content selected by the user and determines the scene content of interest of the user.

Determining the scene content of interest of the user can be performed by the cloud server. For example, the terminal apparatus sends the comment selected by the user to the cloud server after detecting a selection operation of the user, and the cloud server analyzes the comment content selected by the user and then determines the scene content of interest of the user.

The comment content of interest includes at least one of text, speech, picture and video comment content. If the comment content of interest includes the picture, video or the speech comment content, the text content corresponding to the picture, video or the speech comment content is acquired, and the corresponding scene content of interest is determined from the acquired text content.

Specifically, when the comment selected by the user is a text comment and the user performs a selection operation with respect to the marked scene information in the comment content, the scene selected by the user can be directly used as the scene content of interest of the user.

When the comment selected by the user is a text comment and the user performs a selection operation with respect to the entire comment, scenes contained in the comment selected by the user are analyzed based on a semantic analysis technology, and the analyzed scenes are used as the object content of interest of the user.

When the comment selected by the user is a speech comment, the terminal apparatus can convert the speech comment into a text comment and then determine the scene content of interest of the user in the above-described manner.

When the comment selected by the user is a picture or video comment, the scene content of interest of the user can be recognized by the following methods 1) to 3).

1) The picture or video is converted into text by an image analysis technology, and the scene content of interest of the user is then determined in the above-described manner.

2) The scene content of interest of the user is determined according to an image selected by the user or an image frame selected by the user in the video. Specifically, scenes contained in the image can be obtained by analysis by image recognition and analysis, as the scene content of interest of the user.

3) When the user watches a video on a terminal apparatus and a played video frame image contains the scene content of interest of the user, a preset selection operation can be performed with respect to the video frame image or to a region corresponding to the scene content of interest of the user in the video frame image, and the terminal apparatus determines the scene content of interest of the user after detecting the selection operation of the user.

Determining the scene content of interest of a user can be performed by the terminal apparatus. For example, the terminal apparatus determines the scene content of interest of the user after detecting a selection operation of the user.

Determining the scene content of interest of a user can be performed by the cloud server. For example, the terminal apparatus sends information about a video frame image or scene content of interest selected by the user to the cloud server after detecting a selection operation of the user, and the cloud server then determines the scene content of interest of the user.

When the user performs a preset selection operation with respect to a region corresponding to the scene content of interest of the user in a video frame image, the terminal apparatus or the cloud server can perform image recognition and analysis on the video frame image to obtain the scene information corresponding to the region in which the selection operation is performed by the user, and then use the scene as the scene content of interest of the user.

When the user performs a preset selection operation on the video frame image, the scene content of interest of the user can be determined according to the video frame image. Specifically, scenes contained in the image can be analyzed by image recognition and analysis.

When it is detected that the user performs a preset selection operation with respect to the video frame image or to a region corresponding to the scene content of interest of the user in the video frame image, the terminal apparatus can pause the playback of the video, and then resume playing the video after detecting a user's instruction of resuming playing the video.

In step S1103, video playback progress associated with the scene content of interest and acquired according to the scene content of the video, is positioned in the video.

Specifically, the terminal apparatus can search, according to the scene content of interest selected by the user obtained in step S1102, a video fragment containing the scene content of interest from the entire video by image recognition, analysis or other technologies.

The cloud server can search, according to the scene content of interest selected by the user obtained in step S1102, a video fragment containing the scene content of interest from the entire video by image recognition, analysis or other technologies, and the cloud server returns the information about the searched video fragment to the terminal apparatus.

Video playback progress corresponding to the acquired video fragment, such as a starting video playback progress position of the acquired video fragment, is positioned.

In step S1104, the acquired positioned video playback progress is displayed, and/or, the video is positioned to the video playback progress for playback after detecting a playback instruction with respect to the positioned video playback progress.

The terminal apparatus can display the video playback progress corresponding to the video fragment acquired in step S1103, and can also position the video to the starting video playback progress position of the video fragment for playback after detecting a playback instruction with respect to the acquired video fragment.

After detecting a selection operation of the user with respect to the entire comment content containing the scene information or to the scene information in the comment content, the terminal apparatus determines the reception of a playback instruction with respect to a video fragment corresponding to the scene content of interest. That is, after the user selects the scene content of interest, the terminal apparatus automatically positions the video to a starting position of the corresponding video frame for playback.

Alternatively, the terminal apparatus can also position the video to the starting position of the corresponding video fragment after detecting a selection operation of the user with respect to the entire comment content containing the scene information or with respect to the scene information in the comment content, where the video can be not displayed first, and the terminal apparatus plays the video from the starting position of the video fragment when the user requests to play the video. For example, the terminal apparatus pauses the video after skipping the video playback progress, and then re-plays the video according to the operation of the user.

Alternatively, the terminal apparatus displays a starting position of a video fragment corresponding to the positioned video playback progress first, and then positions the video to the starting position for playback after detecting a selection operation of the user with respect to the starting position of the video fragment.

Specifically, the terminal apparatus can display information about the video playback progress of the determined video fragment. For example, the video playback progress corresponding to the determined video fragment is marked on the video playback progress bar, for enabling a user to freely select for skipped playback.

After receiving a user's operation of clicking a certain video playback progress in a certain marked video fragment, the terminal apparatus can perform video skipping by skipping to the clicked video playback progress for playback, or skipping to a starting video playback progress of the video fragment for playback, so that the user can completely understand the video content and the viewing continuity of the user is ensured.

The video playback apparatus and the comment collection apparatus can be the same apparatus or different apparatuses. For example, a user watches a video on a smart phone and issues comments on the video by a virtual keyboard of the smart phone while watching the video. In this case, all the comments on the video can be displayed on one or both of the video playback apparatus and the comment collection apparatus.

When the comments on the video are displayed on the video playback apparatus, the user can directly select a comment containing the scene content of interest on the video playback apparatus. In this case, the video playback apparatus determines the scene content of interest of the user and displays video playback progress and/or a video fragment containing the scene content of interest of the user in the video to the user.

When the comments on the video are displayed on the comment collection apparatus, the user can directly select a comment containing the scene content of interest on the comment collection apparatus, which determines the scene content of interest of the user according to the comment selected by the user and then feeds a video fragment containing the scene content of interest of the user in the video back to the video playback apparatus. In turn, the video playback apparatus feeds the video fragment containing the scene content of interest of the user in the video back to the user. Alternatively, the comment collection apparatus sends the comment selected by the user to the video playback apparatus, and the video playback apparatus determines the scene content of interest of the user according to the received comment and then feeds a video fragment containing the scene content of interest of the user in the video back to the user.

FIG. 11B illustrates an example of positioning the scene content of a video according to comments, according to the eleventh embodiment of the present disclosure. As illustrated in FIG. 11B, when a user watches a video on a video playback interface of a terminal apparatus, the comment content issued by each user to the video can be simultaneously displayed in the playback interface. Assuming that the current video playback progress is 30′40″ and the user selects a certain comment by clicking, the terminal apparatus determines the video playback progress corresponding to the comment to be 40′02″ after detecting the selection operation of the user, obtains by analysis the scene object content of interest of the user from the video frame image corresponding to the video playback progress, and searches that video fragments, in which the scene appears. For example, video fragment from 25′20″ to 27′22″, from 29′30″ to 32′51″ and from 40′00″ to 48′15″ are included. Therefore, the terminal apparatus highlights video playback progress of the three video fragments on the video playback progress bar, so that the user can browse video contents in which the selected scene content of interest appears.

In the method for positioning the scene content of a video based on the comment data according to the eleventh embodiment of the present disclosure, according to a selection operation of a user with respect to the comment including the scene content of interest, the video is automatically positioned to video playback progress where a video fragment containing the scene content of interest of the user is located, and the positioned video playback progress is displayed for enabling the user to select and/or the video fragment containing the scene content of interest of the user is played according to a playback instruction. Moreover, in comparison with the conventional method of manually searching a video fragment containing the scene content of interest by a user, the method provided by the eleventh embodiment of the present disclosure negates the steps of searching manually by the user, greatly enhancing the accuracy and efficiency of video positioning, and improving the user's experience.

### Twelfth Embodiment

The present disclosure considers that, a user may wish to watch the related description of the current video plot in a corresponding novel while watching the video by a terminal apparatus, or the user might wish to watch the related description of a plot mentioned in a certain comment content in a corresponding novel while browsing the comments on the video. However, in the prior art, the user needs to manually search the novel corresponding to the video or the comment, and the user needs to manually find the related description content of the current video plot or the certain comment content from the novel, so that the operation is very tedious, the efficiency is low and it is likely to result in poor user's experience.

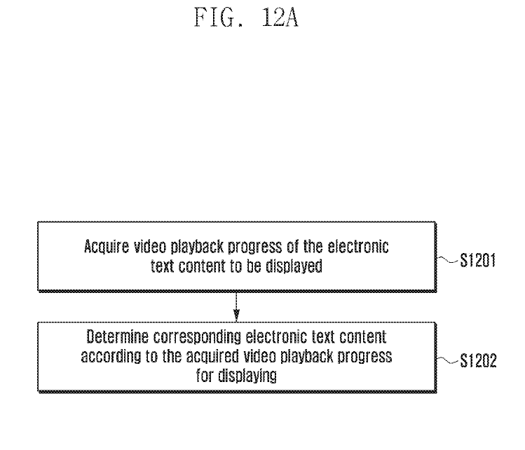

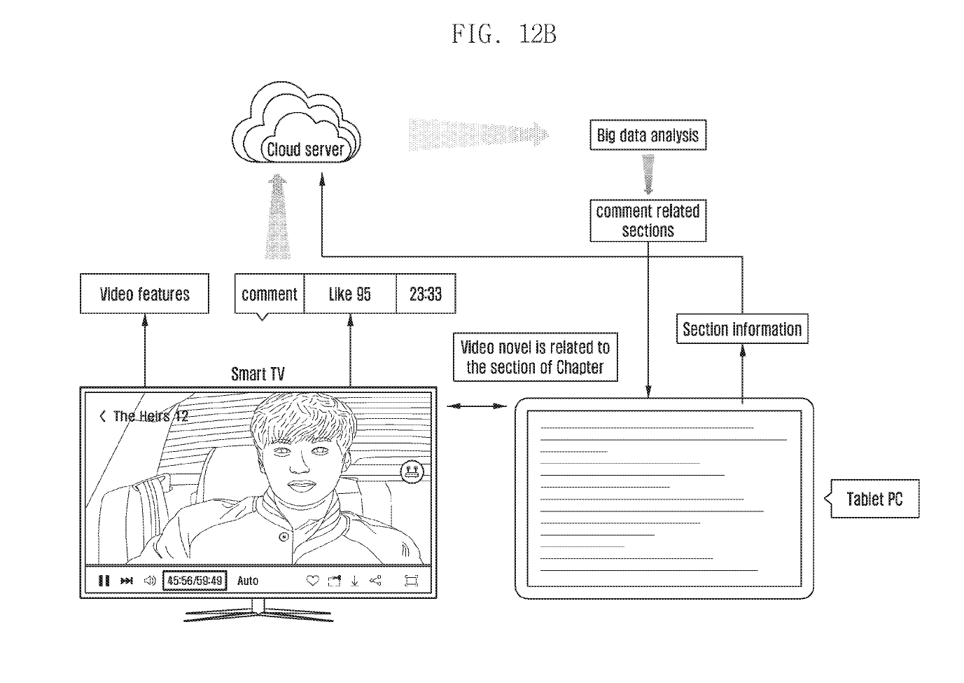

To cure these matters, the twelfth embodiment of the present disclosure as illustrated in FIG. 12A provides a method for positioning and displaying electronic text content associated with a video based on comment data. In step S1201, video playback progress of electronic text content to be displayed is acquired.

The terminal apparatus can acquire the video playback progress of the electronic text content to be displayed by at least one of determining a positioned video playback progress as the video playback progress of the electronic text content to be displayed, determining video playback progress selected by a user as the video playback progress of the electronic text content to be displayed, determining video playback progress corresponding to the video content selected by the user as the video playback progress of the electronic text content to be displayed, and during the video playback process, determining a current video playback progress as the video playback progress of the electronic text content to be displayed.

The electronic text content can be a novel, prose, an essay, a poem, literature, a news report, or a thesis, for example.

Specifically, the terminal apparatus determines the video playback progress positioned in steps S902 of FIG. 9A, S1003 of FIG. 10A, and S1103 of FIG. 11A as the video playback progress of the electronic text content to be displayed.

The terminal apparatus determines video playback progress selected by the user as the video playback progress of the electronic text content to be displayed, by pre-storing, in the terminal apparatus, the correspondence data between the video fragments of a plurality of videos and the electronic text content and the correspondence data between the video playback progresses and the electronic text content, which are acquired from a cloud server.

With respect to a video, the comment content associated with the video playback progress of the video is displayed. The specific method is basically identical to the display method in the step S901 of FIG. 9A, and will not be repeated here.

In response to a selection operation with respect to a comment, the video playback progress associated with the selected comment is determined. Specifically, when a user browses comments with respect to a video and there is a plot of interest contained in the comment content, the user can select this comment and perform a preset selection operation. The terminal apparatus searches video playback progress of the video corresponding to the comment content of the comment after detecting the selection operation of the user with respect to the comment.

The terminal apparatus determines video playback progress corresponding to the video content selected by the user as the video playback progress of the electronic text content to be displayed, by determining, in response to a selection operation with respect to a video frame image, a video fragment associated with the video frame image. Specifically, when a user watches a video on a terminal apparatus and is interested in the current video plot, the user can perform a preset selection operation with respect to the currently played video frame image, and the terminal apparatus determines a video fragment corresponding to the current video content after detecting the selection operation of the user. The video content includes at least one of object, event and scene content.

During the video playback process, the terminal apparatus can also determine the current video playback progress as the video playback progress of the electronic text content to be displayed.

In step S1202, the corresponding electronic text content is determined for displaying according to the acquired video playback progress.

The terminal apparatus is pre-stored with the correspondence data between the video fragments of a plurality of videos and the electronic text content and the correspondence data between the video playback progresses and the electronic text content, which are acquired from a cloud server.

Therefore, according to the video playback progress corresponding to the electronic text content to be displayed, acquired in step S1201 and the pre-stored correspondence data between the comment data, video fragments and electronic text content and the video playback progress, the terminal apparatus determines the electronic text content corresponding to a video fragment where the video playback progress is located.

Specifically, determining the electronic text content can be performed by the terminal apparatus. For example, the terminal apparatus searches video playback progress corresponding to the comment from the stored data after detecting a selection operation of the user, and searches, from the correspondence between video fragments and electronic text content, the electronic text content corresponding to a video fragment where the video playback progress is located.

Determining the electronic text content can be performed by the cloud server. For example, the terminal apparatus sends the comment selected by the user to the cloud server after detecting a selection operation of the user with respect to the comment, and the cloud server searches video playback progress corresponding to the comment and searches, from the correspondence between video fragments and electronic text content, the electronic text content corresponding to a video fragment where the video playback progress is located.

In addition, determining the electronic text content can also be performed by a cooperation of the terminal apparatus and the cloud server. For example, the terminal apparatus searches video playback progress corresponding to the comment from the stored data after detecting a selection operation of the user, and then sends the searched video playback progress to the cloud server, which searches, from the correspondence between video fragments and electronic text content, the electronic text content corresponding to a video fragment where the video playback progress is located.

In this step, the terminal apparatus determines the electronic text content corresponding to the video fragment, according to the video fragment corresponding to the electronic text content to be displayed acquired in step S1201 and the pre-stored correspondence data between video fragments, electronic text content and video playback progresses.

Specifically, determining the electronic text content can be performed by the terminal apparatus. For example, the terminal apparatus searches a video fragment where the video frame image is located after detecting a selection operation of the user, and searches, from the correspondence between video fragments and electronic text content, the electronic text content corresponding to the video fragment.

Determining the electronic text content can be performed by the cloud server. For example, the terminal apparatus sends the video frame image selected by the user to the cloud server after detecting a selection operation of the user, and the cloud server searches a video fragment where the video frame image is located and then searches, from the correspondence between video fragments and electronic text content, the electronic text content corresponding to the video fragment.

Determining the electronic text content can also be performed by a cooperation of the terminal apparatus and the cloud server. For example, the terminal apparatus searches a video fragment where the video frame image is located after detecting a selection operation of the user and then sends the searched video fragment to the cloud server, which searches, from the correspondence between video fragments and electronic text content, the electronic text content corresponding to the video fragment.

The terminal apparatus displays the determined electronic text content corresponding to the acquired video playback progress.

While displaying the electronic text content, the electronic text content corresponding to the video can be displayed in the display interface of the terminal apparatus. For example, the determined electronic text content is highlighted.

The video playback apparatus and the electronic text display apparatus can be the same terminal apparatus or different terminal apparatuses. For example, a smart TV is used to watch a video, while a tablet computer is used to display the corresponding electronic text content.

If the terminal apparatus detects the selection operation of the user in step S1201, the terminal apparatus can pause the playback of the video, and then resume playing the video after subsequently receiving a resume playback instruction from the user. In this case, the user can simultaneously browse the video and the electronic text in this step, and with the playback of the video content, the electronic text content corresponding to the currently played video plot is highlighted in the displayed electronic text.

FIG. 12B illustrates an example of displaying the electronic text content associated with a video, according to the twelfth embodiment of the present disclosure. As illustrated in FIG. 12B,when a user watches a video in a video playback interface of a terminal apparatus, the comment content issued by each user to the video can be simultaneously displayed in the playback interface. Assuming that the current video playback progress is 30′40″ and the user selects a certain comment by clicking, the terminal apparatus determines that the video playback progress corresponding to the comment is 11′23″ after detecting the selection operation of the user, searches that a video fragment where the video playback progress is located is from 10′20″ to 12′15″, and searches the electronic text content corresponding to the video fragment. Subsequently, the terminal apparatus displays the electronic text corresponding to the video in the interface, and highlights the electronic text content corresponding to the video fragment from 10′20″ to 12′15″, for example.

The twelfth embodiment of the present disclosure discloses that the electronic text content can be positioned by videos and comments, which can also be positioned by the electronic text content. That is, when a user browses the electronic text content on a terminal apparatus, the user can select the electronic text content of the video/comment to be positioned by speech, a gesture, a key or an external apparatus, for example, and the terminal apparatus searches a video fragment corresponding to the electronic text content after detecting the selection operation of the user and then positions the video to the searched video fragment for playback. For example, the video can be positioned to a starting video playback progress of the searched video fragment for playback.

In the method for positioning and displaying the electronic text content associated with a video based on the comment data according to the twelfth embodiment of the present disclosure, according to a selection operation of a user with respect to the comment content containing a plot of interest or a click operation with respect to the currently played video frame, the electronic text content corresponding to a video fragment containing the plot of interest of the user is determined automatically and displayed. In contrast to the conventional method of manually searching the electronic text content by a user, the method provided by the twelfth embodiment of the present disclosure negates the steps of searching manually by the user, thereby greatly enhancing the accuracy and efficiency of determining the electronic text content associated with the video plot, and improving the user's experience.

### Thirteenth Embodiment

The present disclosure considers that when a user watches a video on a terminal apparatus, the user may wish to ascertain the impression of other users to the video, and then select whether to watch this video or select which fragment of the video to watch, according to the impression of other users to the video. In the prior art, the user usually acquires the impression of other users to the video by viewing comments, so the manner of acquiring impression is relatively simple, and as a result, the impression of other users to the video cannot be accurately obtained and known. Moreover, the existing comments are usually overall evaluation of other users to the entire video, so the user is unable to know, according to the comments, the change in impression of other users while watching the video. This results in difficult selection or selection deviation when the user selects whether to watch the video or selects which fragment of the video to watch, which is inconvenient to the user.

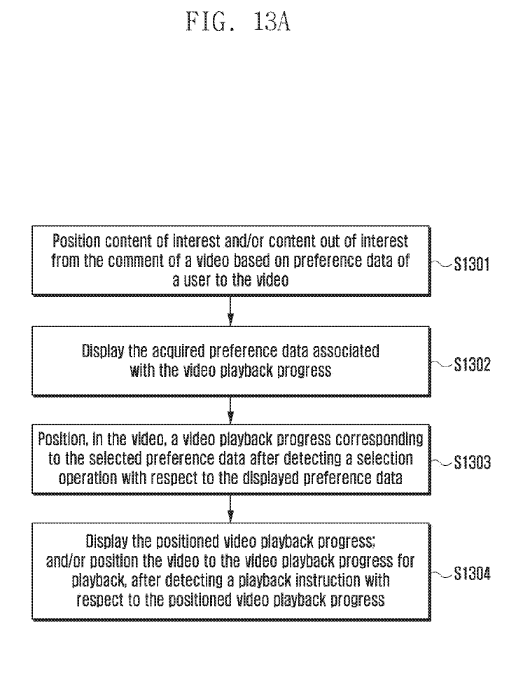

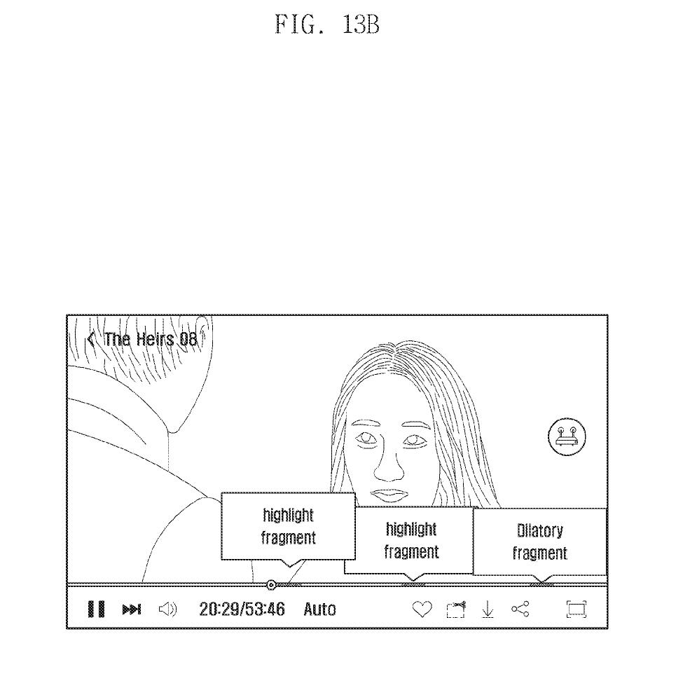

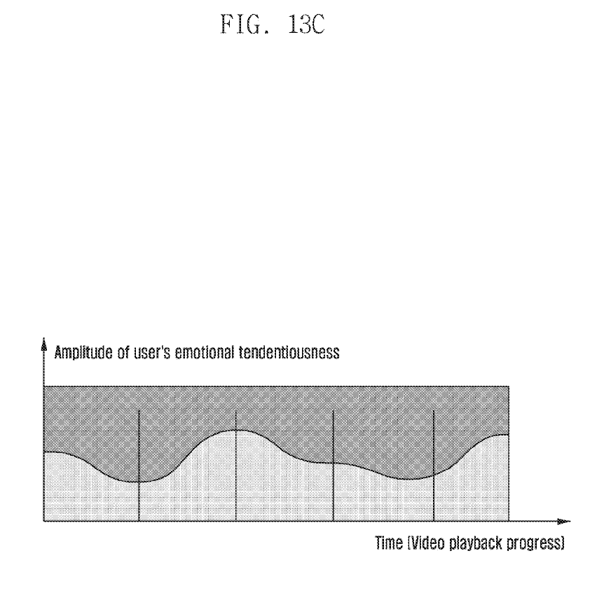

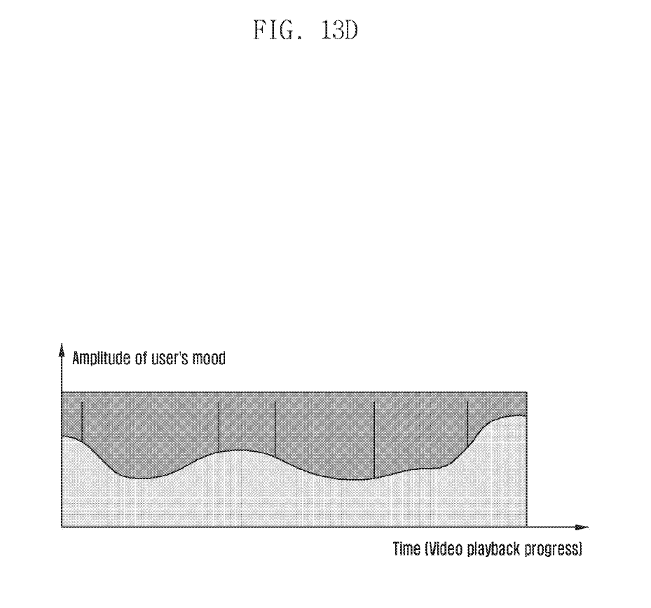

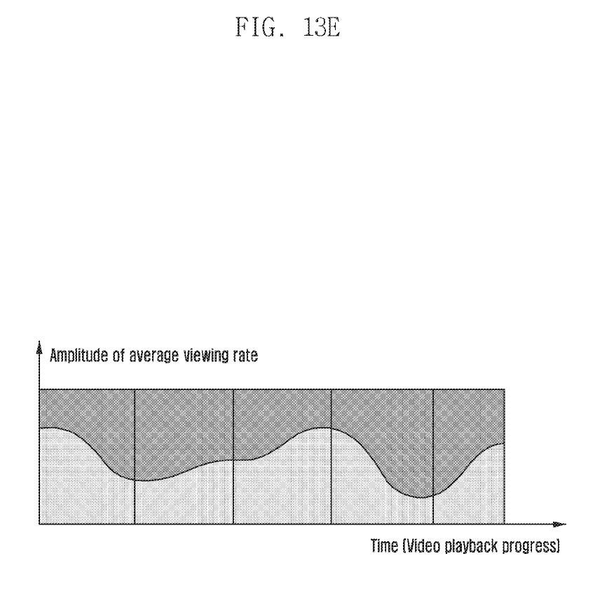

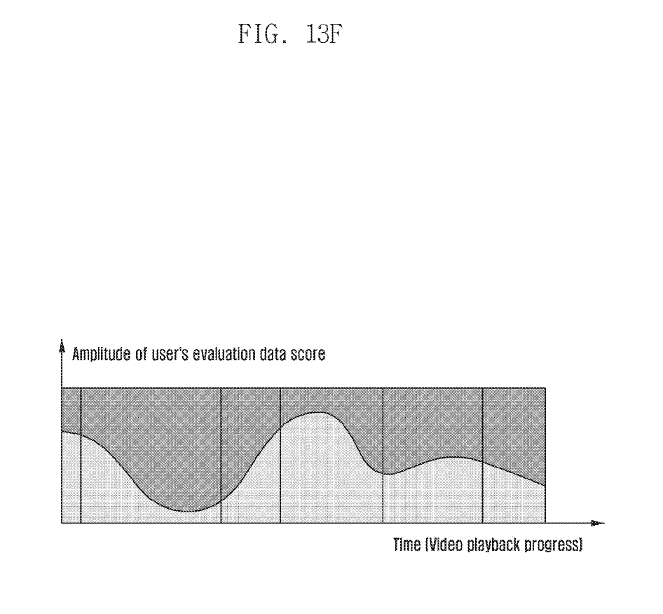

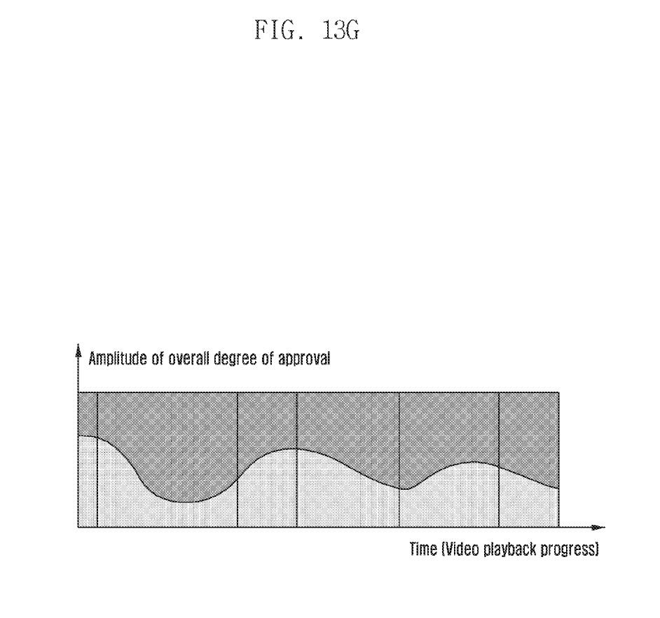

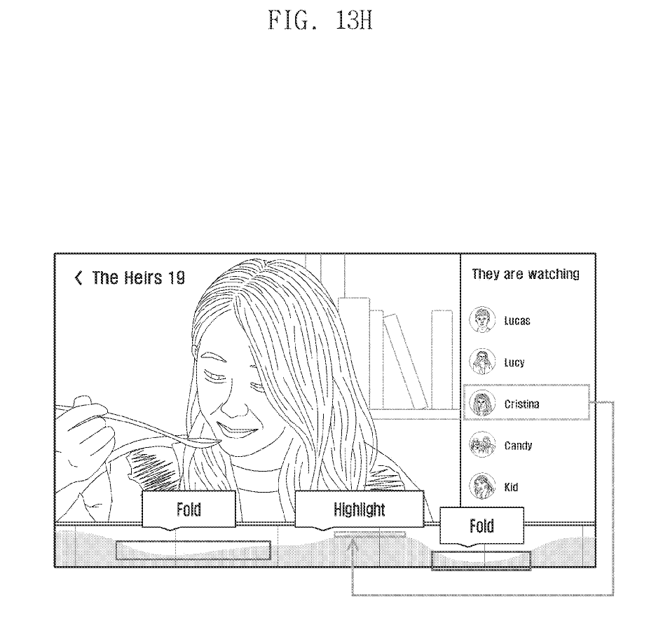

To cure these matters, the thirteenth embodiment of the present disclosure as illustrated in FIG. 13A provides a method for positioning the content of a video based on preference data. In step S1301, content of interest and/or content not of interest is positioned from the content of a video based on preference data of a user to the video, including at least one of emotional tendentiousness data of the user, mood data of the user, viewing rate data, evaluation data and overall data of degree of approval.

A terminal apparatus displays video playback progress corresponding to the content of interest and/or content not of interest.

Specifically, for the preference data of the user to the video, the video content having the preference data greater than a preset highlight threshold is marked as the content of interest, and/or, the video content having the preference data less than a preset non-highlight threshold is marked as the content not of interest (e.g., dilatory content). The highlight threshold is greater than the non-highlight threshold, and the user can set the two thresholds as required.

A video fragment of the content of interest can be a highlight fragment, and a video fragment of the content not of interest can be a non-highlight fragment (e.g., a dilatory fragment).

The marks for the highlight fragments and/or non-highlight fragments are displayed in correspondence to the video playback progress bar of the video.

If the preference data of the user to the video corresponding to a video fragment or video frame is greater than or equal to the highlight threshold, a corresponding segment-shaped or dot-shaped green mark is set above the video progress bar. If a video fragment or video frame is less than the non-highlight threshold, a corresponding segment-shaped or dot-shaped pink mark is set above the video progress bar.

FIG. 3B 13B illustrates an example of marking video playback progress according to user's impression data. As illustrated in FIG. 13B, the starting time and ending time of each highlight and non-highlight fragment are calculated according to a highlight threshold and a non-highlight threshold preset by the user. Highlight fragments are displayed above the video progress bar and marked with green, and non-highlight fragments (non-highlight fragments) are also displayed and marked with pink, for example.

The preference data of the user to the video can be displayed in correspondence to the video playback progress of the video.

Specifically, for each video playback progress of the video, a numerical value (i.e., the preference data of the user to the video) of a vertical coordinate of the video playback progress in an impression curve is correspondingly displayed at the video playback progress of the video playback progress bar of the video, for visual convenience to the user.

For example, for each dot or segment in the video playback progress bar, if the preference data of the user to the video corresponding to the video playback progress represented by the dot or segment is relatively large, the dot or segment is displayed in a relatively dark color, and if the preference data of the user to the video corresponding to the video playback progress represented by the dot or segment is relatively small, the dot or segment is displayed in a relatively light color. Generally speaking, the higher the numerical value of the preference data of the user to the video, the darker the color of the corresponding dot or segment in the video playback progress bar.

It can be understood by a person skilled in the art that, without manually dragging the video playback progress bar multiple times, to some extent, a user may determine highlight parts and non-highlight parts of a video according to different shades of colors on the video playback progress bar of the video so as to position parts of interest and/or parts not of interest. Therefore, it is helpful for the user to select whether to watch this video or select which fragment of this video to watch, thus negating several operations having to be performed by the user and improving the user's experience.

The terminal apparatus simplifies the video according to the content of interest and/or the content not of interest.

The terminal apparatus simplifies video fragments of the content not of interest in the video, i.e., non-highlight fragments in the video, so as to only reserve video fragments of the content of interest.

In step S1302, the acquired preference data associated with the video playback progress is displayed.

According to the correspondence data between the preference data of the user to the video and the video playback progress acquired in advance, the terminal apparatus can display the preference data of the user to the video by an impression curve in a coordinate system. The following description will be given by considering an impression curve as an example. In the coordinate system, the horizontal axis denotes the video playback progress, and the vertical axis denotes the preference data of the user to the video.

The correspondence data between the preference data of the user to the video and the video playback progress acquired in advance includes correspondence data between the video playback progress and the emotional tendentiousness of the user, the video playback progress and the mood of the user, the video playback progress and the viewing rate data, the video playback progress and the score given by the user, and the video playback progress and the overall degree of approval.

The terminal apparatus can acquire correspondence data between the preference data and the video playback progress in real time according to the preference data selected by the user, and then display the correspondence data. For example, the user can select the emotional tendentiousness data of the user for displaying by clicking a key, the terminal apparatus sends a request for acquiring the correspondence data between the video playback progress and the emotional tendentiousness data of the user to a cloud server after detecting the selection operation of the user, the cloud server returns the correspondence data to the terminal apparatus, and the terminal apparatus displays the emotional tendentiousness data of the user in the form of an impression curve.

The impression curve is displayed in correspondence to the video playback progress of the video.

The video playback apparatus and the impression curve display apparatus may be the same terminal apparatus.

For example, when a user watches a video on a smart phone, and when the video is played in full screen, the video playback interface is zoomed to a certain size for playing the video, the video interface is hidden, or the video is closed, the terminal apparatus displays a region in which the impression curve is displayed.

For example, when the video is displayed in full screen, the impression curve can be displayed above a video playback picture in a “hover” manner. When the video is played in non-full screen (that is, the video playback interface is zoomed to a certain size for playing the video), the impression curve can also be displayed above the video playback picture in a “hover” manner, or can also be displayed within regions other than the video playback region.

When the video playback interface is hidden or the video is closed, the impression curve can be displayed in the terminal apparatus interface.

In addition, the user can call out the impression curve by speech, a gesture, a key or an external apparatus. For example, the terminal apparatus displays an impression curve callout key at a preset position of the video playback interface, and calls out and displays the impression curve in the interface after detecting a user's operation with respect to the key.

The present disclosure teaches that the terminal apparatus can display the impression curve of a video when the video is not displayed. For example, if the user performs an operation of searching the impression curve of a certain video, the terminal apparatus searches the impression curve of the video according to the operation of the user and then displays the searched impression curve. In addition, during the video playback process, the terminal apparatus can also display the impression curve within a video playback region above the video playback picture in a “hover” manner. To not influence the normal watching of the user, the impression curve can also be displayed within a non-playback region. If the video is played in full screen currently, the terminal apparatus can detect the visual focus of the user in real time by a front camera or other apparatuses, and then display the impression curve at a non-visual-focus position.

The video playback apparatus and the impression curve display apparatus can also be different terminal apparatuses. For example, the video playback apparatus can be a smart TV or a display apparatus in a public place such as a subway station or a bus station, while the impression curve display apparatus can be a smart phone or a tablet computer of the user. When the video is played on the playback apparatus or is closed, the impression curve display apparatus can acquire the ID information of the video played by the video playback apparatus by logging-into one user account, sound recognition, image recognition or QR code recognition, then search the user's impression curve corresponding to the video according to the ID information of the video played by the video playback apparatus and display the searched impression curve, so that the information exchange between the video playback apparatus and the impression curve display apparatus is realized.

This embodiment of the present disclosure includes but is not limited to the following examples of the impression curve.

FIG. 13C illustrates an example of an impression curve of the video playback progress of a video and user's emotional tendentiousness data, where the horizontal coordinate in FIG. 13C can be the video playback progress time of the video, and the vertical coordinate can be the amplitude of the emotional tendentiousness data of the user.

FIG. 13D illustrates an example of an impression curve of the video playback progress of a video and user's mood data, where the horizontal coordinate in FIG. 13D can be the video playback progress time of the video, and the vertical coordinate can be the amplitude of the mood of the user.

FIG. 13E illustrates an example of an impression curve of the video playback progress of a video and the viewing rate data, where the horizontal coordinate in FIG. 13E can be the video playback progress time of the video, and the vertical coordinate can be the amplitude of the viewing rate data.

FIG. 13F illustrates an example of an impression curve of the video playback progress of a video and the evaluation data of a user, where the horizontal coordinate in FIG. 13F can be the video playback progress time of the video, and the vertical coordinate can be the amplitude of the evaluation data of the user.

FIG. 13G illustrates an example of an impression curve of the video playback progress of a video and the overall data of degree of approval, where the horizontal coordinate in FIG. 13G can be the video playback progress time of the video, and the vertical coordinate can be the amplitude of the overall data of degree of approval.

It can be understood by a person skilled in the art that the impression curve can be available for user's browsing and reference, and the user can view the coordinates (time, numerical value) of any point on the impression curve, i.e., the video playback progress and the amplitude/score/average playback rate corresponding to the video playback progress. The user can determine highlight parts and non-highlight parts of the video to some extent according to the impression curve so as to position the parts of interest and/or parts not of interest. The user can also judge the highlight of the video as a whole according to the impression curve. Accordingly, it is helpful for the user to select whether to watch this video or which fragment of this video to watch, thus improving the user's experience.

The terminal apparatus can acquire, from a cloud server, correspondence data between the feedback data of a user who is watching a plurality of videos and the video playback progress, and can display the correspondence data of a user who is watching a video and the video playback progress of the video in the form of an impression curve. The time illustrated in the horizontal axis of the impression curve is the video playback progress corresponding to the feedback data of the user who is watching the video, and the vertical axis denotes the feedback data of the user who is watching the video.

After the impression curve is displayed, for each video playback progress of a video, a numerical value (i.e., the preference data of the user to the video) of the vertical coordinate of the video playback progress in the impression curve is correspondingly displayed at the video playback progress of the video playback progress bar of the video, for viewing convenience to the user.

For the impression curve displayed in correspondence to the video playback progress bar of the video, marks of the highlight fragments and/or non-highlight fragments are displayed on the impression curve.

In step S1303, video playback progress corresponding to the selected preference data is positioned in the video, after detecting a selection operation with respect to the displayed preference data.

After the terminal apparatus displays the impression curve of the user's impression data, the user can browse the impression curve and then select a certain time point on the impression curve to perform a preset operation, and the terminal apparatus determines video playback progress moment (time point) of this point after detecting a user's operation of selecting one point on the impression curve.

If the user selects a certain segment of interest (corresponding to video playback progress time period) on the impression curve to perform a preset selection operation, the terminal apparatus can determine video playback progress time period corresponding to a curve segment after detecting a user's operation of selecting the curve segment corresponding to the video playback progress time period.

After the terminal apparatus displays an impression curve containing the user's feedback data, the user can browse the impression curve and randomly select a certain progress of interest on the video playback progress bar to perform a preset selection operation or select a certain segment of interest on the video playback progress to perform a preset selection operation, and the terminal apparatus determines video playback progress instant or video playback progress time period corresponding to the selection operation of the user with respect to the video playback progress bar after detecting the selection operation of the user.

After the terminal apparatus displays an impression curve containing the user's feedback data, the user can browse the impression curve and select a certain progress of interest on the impression curve to perform a preset selection operation or select a certain segment of interest on the impression curve to perform a preset selection operation, and the terminal apparatus determines video playback progress instant or video playback progress time period corresponding to the selection operation of the user with respect to the impression region after detecting the selection operation of the user.

The impression curve of a video is displayed, and the non-highlight fragments are simplified, in response to a video optimization operation with respect to the impression curve.

Specifically, a user can select a video optimization function while watching a video, and the terminal apparatus recognizes non-highlight fragments and highlight fragments of the video according to the impression curve after detecting the selection operation of the user, and then automatically simplifies the non-highlight fragments of the video.

In step S1304, the positioned video playback progress is displayed, and/or the video is positioned to the video playback progress for displaying after detecting a playback instruction with respect to the positioned video playback progress.

The terminal apparatus can skip the video to video playback progress instant corresponding to a point on the impression curve indicating the user's preference data for displaying. The terminal apparatus can also position the video to the video playback progress moment for playback, after detecting a playback instruction with respect to the video playback progress moment.

The terminal apparatus can skip the video to video playback progress time period corresponding to a curve segment on the impression curve indicating the user's preference data for displaying, and can position the video to a starting instant of the video playback progress time period for playback, after detecting a playback instruction with respect to the video playback progress time period. Specifically, the playback of the video is started from video playback progress instant corresponding to the starting point of the curve segment, and ended at video playback progress instant corresponding to the ending point of the curve segment.

When the terminal apparatus is playing a video and a selection operation of the user is detected, the video is played after skipping from the current video playback progress moment to video playback progress instant corresponding to a point selected by the user, or a corresponding fragment is played after skipping from the current video playback progress moment video playback progress instant corresponding to a starting point of a time period selected by the user.

If the terminal apparatus is not currently playing a video and a selection operation of the user is detected, the terminal apparatus first activates the playback of the video and then uses video playback progress instant corresponding to a point selected by the user as a starting point for playback or uses video playback progress instant corresponding to a starting point of a time period selected by the user as a starting point for playback of a corresponding video fragment.

After a selection operation with respect to the video playback progress of a video is detected, preference data corresponding to the selected video playback progress is positioned from the displayed preference data of the user to the video.

Specifically, after the terminal apparatus determines the video playback progress instant corresponding to the point selected by the user on the video playback progress bar or the video playback progress time period corresponding to the segment selected by the user on the video playback progress bar in step S1303, the terminal apparatus in step S1304 displays, on the impression curve, the related information of a curve point corresponding to the video playback progress instant of the video or the related information of a curve segment corresponding to the video playback progress time period.

The related information of a curve point includes at least one of video playback progress, a numerical value corresponding to the video playback progress, feedback of all users to the video at this video point, i.e., comments of users to the video, operations of users to the video, physiological responses of users who are watching the video, and scores given by users to the video, for example.

The related information of a curve segment includes at least one of video playback progress, data which can be an average value corresponding to the video playback progress, feedback of all users to the video at this video fragment, i.e., comments of users to the video, operations of users to the video, physiological responses of users who are watching the video, and scores given by users to the video, for example. Within the time period, there can be more than one operation performed by a user to the video, such as fast-forward or pause.

Feedback data of the user who is watching the video corresponding to the selected preference data is displayed, after a selection operation with respect to the displayed preference data is detected.

Specifically, after the terminal apparatus determines the video playback progress instant corresponding to the point selected by the user on the video playback progress bar or the video playback progress time period corresponding to the segment selected by the user on the video playback progress in step S1303, the terminal apparatus displays user's feedback details on the impression curve, such as comments of the user to the video, operation actions performed by the user to the video, the physiological response of the user who is watching the video, and evaluation data of the user to the video.

If a time period is selected, there can be more than one operation performed by the user to the video, such as fast-forward and pause. The feedback details of the user within this time period are displayed, such as comments of the user to the video, operation actions performed by the user to the video, the physiological response of the user who is watching the video, evaluation data of the user to the video and more. If a certain feedback detail of interest is selected to be subjected to a preset selection operation, the video can be played after skipping to video playback progress corresponding to the feedback detail selected by the user for playback.

If the terminal apparatus is playing the video currently and if a selection operation of the user is detected, the video is played after skipping from the current video playback progress to video playback progress corresponding to the point selected by the user for playback, and if the terminal apparatus is not playing the video currently and a selection operation of the user is detected, the terminal apparatus first activates the playback of the video and then uses video playback progress corresponding to the feedback detail selected by the user as a starting point for playback.

A highlight fragment of the video is played.

On the video playback progress bar of the video, a progress bar segment corresponding to the highlight fragment is highlighted. Alternatively, in the impression curve, a curve segment corresponding to the highlight fragment is highlighted.

Specifically, the terminal apparatus highlights highlight fragments recognized in the above step on the video progress bar, so that the terminal apparatus automatically skips non-highlight fragments and prompts the user of highlight fragments in a highlight manner when the user actually watches the video, thus improving the user's experience in watching the video.

FIG. 13H illustrates an example of positioning the content of a video according to the preference data of a user to the video. As illustrated in FIG. 13H, a fragment having a score less than the non-highlight threshold is simplified, and a fragment having a score greater than the highlight threshold is highlighted and marked in green.

In the method for positioning the content of a video based on preference data according to the thirteenth embodiment of the present disclosure, the terminal apparatus can display the preference data of the user to the video for user's reference and determine whether to watch this video or determine which fragment of this video to watch. In contrast to the prior art, in which the user can acquire the impression to the video only by manually dragging and watching the video fragment progress, the user's emotional data in the present disclosure can reflect the user's impression of the video more comprehensively, accurately and intuitively. While watching the video, the user can select whether to watch this video or which fragment of this video to watch, according to the preference data of the user to the video, enhancing user's convenience. It is also possible to quickly skip to the video playback progress of interest for watching, according to the preference data of the user to the video. In addition, the terminal apparatus can also mark, simplify and/or highlight the video content according to the preference data of the user to the video, so that the user can quickly position to the desired video content according to the marked, simplified and/or highlighted video, thus improving the user's experience of watching the video.

### Fourteenth Embodiment

The present disclosure considers that a user usually will use an automatic downloading function of a terminal apparatus. In an existing method, during the automatic video downloading process, the terminal apparatus usually downloads video fragments one by one according to the playback sequence of the video fragments of the video. When the current apparatus state of the terminal apparatus changes (for example, the electric power or the storage space of the terminal apparatus is exhausted), the downloading is terminated, and consequently, an incomplete video is obtained. However, the present disclosure teaches that there are usually many video fragments such as dilatory plots in the incomplete video, thus frequently causing a poor user's experience of watching the video. In addition, when the electric power or storage space of the terminal apparatus is exhausted, the user is required to perform additional operations such as charging or managing the storage space, which is time-consuming and inconvenient.

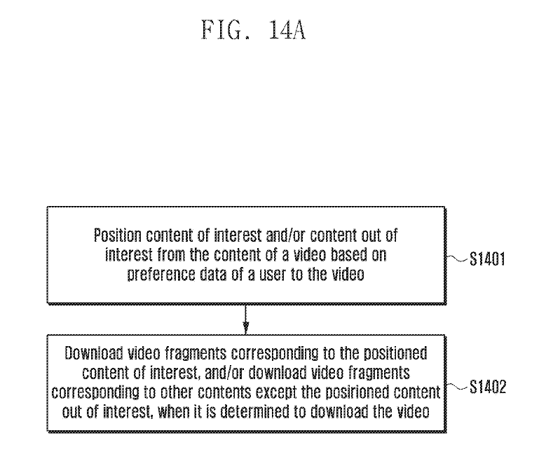

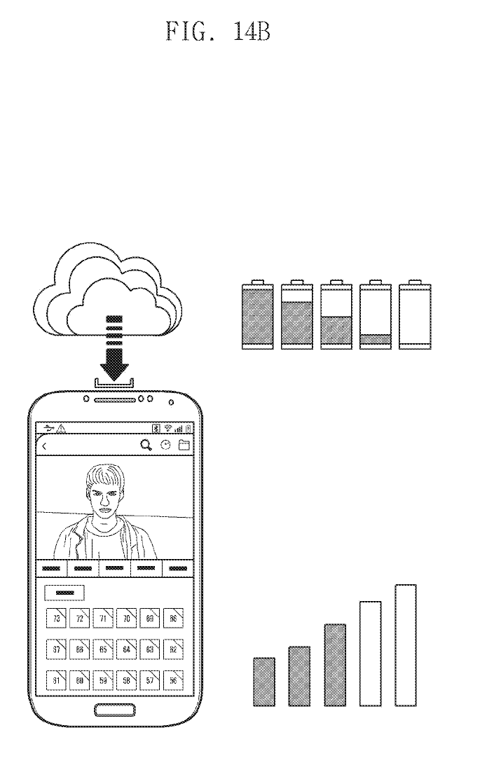

To cure these matters, the fourteenth embodiment of the present disclosure as illustrated in FIG. 14A provides a method for downloading a video based on preference data. In step S1401, content of interest and/or content not of interest are positioned from the content of a video based on preference data of a user to the video.

The specific method for positioning the content of interest and/or content not of interest from the content of a video is identical to the method for positioning the content of interest and/or content not of interest from the content of a video in S1301 of FIG. 13A, and will not be repeated here.

In step S1402, video fragments corresponding to the positioned content of interest are downloaded, and/or video fragments corresponding to other contents except the positioned content not of interest are downloaded, when it is determined to download the video.

Whether to download video fragments corresponding to the content of interest and/or video fragments corresponding to other contents except the content not of interest is determined according to at least one of the current state of an apparatus, pre-settings and a downloading trigger operation of the user.

The current state of an apparatus includes at least one of the current electric power state, current storage state, and current network state of the apparatus.

Based on the same method as described in step S1301, video fragments corresponding to the content of interest can be regarded as highlight fragments, while video fragments corresponding to the content not of interest can be regarded as non-highlight fragments.

After a user downloads a video, in response to this downloading operation, the respective video playback progress of at least one highlight fragment in the video is determined, and the highlight fragment of this video is downloaded from a cloud server according to the determined video playback progress and the current state of an apparatus of the terminal apparatus.

Specifically, the video can be downloaded according to the preference data of the user to the video and the current electric power state of the terminal apparatus.

When the terminal apparatus detects a user's operation of downloading a certain video, in response to the downloading operation, the terminal apparatus can first detect the current electric power state of the terminal apparatus and then estimate whether the current electric power state of the apparatus can support the downloading of the video. If so, the full content of the video can be directly downloaded from the network side.

If it is estimated that the current electric power state of the apparatus is unable to support the downloading of the video, it is possible to acquire, from a cloud server, the preference data of the user to the video and then obtain by analysis the content of interest and the content not of interest of the video according to the preference data of the user to the video fed back by the cloud server. The analysis progress of the content of interest and the content not of interest refers to the description of steps S1301-S1302 in FIG. 13A. The terminal apparatus can download only the content of interest obtained by analysis, according to the starting time and ending time of the highlight fragments, or can download video fragments except the non-highlight fragments, instead of downloading the content out of content, according to the starting time and ending time of the non-highlight fragments.

For example, FIG. 14B illustrates an example of intelligently downloading a video according to the preference data of a user to the video and the electric power of a terminal apparatus. For example, for a film video, the full duration is 2 hours, the resolution is 1080P, and the video size is 2 G. When the terminal apparatus downloads this film, the actual conditions of the terminal apparatus are as follows: the current electric power state of the terminal apparatus is only 20%, so it is impossible to download the complete film of 1080P. Accordingly, in combination with an impression curve and in accordance with the actual conditions of the terminal apparatus, the terminal apparatus downloads video contents which satisfy the user to the maximum limit, i.e., three highlight video fragments: a video fragment having a duration of 25 minutes and a resolution of 1080P, a video fragment having a duration of 25 minutes and a resolution of 720P, and a video fragment having a duration of 10 minutes and a resolution of 1080P, where the total duration is 1 hour.

The video can be downloaded according to the preference data of the user to the video and the current storage state of the terminal apparatus.

When the terminal apparatus detects a user's operation of downloading a certain video, in response to the downloading operation, the terminal apparatus can first detect the current storage state of the terminal apparatus and then estimate whether the current storage state can support the storage of the video. If the current storage state can support the storage of the video, the full content of the video can be directly downloaded from the network side.

If it is estimated that the current storage state is unable to support the storage of the full content of the video, it is possible to acquire, from a cloud server, the preference data of the user to the video and then obtain by analysis the content of interest and the content not of interest of the video according to the preference data of the user to the video fed back by the cloud server. The terminal apparatus can download only the content of interest obtained by analysis, according to the starting time and ending time of the highlight fragments, or the terminal apparatus may not download the content not of interest according to the starting time and ending time of the non-highlight fragments.

For example, for a film video, the full duration is 2 hours, the resolution is 1080P, and the video size is 2 G. When the terminal apparatus downloads this film, the actual conditions of the terminal apparatus are that the remaining storage space of the memory of the terminal apparatus is only 1 G, so it is impossible to download the complete film of 1080P. Accordingly, in combination with an impression curve and in accordance with the actual conditions of the terminal apparatus, the terminal apparatus downloads video contents which satisfy the user to the maximum limit, i.e., three highlight video fragments: a video fragment having a duration of 25 minutes and a resolution of 1080P, a video fragment having a duration of 25 minutes and a resolution of 720P, and a video fragment having a duration of 10 minutes and a resolution of 1080P, where the total duration is 1 hour.

The video can be downloaded according to the preference data of the user to the video and the current network state of the terminal apparatus.

When the terminal apparatus detects a downloading operation of the user to a certain video, in response to the downloading operation, the terminal apparatus can first detect the current network condition of the terminal apparatus. If the current network condition is good, such as in a WiFi environment, or the downloading speed is greater than a preset threshold, the full content of the video can be directly downloaded from the network side.

If the current network condition is poor, such as in a non-WiFi environment, or the downloading speed is less than the preset threshold, it is possible to acquire, from a cloud server, the preference data of the user to the video and then obtain by analysis the content of interest and the content not of interest of the video according to the preference data of the user to the video fed back by the cloud server. The terminal apparatus can download only the content of interest obtained by analysis, according to the starting time and ending time of the highlight fragments, or may not download the content not of interest according to the starting time and ending time of the non-highlight fragments.

For example, for a film video, the full duration is 2 hours, the resolution is 1080P, and the video size is 2 G. When the terminal apparatus downloads this film and the current network environment is a non-WiFi environment, in combination with an impression curve and in accordance with the actual conditions of the terminal apparatus, the terminal apparatus downloads video contents which satisfy the user to the maximum limit, i.e., three highlight video fragments: a video fragment having a duration of 25 minutes and a resolution of 1080P, a video fragment having a duration of 25 minutes and a resolution of 720P, and a video fragment having a duration of 10 minutes and a resolution of 1080P.

The video can be downloaded according to the preference data of the user to the video and the current state of an apparatus of the terminal apparatus.

The terminal apparatus can also determine whether the video content can be downloaded completely according to at least one of the current electric power state, current storage state and current network condition of the terminal apparatus. If the video cannot be downloaded completely, the preference data of the user to the video is acquired from a cloud server, and the content of interest and the content not of interest of the video are obtained by analysis according to the preference data of the user to the video fed back by the cloud server. Then, the terminal apparatus downloads only the content of interest obtained by analysis, or does not download the content not of interest.

In the method for downloading a video based on preference data according to the fourteenth embodiment of the present disclosure, the terminal apparatus no longer downloads the complete video content. In the case of poor actual apparatus conditions of the terminal apparatus, the terminal apparatus downloads highlight fragments only and/or video fragments except the non-highlight fragments according to the preference data of the user to the video, so that the downloading and viewing needs of the user can be met in the current state of the apparatus and the user's experience can be improved.

### Fifteenth Embodiment

The present disclosure considers that a user may wish to share a highlight video with other users while watching the video. In an existing video sharing method, a user usually needs to intercept a video into video fragments having a fixed duration, and then share the video fragments. However, when other users want to continuously watch the complete video to which the video fragments pertain after watching the shared video fragments, the other users usually need to search a plurality of similar videos over the network and then watch the plurality of similar videos one by one. When doing so, it can be exceedingly difficult to find the video to which the video fragments pertain. Even if the video can be discovered, it will inconveniently consume a large amount of energy and time of other users.

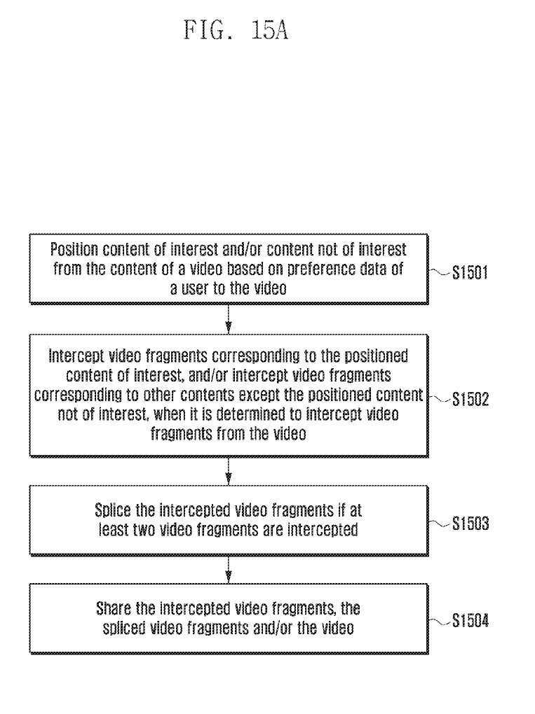

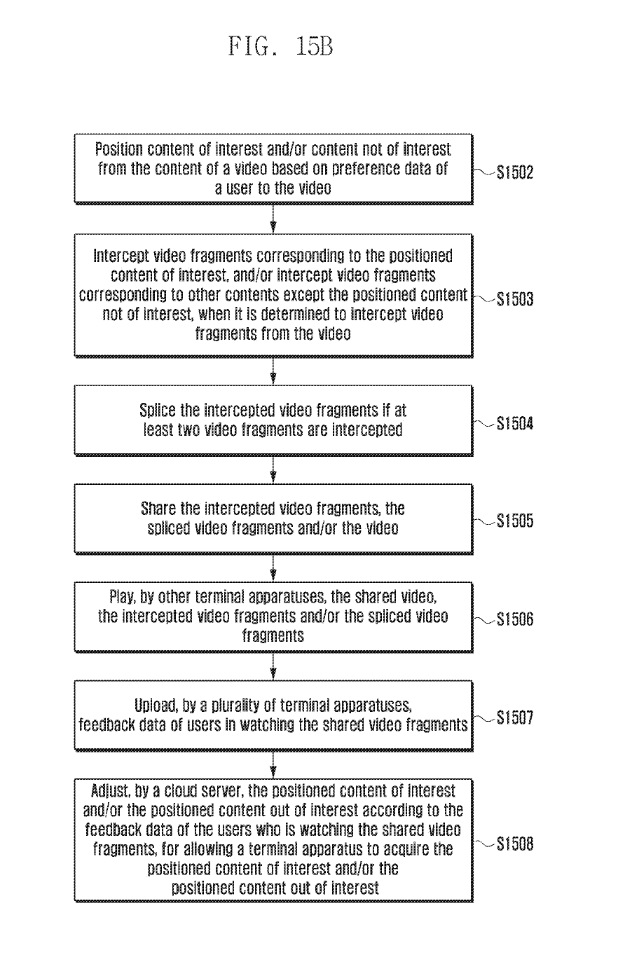

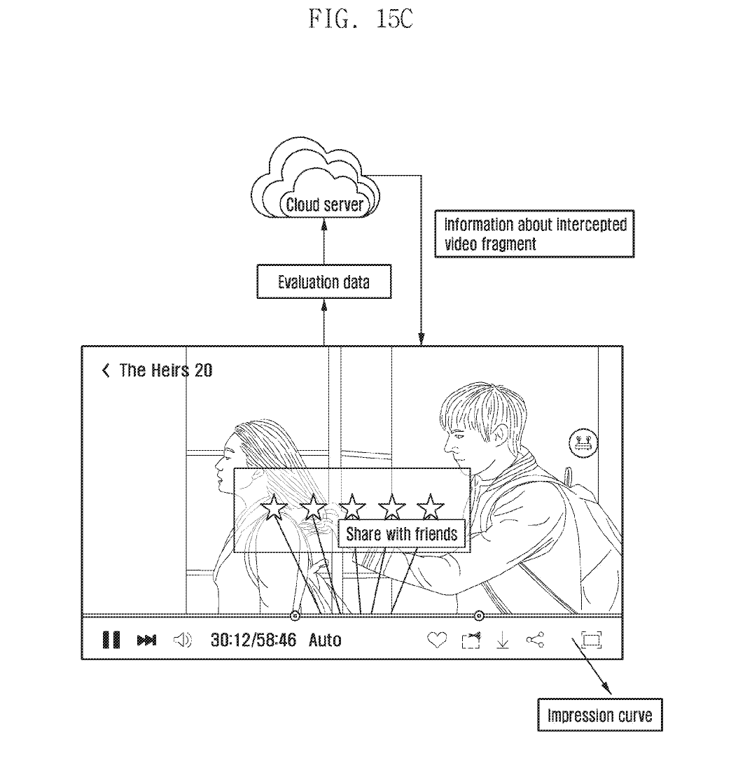

To cure these matters, the fourteenth embodiment of the present disclosure as described in FIG. 15A provides a method for intercepting and sharing a video based on preference data. In step S1501, content of interest and/or content not of interest are positioned from the content of a video based on preference data of a user to the video.

The specific method for positioning the content of interest and/or content not of interest from the content of a video is identical to the method for positioning the content of interest and/or content not of interest from the content of a video in step S1301 of FIG. 13A, and will not be repeated here.

In step S1502, video fragments corresponding to the positioned content of interest are intercepted, and/or video fragments corresponding to other contents except the positioned content not of interest are intercepted, when it is determined to intercept video fragments from the video.

Based on the same method as described in step S1301, in step S1502, video fragments corresponding to the content of interest can be regarded as highlight fragments, while video fragments corresponding to the content not of interest may be regarded as non-highlight fragments.

Intelligently intercepted video fragments can be highlight video fragments, or can be other video fragments except non-highlight video fragments. In this embodiment of the present disclosure, for the sake of convenience, the description is given by considering highlight video fragments as an example.

In response to an intercepting and sharing operation, according to the preset highlight threshold and non-highlight threshold, video fragments marked as the highlight fragments are intercepted from the video, or video fragments except non-highlight fragments are intercepted, to obtain intercepted video fragments.

In step S1503, the intercepted video fragments are spliced, if at least two video fragments are intercepted.

As the user does not need to manually splice video fragments, it is more convenient for the user to watch the intercepted or shared video fragments.

In step S1504, the intercepted video fragments, the spliced video fragments and/or the video are shared.

The terminal apparatus can share the intercepted and/or spliced video fragments in at least one of directly sharing the intercepted or spliced video fragments, sharing the video to which the intercepted or spliced video fragments pertain, and playback progresses of the intercepted or spliced video fragments in the video, and sharing a content acquisition mode of the intercepted or spliced video fragments, and the video to which the intercepted or spliced video fragments pertain.

Specifically, in sharing mode (1), the intercepted video fragments and/or spliced video fragments are directly shared so that other terminal apparatuses can directly play the received video fragments.

In sharing mode (2), the playback progress of the video and of the video fragments and/or intercepted video fragments in the video (for example, the starting time information and the ending time information) are shared.

In sharing mode (3), the content acquisition mode of the intercepted video fragments, the spliced video fragments and/or the video is shared. With respect to the spliced video fragments, the storage address information of the spliced video fragments and the video to which the spliced video fragments pertain, and at least one of the video fragments are shared. For example, the storage address information can be a uniform resource locator (URL).

FIG. 15B illustrates the method for intercepting and sharing a video based on preference data according to the fifteenth embodiment of the present disclosure, subsequent to the method of FIG. 15A.

In step S1505, other terminal apparatuses play the shared video, intercepted video fragments and/or spliced video fragments.

Specifically, other users play the shared video fragments by other terminal apparatuses. If users want to watch the intercepted video fragments or spliced video fragments, there are three playback modes (1)-(3) separately corresponding to the three sharing modes (1)-(3) as described above in step S1504.

Playback mode (1): Other terminal apparatuses can directly play the received video fragments, which can be the intercepted video fragments and/or spliced video fragments mentioned above.

Playback mode (2): Other terminal apparatuses receive the shared video and the playback progress of the video fragments in the video, then play the video fragments according to the received playback progress after detecting a video playback instruction, and resume playing other contents of the video after detecting a resume playback instruction.

For example, other terminal apparatuses receive the shared video and the playback progress of the intercepted video fragments in the video, then play the intercepted video fragments according to the received playback progress after detecting a video playback instruction, and can resume playing other contents in the video after playing the video fragments and detecting a resume playback instruction.

Playback mode (3): Other terminal apparatuses receive the shared content acquisition mode of the video fragments and of the complete video, then play the received video fragments after detecting a video playback instruction, and acquire the content of the complete video according to the received content acquisition mode and resume playing the content of the complete video after detecting a resume playback instruction.

For example, if a terminal apparatus shares the playback URL of the complete video and the intercepted video fragments, other terminal apparatuses play the received video fragments after detecting a video playback instruction, and acquire and resume playing the content of the complete video according to the received URL if a resume playback instruction input by the user is detected after playing the video fragments.

In step S1506, a plurality of terminal apparatuses upload feedback data of users who are watching the shared video fragments.

When other users watch video fragments by other terminals, it is possible to generate feedback (evaluation) data to the video. The evaluation data includes, but is not limited to, at least one of a good evaluation, poor evaluation and no evaluation. Other terminal apparatuses upload the evaluation data of users, corresponding video ID and corresponding video fragment ID to a cloud server.

In step S1507, the plurality of terminal apparatuses upload feedback data of users who is watching the shared video fragments.

In step S1508, the cloud server adjusts the positioned content of interest and/or the positioned content not of interest according to the feedback data of the user who is watching the shared video fragments, for enabling the terminal apparatus to acquire the content of interest and/or the positioned content not of interest.

The cloud server analyzes the feedback data of a user who is watching the shared video fragments uploaded by a plurality of terminal apparatuses in step S1506, and then, according to the number of good evaluations and the number of poor evaluations of the users to the video fragment, automatically alters the threshold for intercepting the video and further alters the starting time and ending time for intercepting the video, where the duration of corresponding video fragments may vary.

In addition, the number of video fragments may also vary. That is, the duration of the intelligently intercepted video fragments (including the starting time and ending time for intercepting the video) and the number of video fragments will be dynamically adjusted.

Other terminal apparatuses acquire, in advance, the duration of the intercepted video fragments (including the starting time and ending time for intercepting the video), the number of video fragments, corresponding video ID, and corresponding video fragment ID.

Therefore, after the big data analysis is realized, the starting point/ending point of a highlight video really satisfies the preference of the user. For example, while watching a shared fragment, the user can perform good evaluation on this shared fragment. The number of good evaluations is recorded, and is synchronized to the impression curve. When the number of good evaluations reaches a certain value, the highlight threshold of the corresponding video fragment will decrease correspondingly, so that the time of the highlight video fragment will be lengthened. That is, the greater the number of good evaluations given by users is, the longer the length of the video is.

Conversely, while watching, the user can give a thumbs-down. The number of thumbs-down is recorded, and is synchronized to the impression curve. When the number of thumbs-down reaches a certain value, the highlight threshold of the corresponding video fragment will increase correspondingly, so that the time of the highlight video fragment will be decreased. That is, the greater the number of thumbs-down given by users, the shorter the length of the video.

In the extreme case, when the number of good evaluations reaches a certain value, all the spliced video fragments are highlight video fragments, and conversely, when the number of thumbs-down reaches a certain value, the video fragments are not highlight video fragments any more.

FIG. 15C illustrates an example of intercepting and sharing a video. As illustrated in FIG. 15C, a highlight video is intelligently intercepted and shared according to the preference data of the user to the video. After video fragments are shared with other users, the other users will evaluate the video while watching the video fragments, where the evaluation includes but is not limited to at least one of good evaluation, poor evaluation and no evaluation. The system uploads the evaluation data of the users, corresponding video ID and corresponding video fragment ID to a cloud server, which analyzes the data, and then, according to the number of good evaluations and the number of poor evaluations of the users to the video fragments, automatically alters the threshold for intercepting the video, and further alters the starting time and ending time for intercepting the video. Accordingly, the duration of the corresponding video fragments may vary.

In addition, the number of video fragments may also vary. When the user intercepts video fragments, the system acquires information about the intercepted video fragments from the cloud server in advance. For example, if there are many good evaluations, for example, if a number of the good evaluations reaches a predetermined value, the threshold will decrease, and the time for intercepting highlight fragments by the user will be lengthened. However, if there are few good evaluations, for example, if a number of the good evaluations is below a predetermined value, the threshold will increase, so that the time for intercepting highlight fragments by the user next time will be decreased. The threshold can also be dynamically adjusted according to the number of poor evaluations of the user. If there are many poor evaluations, the threshold will increase, and the number of highlight fragments intercepted by the user will decrease. However, if there are few poor evaluations, the threshold will decrease, and the number of highlight fragments intercepted by the user will increase.

In the method for intercepting and sharing a video based on preference data according to the fifteenth embodiment of the present disclosure, the terminal apparatus intelligently intercepts video fragments according to the preference data of the user to the video. In comparison with the conventional manual selecting and intercepting a video by a user, the method is more accurate and saves a large amount of manual selection operations of the user. Moreover, the playback progress of intercepted video fragments can also be dynamically adjusted according to the number of good evaluations and the number of poor evaluations of users, and the cloud server performs big data analysis, so that the video fragments intercepted according to the preference data of the user to the video are closer to the real impression of the user. The shared spliced video fragments can be automatically spliced from a plurality of video fragments, and no manual splicing by the user is required, which is convenient for user viewing. After other users watch the shared video fragments, the other users can continue to watch the spliced video fragments and/or the complete video, so that the step of searching the spliced video fragments and/or the complete video by other users is negated, and the user's experience is greatly improved.

### Sixteenth Embodiment

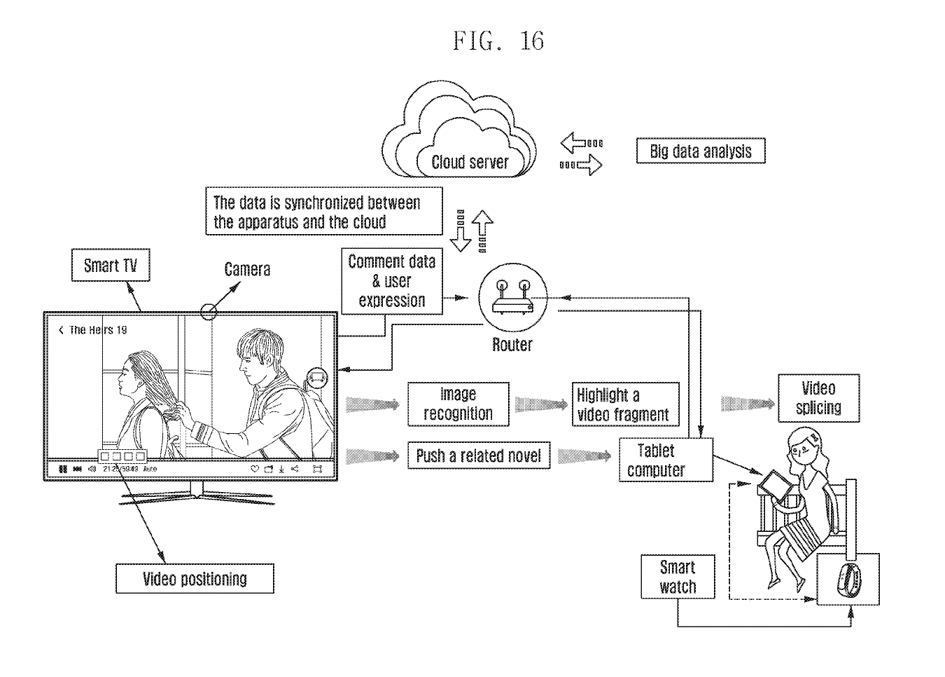

Based on the steps illustrated above in FIGS. 2-15, a particular example of an overall implementation of the present disclosure will be described in the sixteenth embodiment of the present disclosure in FIG. 16, where a user may have a plurality of intelligent terminal apparatuses, for example, a smart phone, a tablet computer, a PC, a smart TV, and a wearable apparatus. The user can use one or more of the apparatuses to watch a video.

The video can be stored in the terminal apparatus, or acquired from the network side. The acquiring from the network side includes downloading from the network side to the terminal apparatus for local storage, or online browsing by the terminal apparatus.

With reference to FIG. 16, the user uses a smart TV to watch a video, and the smart TV is connected to a tablet computer through a router. When the user watches the video, the user can issue comments by the tablet computer. The comment content to the video can be displayed on the smart TV or the tablet computer, and the camera of the smart TV collects expression information of the user in real time. Meanwhile, a smart watch collects the physiological response of the user who is watching the video in real time, for example, body temperature, heart rate, blood pressure or other physiological indices, and the smart watch synchronously sends the collected data to the tablet computer since the smart watch is in connection to the tablet computer. The tablet computer uploads the comment data issued by the user and the physiological response data of the user transmitted from the smart watch to a cloud server through the router. In addition, the smart TV uploads the user's expression information to the cloud server, where the comment data of the user can also be uploaded to the cloud server by the smart TV. When the apparatuses such as the tablet computer, the smart watch, and the smart TV, upload the comments issued by the user, the video playback progress corresponding to the moment of issuing the comments and the comment content are uploaded correspondingly.

The cloud server collects the data uploaded by a large amount of apparatuses, then performs big data analysis, and synchronizes the processed data to the apparatuses through the router. If the user clicks any comment, the current video can be played after skipping to the moment of the video playback progress corresponding to the moment of issuing this comment, so that the purpose of positioning the video by comments is realized. The user can select a point of interest in the video, for example, a character, an animal, scenery or other objects or various scenes, and the terminal apparatus recognizes, from the video, fragments in which the point of interest of the user appears, according to an image recognition technology, and highlights the fragments for convenience of user's selection and watching. These fragments can be spliced, for convenience of intercepting and sharing the video by the user. The smart TV pushes a related novel to the tablet computer of the user according to the content of the played video, so that it is convenient for the user to directly view the corresponding novel plots on the tablet computer.

### Seventeenth Embodiment

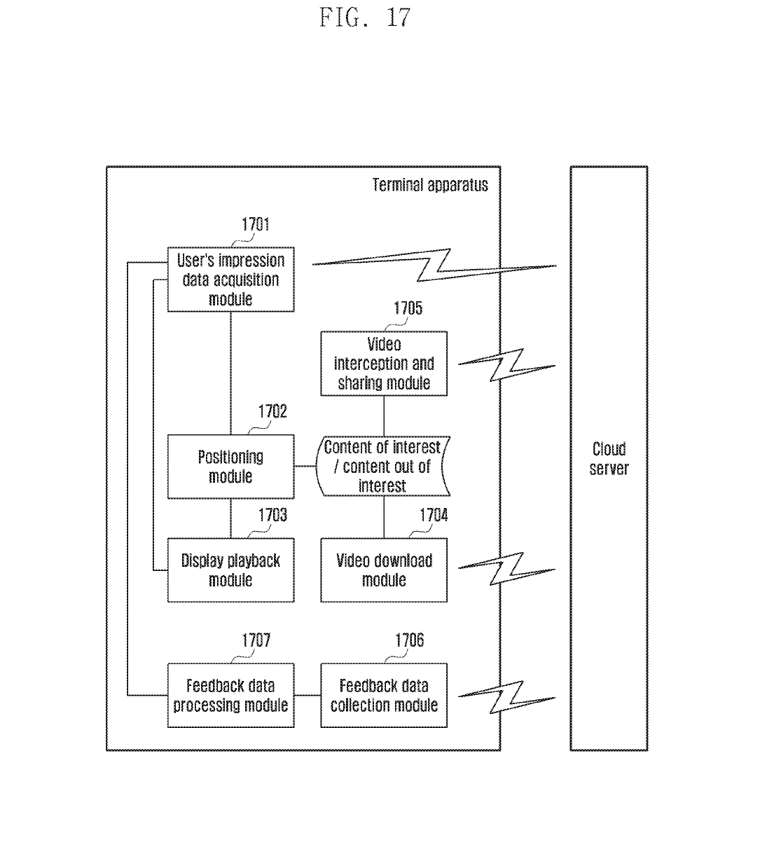

Based on the methods illustrated in FIGS. 2-6 and FIGS. 8-15, a block diagram of an internal structure of a terminal apparatus according to the seventeenth embodiment of the present disclosure is as illustrated in FIG. 17, including a user's impression data acquisition module 1701 and a positioning module 1702.

The user's impression data acquisition module 1701 is configured to acquire user's impression data associated with video playback progress of a video.

The positioning module 1702 is configured to position the content of the video based on the acquired user's impression data.

The user's impression data includes comment data of the user on the video, and/or preference data of the user to the video. The preference data of the user to the video includes at least one of emotional tendentiousness data of the user to the video; mood data of the user who is watching the video, viewing rate data of the user who is watching the video, evaluation data of the user to the video, and overall data of degree of approval of the user to the video.

The positioning module 1702 is configured to determine comment content of interest from the comment data of the user to the video; and position, in the video, video playback progress associated with the comment content of interest.

The positioning module 1702 is configured to determine corresponding video content of interest based on the comment content of interest; and position, in the video, video playback progress associated with the video content of interest.

The video content includes at least one of object content, scene content and event content.

The positioning module 1702 is configured to determine a video frame image corresponding to the video playback progress associated with the comment content of interest; and determine corresponding video content of interest based on the video frame image.

The positioning module 1702 is configured to determine corresponding video content of interest from the comment content of interest.

The comment content of interest includes at least one of text, speech, picture and video comment content.

If the comment content of interest includes the picture comment content, the video comment content or the speech comment content, the positioning module 1702 is configured to acquire text content corresponding to the picture comment content, the video comment content or the speech comment content and determine corresponding video content of interest from the acquired text content.

As illustrated in FIG. 17, the terminal apparatus in this embodiment of the present disclosure further includes a display playback module 1703.

The display playback module 1703 is configured to display the video playback progress positioned by the positioning module 1702, and/or position the video to the video playback progress positioned by the positioning module 1702 for playback, after detecting a playback instruction with respect to the positioned video playback progress.

The positioning module 1702 is further configured to acquire a video fragment corresponding to the positioned video playback progress according to the video content of the video.

The display playback module 1703 is further configured to display video playback progress corresponding to the video fragment acquired by the acquisition module 1701, and/or, position the video to a starting position of the video fragment acquired by the user's impression data acquisition module 1701 for playback, after detecting a playback instruction with respect to the acquired video fragment.

The positioning module 1702 is further configured to send a comment display notification before determining the comment content of interest.

The display playback module 1703 is further configured to display comment content searched according to a keyword input by the user, after receiving the comment display notification.

The positioning module 1702 is further configured to determine the comment content of interest by one of speech, a key, a gesture and an external apparatus.

The positioning module 1702 is further configured to receive the comment content of interest sent by the external apparatus and/or video playback progress associated with the video content of interest.

The positioning module 1702 is further configured to acquire video playback progress of the electronic text content to be displayed.

The display playback module 1703 determines corresponding electronic text content according to the acquired video playback progress for displaying.

The positioning module 1702 is further configured to acquire the video playback progress of the electronic text content to be displayed by at least one of determining a positioned video playback progress as the video playback progress of the electronic text content to be displayed, determining video playback progress selected by a user as the video playback progress of the electronic text content to be displayed, determining video playback progress corresponding to the video content selected by the user as the video playback progress of the electronic text content to be displayed, and, during the video playback process, determining a current video playback progress as the video playback progress of the electronic text content to be displayed.

The positioning module 1702 is further configured to determine a video fragment of interest from video fragments corresponding to the video.

The display playback module 1703 is further configured to display comment content associated with the video playback progress corresponding to the video fragment of interest.

The positioning module 1702 is further configured to position content of interest and/or content not of interest from the content of the video based on the preference data of the user to the video.

The display playback module 1703 is further configured to display video playback progress corresponding to the content of interest and/or the content not of interest.

The positioning module 1702 is further configured to simplify the video according to the content of interest and/or the content not of interest.

The display playback module 1703 is further configured to display preference data associated with the video playback progress acquired by the user's impression data acquisition module 1701.

The display playback module 1703 is further configured to position, from the displayed preference data of the user to the video, preference data corresponding to the selected video playback progress after detecting a selection operation to the video playback progress of the video, and display the preference data.

The positioning module 1702 is further configured to position, from the video, video playback progress corresponding to the selected preference data, after detecting a selection operation to the displayed preference data.

The display playback module 1703 is further configured to display the positioned video playback progress, and/or position the video to the video playback progress for displaying after detecting a playback instruction with respect to the positioned video playback progress.

The display playback module 1703 is further configured to display feedback data of the user who is watching the video corresponding to the selected preference data, after detecting a selection operation to the displayed preference data.

As illustrated in FIG. 17, the terminal apparatus in this embodiment of the present disclosure further includes a video downloading module 1704.

The video downloading module 1704 is configured to download video fragments corresponding to the positioned content of interest, and/or download video fragments corresponding to other contents except the positioned content not of interest, when it is determined to download the video.

The video downloading module 1704 is further configured to determine whether to download video fragments corresponding to the positioned content of interest and/or video fragments corresponding to other contents except the positioned content not of interest according to at least one of the current state of the apparatus, pre-settings and a downloading trigger operation of the user.

The current state of the apparatus includes at least one of the current electric power state, current storage state and current network state of the apparatus.

As illustrated in FIG. 17, the terminal apparatus in this embodiment of the present disclosure further includes a video interception and sharing module 1705.

The video interception and sharing module 1705 is configured to intercept video fragments corresponding to the positioned content of interest, and/or intercept video fragments corresponding to other contents except the positioned content not of interest, when it is determined to intercept video fragments from the video.

The video interception and sharing module 1705 is further configured to splice the intercepted video fragments if at least two video fragments are intercepted.

The video interception and sharing module 1705 is further configured to perform at least one of sharing an intercepted or spliced video fragment, sharing the video and a playback progress of the intercepted or spliced video fragment in the video, and sharing a content acquisition mode of the intercepted or spliced video fragment and the video.

The video interception and sharing module 1705 is further configured to receive the shared video and the shared playback progress of the video fragment in the video, playing the video fragment according to the received playback progress after detecting a video playback instruction, and resume playing other contents of the video after detecting a resume playback instruction, and/or receive the shared content acquisition mode of the video fragment and the complete video, playing the received video fragment after detecting a video playback instruction, and acquire according to the received content acquisition mode and resuming playing the content of the complete video after detecting a resume playback instruction.

The video interception and sharing module 1705 is further configured to adjust the positioned content of interest and/or the positioned content not of interest according to the feedback data of the user who is watching the shared video fragment.

As illustrated in FIG. 17, the terminal apparatus in this embodiment of the present disclosure further includes a feedback data collection module 1706.

The feedback data collection module 1706 is configured to collect feedback data of the user who is watching the video and corresponding video playback progress.

The feedback of the user who is watching the video includes at least one of comment data of the user to the video, operation data of the user to the video, physiological response data of the user who is watching the video, and evaluation data of the user to the video.

The comment data of the user to the video includes at least one of text, speech, video, picture and expression comment. The operation data of the user to the video includes at least one of a marking operation of the user to the video, a user's operation of dragging the video, a fast-forward, fast-reverse, pause, zooming, interception and video sharing operation. The physiological response data of the user who is watching the video includes at least one of expression information, action information, sound information and physiological indices of the user.

The feedback data collection module 1706 is configured to collect feedback data of the user who is watching the video, and acquire corresponding video playback progress through a video playback apparatus.

The feedback data collection module 1706 acquires the corresponding video playback progress through the video playback apparatus by at least one of account login, speech recognition, image recognition and QR code recognition.

The feedback data collection module 1706 is configured to acquire the feedback data of the user who is watching the video through a collection apparatus, and acquire corresponding video playback progress on the current apparatus.

The feedback data of the user who is watching the video includes comment data of the user on the video and/or evaluation data of the user to the video. The feedback data collection module 1706 is further configured to perform at least one of determining video playback progress, when it is determined to issue the feedback data, as the video playback progress corresponding to the feedback data, determining video playback progress selected by the user as the video playback progress corresponding to the feedback data, and determining video playback progress, when it is determined to input the feedback data, as the video playback progress corresponding to the feedback data.

The feedback data of the user who is watching the video includes operation data of the user to the video, and the feedback data collection module 1706 is further configured to perform at least one of the following:

When the operation of the user to the video is a marking operation, determining at least one of video playback progress corresponding to a video frame in which the mark of the user is located, a starting video playback progress corresponding to the marked video fragment, an ending video playback progress corresponding to the video fragment and video playback progress corresponding to a key video frame in the video fragment as the video playback progress corresponding to the feedback data,

When the operation of the user to the video is a user's operation of dragging the video, a fast-forward operation, a fast-reverse operation, a pause operation or a zooming operation, determining video playback progress during performing the operation and/or video playback progress after performing the operation as the video playback progress corresponding to the feedback data, and

When the operation of the user to the video is an operation of intercepting or sharing the video, determining at least one of a starting video playback progress corresponding to the intercepted or shared video content, an ending video playback progress and video playback progress corresponding to the key video frame as the video playback progress corresponding to the feedback data.

The feedback data collection module 1706 is further configured to upload the collected feedback data and the corresponding video playback progress to a cloud server.

As illustrated in FIG. 17, the terminal apparatus in this embodiment of the present disclosure further includes a feedback data processing module 1707.

The feedback data processing module 1707 is configured to correcting video playback progress corresponding to the collected feedback data according to at least one of the following information: comment content contained in the feedback data, object information of the video, and scene information.

The feedback data processing module 1707 is configured to determine at least one of viewing rate data associated with the video playback progress of the video, emotional tendentiousness data associated with the video playback progress of the video, mood data associated with the video playback progress of the video, and evaluation data associated with the video playback progress of the video.

The feedback data processing module 1707 is further configured to determine overall data of degree of approval associated with the video playback progress of the video according to at least one of the viewing rate data, the emotional tendentiousness data and the mood data.

The feedback data processing module 1707 is further configured to determine the overall data of degree of approval by weight fusion and/or numerical fitting.

The implementations of the functions of the user's impression data acquisition module 1701, the positioning module 1702, the display playback module 1703, the video downloading module 1704, the video interception and sharing module 1705, the feedback data collection module 1706 and the feedback data processing module 1707 can refer to the specific contents of the flow steps illustrated in FIGS. 2-6 and FIGS. 8-15 and will not be repeated here.

### Eighteenth Embodiment

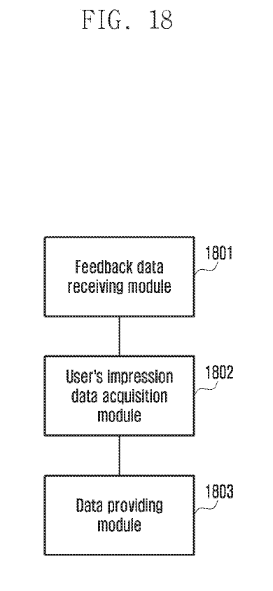

Based on the method in FIG. 7, a block diagram of an internal structure of a cloud server according to an eighteenth embodiment of the present disclosure is as illustrated in FIG. 18, including a feedback data receiving module 1801, a user's impression data determination module 1802 and a data providing module 1803.

The feedback data receiving module 1801 is configured to receive feedback data of a user who is watching a video and corresponding video playback progress uploaded by a plurality of terminal apparatuses.

The user's impression data determination module 1802 is configured to determine user's impression data associated with the video playback progress, based on the feedback data of each user who is watching a video and the corresponding video playback progress.

The data providing module 1803 is configured to provide the determined user's impression data associated with the video playback progresses to a terminal apparatus so that the terminal apparatus positions the content of the video according to the user's impression data.

The user's impression data includes comment data of the user on the video, and/or preference data of the user to the video. The preference data of the user to the video includes at least one of emotional tendentiousness data of the user on the video, mood data of the user who is watching the video, viewing rate data of the user who is watching the video, evaluation data of the user on the video, and overall data of degree of approval of the user to the video.

The user's impression data determination module 1802 is configured to correct the video playback progress corresponding to the feedback data according to at least one of comment content contained in the feedback data, object information of the video, and scene information.

The user's impression data determination module 1802 is configured to determine at least one of the following data based on the feedback data: viewing rate data associated with the video playback progress of the video, emotional tendentiousness data associated with the video playback progress of the video, mood data associated with the video playback progress of the video, and evaluation data associated with the video playback progress of the video.

The user's impression data determination module 1802 is configured to determine the overall data of degree of approval associated with the video playback progress of the video according to at least one of the viewing rate data, the emotional tendentiousness data and the mood data.

The u determination module 1802 is configured to determine the overall data of degree of approval by weight fusion and/or numerical fitting.

The implementation of the functions of the feedback data receiving module 1801, the user's impression data determination module 1802 and the data providing module 1803 can refer to the specific content of the flow steps illustrated in FIG. 7A and will not be repeated here.

It should be understood by a person of ordinary skill in the art that the present disclosure includes devices for performing one or more of operations as described in the present disclosure. The devices can be specially designed and manufactured as intended, or can include well known devices in a general-purpose computer. The devices have computer programs stored therein, which are selectively activated or reconstructed. Such computer programs can be stored in device (such as computer) readable media or in any type of media suitable for storing electronic instructions and respectively coupled to a bus, the computer readable media include but are not limited to any type of disks (including floppy disks, hard disks, optical disks, CD-ROM and magneto optical disks), ROM (read-only memory), RAM (random access memory), EPROM (erasable programmable read-only memory), EEPROM (electrically erasable programmable read-only memory), flash memories, magnetic cards or optical line cards. That is, readable media include any media storing or transmitting information in a device (for example, computer) readable form.

It can be understood by a person of ordinary skill in the art that computer program instructions can be used to realize each block in structure diagrams and/or block diagrams and/or flowcharts as well as a combination of blocks in the structure diagrams and/or block diagrams and/or flowcharts. It can be understood by a person of ordinary skill in the art that these computer program instructions can be provided to general purpose computers, special purpose computers or other processors of programmable data processing means to be implemented, so that solutions designated in a block or blocks of the structure diagrams and/or block diagrams and/or flow diagrams are executed by computers or other processors of programmable data processing means.

It can be understood by a person of ordinary skill in the art that the steps, measures and solutions in the operations and methods disclosed in the present disclosure can be alternated, changed, combined or deleted. Other steps, measures and solutions in the operations and methods disclosed in the present disclosure can also be alternated, changed, rearranged, decomposed, combined or deleted. The steps, measures and solutions of the prior art in the operations and methods of the present disclosure can also be alternated, changed, rearranged, decomposed, combined or deleted.

The foregoing descriptions are merely some implementations of the present disclosure. It should be noted that, to a person of ordinary skill in the art, various improvements and modifications can be made without departing from the principle of the present disclosure, and these improvements and modifications shall be regarded as falling into the protection scope of the present disclosure.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. A method for positioning a video, comprising:
acquiring user impression data associated with playback progress of a video; and
positioning content of the video based on the acquired user impression data.

2. The method according to claim 1, wherein the user impression data comprises at least one of comment data, of the user, regarding the video, and preference data of the user to the video, and wherein the preference data of the user to the video comprises at least one of the following:
emotional tendentiousness data of the user to the video;
mood data of the user who is watching the video;
viewing rate data of the user who is watching the video;
evaluation data of the user to the video; and
overall data of degree of approval of the user to the video.

3. The method according to claim 2, wherein the user's impression data comprises the comment data; and
positioning the content of the video based on the acquired user's impression data specifically comprises:
determining comment content of interest from the comment data of the user to the video; and
positioning, in the video, video playback progress associated with the comment content of interest.

4. The method according to claim 3, wherein the positioning, in the video, the video playback progress associated with the comment content of interest specifically comprises:
determining corresponding video content of interest based on the comment content of interest; and
positioning, in the video, the video playback progress associated with the video content of interest,
wherein the video content comprises any one of object content, scene content and event content.

5. The method according to claim 3, further comprising at least one of:
displaying the positioned video playback progress, and
positioning the video to the video playback progress for playback, after detecting a playback instruction with respect to the positioned video playback progress.

6. The method according to claim 3, further comprising:
acquiring a video fragment corresponding to the positioned video playback progress according to the video content of the video; and
displaying the video playback progress corresponding to the acquired video fragment, and/or, positioning the video to a starting position of the video fragment for playback, after detecting a playback instruction with respect to the acquired video fragment.

7. The method according to claim 2, wherein the user impression data comprises the preference data of the user to the video; and
the positioning the content of the video based on the acquired user impression data comprises positioning at least one of content of interest and content not of interest, from the content of the video based on the preference data of the user to the video.

8. The method according to claim 7, further comprising at least one of:
displaying video playback progress corresponding to at least one of the content of interest and the content not of interest,and performing simplification processing on the video according to the at least one of the content of interest and the content not of interest;
downloading at least one of video fragments corresponding to the positioned content of interest, and video fragments corresponding to other contents except the positioned content not of interest, when it is determined to download the video; and
intercepting video fragments corresponding to at least one of the positioned content of interest, and other content except the positioned content not of interest, when it is determined to intercept video fragments from the video.

9. The method according to claim 8, further comprising at least one of:
sharing intercepted or spliced video fragment;
sharing the video and the playback progress of an intercepted or spliced video fragment in the video; and
sharing an intercepted or spliced video fragment and the content acquisition mode of the video.

10. The method according to claim 9, further comprising at least one of:
receiving the shared video and the shared playback progress of the video fragment in the video, playing the video fragment according to the received playback progress after detecting a video playback instruction, and resuming playing other contents of the video after detecting a resume playback instruction; and
receiving the shared content acquisition mode of the video fragment and the complete video, playing the received fragment after detecting a video playback instruction, and
resuming playing the content of the complete video after detecting the resume playback instruction.

11. The method according to claim 10, wherein the feedback data of the user who is watching the video comprises at least one of:
comment data, of the user, regarding the video;
operation data of the user to the video;
physiological response data of the user who is watching the video; and
evaluation data of the user to the video.

12. The method according to claim 11, wherein the feedback data of the user who is watching the video comprises at least one of the comment data of the user to the video and the evaluation data of the user to the video; and
collecting the video playback progress corresponding to the feedback data of the user who is watching the video comprises at least one of:
determining the video playback progress, when it is determined to issue the feedback data, as the video playback progress corresponding to the feedback data;
determining the video playback progress selected by the user as the video playback progress corresponding to the feedback data; and
determining the video playback progress, when it is determined to input the feedback data, as the video playback progress corresponding to the feedback data.

13. The method according to claim 11, wherein the feedback data of the user who is watching the video comprises operation data of the user to the video; and
collecting the video playback progress corresponding to the feedback data of the user who is watching the video comprises at least one of:
determining, when the operation of the user to the video is a marking operation, at least one of video playback progress corresponding to a video frame in which a mark of the user is located, a starting video playback progress corresponding to the marked video fragment, an ending video playback progress corresponding to the video fragment and video playback progress corresponding to a key video frame in the video fragment as the video playback progress corresponding to the feedback data;
determining, when the operation of the user to the video is a user operation of dragging the video, a fast-forward operation, a fast-reverse operation, a pause operation or a zoom operation, at least one of video playback progress during performing the operation and video playback progress after performing the operation as the video playback progress corresponding to the feedback data;
determining, when the operation of the user to the video is intercepting or sharing the video, at least one of starting video playback progress corresponding to the intercepted or shared video content, ending video playback progress and video playback progress corresponding to the key video frame as the video playback progress corresponding to the feedback data; and
uploading the collected feedback data and the corresponding video playback progress to a cloud server.

14. A method for positioning a video, comprising:
receiving feedback data of the users who are watching a video and corresponding video playback progress uploaded by a plurality of terminal apparatuses;
determining user impression data associated with the video playback progress based on the feedback data of each user who is watching the video and the corresponding video playback progress; and
providing the determined user impression data associated with the video playback progress to a terminal apparatus,
wherein the terminal apparatus positions the content of the video according to the user's impression data.

15. The method according to claim 14, further comprising:
correcting video playback progress corresponding to the feedback data according to at least one of comment content included in the feedback data, object information of the video, and scene information.

16. The method according to claim 14, wherein the user impression data comprises at least one of comment data of the user to the video, and preference data of the user to the video, and
wherein the preference data of the user to the video comprises at least one of:
emotional tendentiousness data of the user to the video;
mood data of the user who is watching the video;
viewing rate data of the user who is watching the video;
evaluation data of the user to the video; and
overall data of degree of approval of the user to the video.

17. The method according to claim 16, wherein determining the use impression data associated with the video playback progress based on the feedback data of each user who is watching the video and the corresponding video playback progress comprises:
determining, based on the feedback data at least one of:
viewing rate data associated with the video playback progress of the video;
emotional tendentiousness data associated with the video playback progress of the video;
mood data associated with the video playback progress of the video; and
evaluation data associated with the video playback progress of the video.

18. The method according to claim 17, further comprising:
determining the overall data of degree of approval associated with the video playback progress of the video according to at least one of the viewing rate data, the emotional tendentiousness data, the mood data and the evaluation data.

19. A terminal apparatus, comprising:
a user impression data acquisition module, configured to acquire user impression data associated with video playback progress of a video; and
a positioning module, configured to position the content of the video based on the acquired user impression data.

20. A cloud server, comprising:
a feedback data receiving module, configured to receive feedback data of the user who is watching a video and corresponding video playback progress uploaded by a plurality of terminal apparatuses;
a user impression data determination module, configured to determine user impression data associated with the video playback progress based on the feedback data of each user who is watching the video and the corresponding video playback progress; and
a data providing module, configured to provide the determined user impression data associated with the video playback progress to a terminal apparatus,
wherein the terminal apparatus positions the content of the video according to the user impression data.
